(19) United States
(12) Patent Application Publication
(10) Pub. No.: US 2023/0009304 A1
(43) Pub. Date: Jan. 12, 2023

(54) Systems and Methods for Token Management in Augmented and Virtual Environments

(71) Applicant: Artema Labs, Inc, Los Angeles, CA (US)

(72) Inventors: Bjorn Markus Jakobsson, Portola Valley, CA (US); Stephen C. Gerber, Austin, TX (US); Ajay Kapur, Valencia, CA (US); Madhu Vijayan, Venice, CA (US); Rebecca Anne Fiebrink, London (GB)

(73) Assignee: Artema Labs, Inc, Los Angeles, CA (US)

(21) Appl. No.: 17/811,831

(22) Filed: Jul. 11, 2022

Related U.S. Application Data
(60) Provisional application No. 63/289,189, filed on Dec. 14, 2021.
(60) Provisional application No. 63/289,512, filed on Dec. 14, 2021.
(60) Provisional application No. 63/283,331, filed on Nov. 26, 2021.
(60) Provisional application No. 63/223,099, filed on Jul. 19, 2021.
(60) Provisional application No. 63/219,864, filed on Jul. 9, 2021.

(51) Int. Cl. G06T 13/40; G06T 15/00; H04L 9/32

(52) U.S. Cl. CPC G06T 13/40; G06T 15/005; H04L 9/3213; H04L 2209/56; H04L 2209/603

(57) ABSTRACT

Systems and techniques to apply NFT content to immersive environment generation within an NFT platform are illustrated. One embodiment includes a method for rendering content. The method receives, from one or more sensory instruments, sensory input. The method processes the sensory input into a background source. The method receives a non-fungible token (NFT), wherein the NFT includes one or more character modeling elements. The method processes the one or more character modeling elements from the NFT into a character source. The method produces an immersive environment including features from the background source and features from the character source.

### CROSS-REFERENCE TO RELATED APPLICATIONS

The current application claims the benefit of and priority under 35 U.S.C. § 119(e) to U.S. Provisional Patent Application No. 63/219,864 entitled “Using Tokens in Augmented and Virtual Environments” filed Jul. 9, 2021, U.S. Provisional Patent Application No. 63/223,099 entitled “Advertisement Portability Methods” filed Jul. 19, 2021, U.S. Provisional Patent Application No. 63/283,331 entitled “Augmented Reality Overlay Access Rights Management” filed Nov. 26, 2021, U.S. Provisional Patent Application No. 63/283,512 entitled “Anti-Abuse Control of Augmented Reality” filed Nov. 28, 2021, U.S. Provisional Patent Application No. 63/289,189 entitled “Enhanced Audio-based Reality” filed Dec. 14, 2021, the disclosures of which are hereby incorporated by reference in their entireties for all purposes.

### FIELD OF THE INVENTION

The present invention generally relates to systems and methods directed to the minting of non-fungible tokens and maintenance of newly-created non-fungible tokens. The present invention additionally relates to systems and methods directed to facilitating the application of non-fungible tokens to augmented and virtual environments.

### BACKGROUND

Application of NFT content to virtual environments may be applied to facilitate conveyance of emotions, co-located teamwork, creativity, cultures, ideas, presentations, etc. Platforms in accordance with various embodiments of the invention may therefore enable new services, help people find directions and friends, facilitate health-building exercises, and/or help promote commercial products of relevance to users on a location-centric basis. Various business, learning, and recreation-based environments may therefore incorporate user interfaces that simplify the use of such NFTs.

### SUMMARY OF THE INVENTION

Systems and techniques to apply NFT content to immersive environment generation within an NFT platform are illustrated. One embodiment includes a method for rendering content. The method receives, from one or more sensory instruments, sensory input. The method processes the sensory input into a background source. The method receives a non-fungible token (NFT), wherein the NFT includes one or more character modeling elements. The method processes the one or more character modeling elements from the NFT into a character source. The method produces an immersive environment including features from the background source and features from the character source.

In a further embodiment, the method receives a connective visual source includes one or more connective visual elements. The method enhances details of the immersive environment using the connective visual source.

In another embodiment, the method renders the immersive environment.

In yet another embodiment, the method generates a log entry, wherein the log entry includes information relating to the rendering of the immersive environment.

In a further embodiment, the method processes the log entry. The method initiates a transfer of funds based on content from the log entry.

In another embodiment, the sensory input is obtained from a physical location.

In a further embodiment, the physical location is selected from the group consisting of an office, a recreational location, a residence of a participant in the immersive environment, and a custom-made environment.

In a still further embodiment, the immersive environment is used for instructional purposes; the physical location is a classroom; and the character is a computer-generated instructor.

In a further embodiment, the computer-generated instructor uses a computer-generated script, includes dialogue to be spoken by the instructor; and suggested reactions to questions from participants to the immersive environment.

In a still further embodiment, the method reviews the suggested reactions when a participant in the immersive environment asks a question. When a reaction of the suggested reactions is appropriate to the question, the method configures the instructor to respond using the reaction. When no reaction of the suggested reactions is appropriate to the question, the method configures the instructor to respond using an input reaction.

In yet another embodiment, the character source, when rendered, corresponds to facial elements.

In a further embodiment, the facial elements are derived from a character, and the character is selected from the group consisting of a fictional character, a celebrity, a participant in the immersive environment, and a custom-made character.

In still a further embodiment, the custom-made character is a character-trained model.

In still another embodiment, a right to use the character source is obtained by purchasing and/or licensing the NFT.

In still yet another embodiment, the features are selected from the group consisting of perspective, angle, lighting, color, and physical attributes.

In still another embodiment, the method incorporates audible elements into the immersive environment, wherein audible elements are selected from the group consisting of vocal music, speech, audible advertisements, and background music.

In still yet another embodiment, the sensory instruments are selected from the group consisting of cameras, microphones, and pressure-sensitive sensors.

In still another embodiment, elements that are processed into sources correspond to NFTs.

In a further embodiment, each NFT corresponding to an element is associated with one or more policies.

In a still further embodiment, at least one policy of the one or more policies governs royalty payments for use of an associated element.

One embodiment includes a non-transitory computer-readable medium storing instructions that, when executed by a processor, are configured to cause the processor to perform operations for rendering content. The processor receives, from one or more sensory instruments, sensory input. The method processes the sensory input into a background source. The method receives a non-fungible token (NFT), wherein the NFT includes one or more character modeling elements. The processes the one or more character modeling elements into a character source. The produces an immersive environment includes features from the background source and features from the character source.

In a further embodiment, the processor receives a connective visual source includes one or more connective visual elements. The processor enhances details of the immersive environment using the connective visual source.

In another embodiment, the processor renders the immersive environment.

In yet another embodiment, the processor generates a log entry, wherein the log entry includes information relating to the rendering of the immersive environment.

In a further embodiment, the processor processes the log entry. The processor initiates a transfer of funds based on content from the log entry.

In another embodiment, the sensory input is obtained from a physical location.

In a further embodiment, the physical location is selected from the group consisting of an office, a recreational location, a residence of a participant in the immersive environment, and a custom-made environment.

In a still further embodiment, the immersive environment is used for instructional purposes; the physical location is a classroom; and the character is a computer-generated instructor.

In a further embodiment, the computer-generated instructor uses a computer-generated script, includes dialogue to be spoken by the instructor; and suggested reactions to questions from participants to the immersive environment.

In a still further embodiment, the processor reviews the suggested reactions when a participant in the immersive environment asks a question. When a reaction of the suggested reactions is appropriate to the question, the processor configures the instructor to respond using the reaction. When no reaction of the suggested reactions is appropriate to the question, the processor configures the instructor to respond using an input reaction.

In yet another embodiment, the character source, when rendered, corresponds to facial elements.

In a further embodiment, the facial elements are derived from a character, and the character is selected from the group consisting of a fictional character, a celebrity, a participant in the immersive environment, and a custom-made character. In still a further embodiment, the custom-made character is a character-trained model.

In still another embodiment, a right to use the character source is obtained by purchasing and/or licensing the NFT.

In still yet another embodiment, the features are selected from the group consisting of perspective, angle, lighting, color, and physical attributes.

In still another embodiment, the processor incorporates audible elements into the immersive environment, wherein audible elements are selected from the group consisting of vocal music, speech, audible advertisements, and background music.

In still yet another embodiment, the sensory instruments are selected from the group consisting of cameras, microphones, and pressure-sensitive sensors.

In still another embodiment, elements that are processed into sources correspond to NFTs.

In a further embodiment, each NFT corresponding to an element is associated with one or more policies.

In a still further embodiment, at least one policy of the one or more policies governs royalty payments for use of an associated element.

One embodiment includes a method for advertising within rendered content. The method initiates an augmented environment experience for a participant. The method determines, using one or more sensors, a present condition of the participant, wherein the present condition includes location and recent activity within the augmented environment experience. The method determines, using the present condition and demographic information for the participant, a beneficial advertisement opportunity for the participant. The method displays, in the augmented environment experience, the advertisement opportunity.

In a further embodiment, the demographic information includes information obtained from the participant when registering for the augmented environment experience.

In another embodiment, the augmented environment experience corresponds to a virtual game.

In a still another embodiment, the advertisement opportunity is selected from the group consisting of promotions, advertisements, sweepstakes, and coupons.

In a further embodiment, the advertisement opportunity provides an opportunity to purchase and/or license characters for use in one or more immersive environments.

In another embodiment, the present condition further includes attributes selected from the group consisting of location, physical state, emotional state, immediate surroundings, and weather.

In yet another embodiment, the demographic information is selected from the group consisting of age, race, sex, nationality, and sexual orientation.

In another embodiment, the demographic information includes information obtained through observing the participant.

One embodiment includes a method for generating promotional content. The method posts an advertisement token on a first immersive environment. The method determines that the advertisement token has been added to a digital wallet. The method detects that the advertisement token has been republished. The method detects a conversion associated with consumption of the advertisement token. The method transmits a reward to the digital wallet.

In a further embodiment, a conversion is selected from the group consisting of purchases, clicks, detection of attention by a player, and usage of a product corresponding to the advertisement token.

In another embodiment, the advertisement token includes: advertisement content; and a reward policy that governs the reward transmitted to the digital wallet.

In yet another embodiment, republishing an advertisement token includes posting the advertisement token in a second immersive environment.

In still yet another embodiment, the method records the detection of the conversion; and demographic information for a party that performed the conversion.

One embodiment includes a non-transitory computer-readable medium storing instructions that, when executed by a processor, are configured to cause the processor to perform operations for advertising within rendered content. The processor initiates an augmented environment experience for a participant. The method determines, using one or more sensors, a present condition of the participant, wherein the present condition includes location and recent activity within the augmented environment experience. The method determines, using the present condition and demographic information for the participant, a beneficial advertisement opportunity for the participant. The method displays, in the augmented environment experience, the advertisement opportunity.

In a further embodiment, the demographic information includes information obtained from the participant when registering for the augmented environment experience.

In another embodiment, the augmented environment experience corresponds to a virtual game.

In a still another embodiment, the advertisement opportunity is selected from the group consisting of promotions, advertisements, sweepstakes, and coupons; the present condition further includes attributes selected from the group consisting of location, physical state, emotional state, immediate surroundings, and weather; and the demographic information is selected from the group consisting of age, race, sex, nationality, and sexual orientation.

In another embodiment, the demographic information includes information obtained through observing the participant.

In still yet another embodiment, the advertisement opportunity provides an opportunity to purchase and/or license characters for use in one or more immersive environments.

One embodiment includes a machine-readable medium containing bytecode stored within an immutable ledger, where the bytecode encodes an advertisement token. The advertisement token includes advertisement content; a reward policy; and a transmitter. Execution of the bytecode causes: a display of the advertisement content; and an indication that a conversion has occurred, wherein a conversion is selected from the group consisting of purchases, clicks, detection of attention by a player, and usage of a product corresponding to the advertisement token.

One embodiment includes a method for modifying audio data. The method receives a signal includes audio data. The method separates the audio data into one or more threads, wherein different sources of audio within the audio data are separated into different threads. The different sources of audio within the audio data are separated into different threads. A first thread is attributed to sounds from a first person and a second thread is attributed to sounds from a second person. The method modifies a first thread of the one or more threads. The method transmits the first thread to an immersive reality receiver.

In a further embodiment, the signal is received using one or more microphones and/or radio receivers.

In another embodiment, the sounds are verbal speech.

In a further embodiment, attributing a thread includes performing a Fast Fourier Transform (FFT) on the thread.

In another embodiment, attributing a thread is based on comparisons to one or more speaker profiles.

In yet another embodiment, modifying the first thread includes an action selected from the group consisting of an enhancement, a suppression, a translation, a search, and a transcription.

In still yet another embodiment, the immersive reality receiver is an Augmented Reality (AR) headset speaker.

In yet another embodiment, each thread is classified based on the different sources of audio.

In another embodiment, the first thread is determined based on a user selection.

In still another embodiment, a speaker profile can be obtained by purchasing and/or licensing a non-fungible token (NFT).

One embodiment includes a non-transitory machine-readable medium storing instructions that, when executed by a processor, are configured to cause the processor to perform operations for modifying audio data. The processor receives a signal includes audio data. The processor separates the audio data into one or more threads, wherein different sources of audio within the audio data are separated into different threads. The different sources of audio within the audio data are separated into different threads. A first thread is attributed to sounds from a first person and a second thread is attributed to sounds from a second person. The processor modifies a first thread of the one or more threads. The processor transmits the first thread to an immersive reality receiver.

In a further embodiment, the signal is received using one or more microphones and/or radio receivers.

In another embodiment, the sounds are verbal speech.

In a further embodiment, attributing a thread includes performing a Fast Fourier Transform (FFT) on the thread.

In another embodiment, attributing a thread is based on comparisons to one or more speaker profiles.

In yet another embodiment, modifying the first thread includes an action selected from the group consisting of an enhancement, a suppression, a translation, a search, and a transcription.

In still yet another embodiment, the immersive reality receiver is an Augmented Reality (AR) headset speaker.

In yet another embodiment, each thread is classified based on the different sources of audio.

In another embodiment, the first thread is determined based on a user selection.

In still another embodiment, a speaker profile can be obtained by purchasing and/or licensing a non-fungible token (NFT).

One embodiment includes a method for rendering augmented reality (AR) content. The method receives a reference to an AR token, wherein the AR token includes one or more AR content elements. The method assesses one or more access control rules associated with the AR token. The method compares the one or more access control rules with an identifier of a digital wallet holding the AR token. Based on the one or more access control rules and the identifier the method determines rights of consumption for the AR token by an owner of the digital wallet. The rights of consumption comprise at least one of a right to render, a right to execute, a right to possess, and a right to transfer.

In a further embodiment, the AR content is selected from the group consisting of an anime character, imagery associated with a human likeness, direction guidance, a recommendation, an endorsement, advertisement content, a game element, a user notification, and a warning.

In another embodiment, an access control rule is associated with a location of the AR token.

One embodiment includes a non-transitory machine-readable medium storing instructions that, when executed by a processor, are configured to cause the processor to perform operations for rendering augmented reality (AR) content. The processor receives a reference to an AR token, wherein the AR token includes one or more AR content elements. The processor assesses one or more access control rules associated with the AR token. The processor compares the one or more access control rules with an identifier of a digital wallet holding the AR token. Based on the one or more access control rules and the identifier the processor determines rights of consumption for the AR token by an owner of the digital wallet. The rights of consumption comprise at least one of a right to render, a right to execute, a right to possess, and a right to transfer.

In a further embodiment, the AR content is selected from the group consisting of an anime character, imagery associated with a human likeness, direction guidance, a recommendation, an endorsement, advertisement content, a game element, a user notification, and a warning.

In another embodiment, an access control rule is associated with a location of the AR token.

One embodiment includes a machine-readable medium containing bytecode stored within an immutable ledger, where the bytecode encodes an augmented reality (AR) token. The augmented reality token includes an AR content element; a type descriptor includes a description of the AR content element; and access control information. The access control information includes rights of consumption for the AR content element wherein rights of consumption comprise at least one of a right to render, a right to execute, a right to possess, and a right to transfer. Execution of the bytecode causes a rendering of the AR content element.

In a further embodiment, the AR content element includes a visual AR component, audio content, and scripts governing how to render the visual AR component and/or the audio content.

In a further embodiment, the visual AR component includes one or more of an image, a visual model, video clip, vector graphics, and a graphic model for 3D rendering.

In another embodiment, the audio content includes one or more of sound effects, music, and voice data.

In another embodiment, the scripts comprise references to code libraries and/or API call information.

In still another embodiment, the AR token includes an AR anchor indicator and a certification; wherein the anchor indicator indicates one or more anchors; and wherein the certification verifies the AR content element.

In still another embodiment each anchor is at least one of a location, a reference object, and an experience.

In still another embodiment, the location is determined using at least one of a GPS sensor, a WiFi-enabled radio, a Bluetooth-enabled radio; a compass; an accelerometer; and a previous location. A basis for the reference object is selected from the group consisting of processing of a QR code, processing of an image associated with the location, and optical character recognition (OCR). The experience corresponds to at least one of use of an application and a sensory input.

One embodiment includes a method for controlling rendering of augmented reality (AR) content. The method identifies one or more AR non-fungible tokens (NFTs) includes AR content. The method determines an anchor for the AR content. The method evaluates two or more content limiters concerning the AR NFT. The method, based on the evaluation, renders content associated with the one or more AR NFTs physically positioned near the anchor.

In another embodiment, the anchor includes at least one of a location, a reference object, and an experience.

In a further embodiment, the location is determined using at least one of a GPS sensor, a WiFi-enabled radio, a Bluetooth-enabled radio; a compass; an accelerometer; and a previous location.

In yet another embodiment, the content limiters are selected from the group consisting of priority, rendering limitations, exclusions, and blocklist match.

In a further embodiment, priority can be used to evaluate a primacy of AR content based in part on detected user actions; rendering limitations can block AR content from being rendered; exclusions can exclude AR content from being rendered and are evaluated based on at least one of membership, ownership, and sensory inputs; and blocklists indicate undesirable AR content.

In another embodiment, a basis for the reference object is selected from the group consisting of processing of a QR code, processing of an image associated with the location, and optical character recognition (OCR).

In yet another embodiment, the experience corresponds to one or more of use of an application and a sensory input.

In still another embodiment, the AR content includes one or more of video content, audio content, text content, and script content.

One embodiment includes a non-transitory computer-readable medium storing instructions that, when executed by a processor, are configured to cause the processor to perform operations for controlling rendering augmented reality (AR) content. The processor identifies one or more AR non-fungible tokens (NFTs) includes AR content. The processor determines an anchor for the AR content. The processor evaluates two or more content limiters concerning the AR NFT. The processor, based on the evaluation, renders content associated with the one or more AR NFTs physically positioned near the anchor.

In another embodiment, the anchor includes at least one of a location, a reference object, and an experience.

In a further embodiment, the location is determined using at least one of a GPS sensor, a WiFi-enabled radio, a Bluetooth-enabled radio; a compass; an accelerometer; and a previous location.

In yet another embodiment, the content limiters are selected from the group consisting of priority, rendering limitations, exclusions, and blocklist match.

In a further embodiment, priority can be used to evaluate a primacy of AR content based in part on detected user actions; rendering limitations can block AR content from being rendered; exclusions can exclude AR content from being rendered and are evaluated based on at least one of membership, ownership, and sensory inputs; and blocklists indicate undesirable AR content.

In another embodiment, a basis for the reference object is selected from the group consisting of processing of a QR code, processing of an image associated with the location, and optical character recognition (OCR).

In yet another embodiment, the experience corresponds to one or more of use of an application and a sensory input.

In still another embodiment, the AR content includes one or more of video content, audio content, text content, and script content.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a conceptual diagram of an NFT platform in accordance with an embodiment of the invention.

FIG. 2 is a network architecture diagram of an NFT platform in accordance with an embodiment of the invention.

FIG. 3 is a conceptual diagram of a permissioned blockchain in accordance with an embodiment of the invention.

FIG. 4 is a conceptual diagram of a permissionless blockchain in accordance with an embodiment of the invention.

FIGS. 5A-5B are diagrams of a dual blockchain in accordance with a number of embodiments of the invention.

FIG. 6 conceptually illustrates a process followed by a Proof of Work consensus mechanism in accordance with an embodiment of the invention.

FIG. 7 conceptually illustrates a process followed by a Proof of Space consensus mechanism in accordance with an embodiment of the invention.

FIG. 8 illustrates a dual proof consensus mechanism configuration in accordance with an embodiment of the invention.

FIG. 9 illustrates a process followed by a Trusted Execution Environment-based consensus mechanism in accordance with some embodiments of the invention.

FIGS. 10-12 depicts various devices that can be utilized alongside an NFT platform in accordance with various embodiments of the invention.

FIG. 13 depicts a media wallet application configuration in accordance with an embodiment of the invention.

FIGS. 14A-14C depicts user interfaces of various media wallet applications in accordance with a number of embodiments of the invention.

FIG. 15 illustrates an NFT ledger entry corresponding to an NFT identifier in accordance with various embodiments of the invention.

FIGS. 16A-16B illustrate an NFT arrangement relationship with corresponding physical content in accordance with some embodiments of the invention.

FIG. 17 illustrates a process for establishing a relationship between an NFT and corresponding physical content in accordance with certain embodiments of the invention.

FIG. 18 conceptually illustrates a possible implementation of the interaction between three sources of content, rendering units, and presentation units in accordance with a number of embodiments of the invention.

FIG. 19 illustrates the process of minting, advertising, licensing, and rendering work configured for virtual environment experiences, in accordance with various embodiments of the invention.

FIG. 20 illustrates a wearable computing device capable of incorporation into immersive environments in accordance with many embodiments of the invention.

FIG. 21 depicts an interaction system for updating the characteristics of possible avatars, in accordance with several embodiments of the invention.

FIG. 22 illustrates a user interface that may be used by administrators for immersive environments in accordance with certain embodiments of the invention.

FIG. 23 conceptually illustrates a system of creation, minting, and licensing a virtual model for immersive environments in accordance with some embodiments of the invention.

FIG. 24 conceptually illustrates a series of updates that may be initiated in response to immersive environment monitoring, in accordance with a number of embodiments of the invention.

FIG. 25 depicts a process for the identification and rendering of content elements, in accordance with various embodiments of the invention.

FIG. 26 illustrates a process followed in monitoring an immersive environment for opportunities to advertise products in accordance with some embodiments of the invention.

FIG. 27 illustrates a view of a configuration meter, in accordance with various embodiments of the invention.

FIG. 28 illustrates a process for manipulating audio input, in accordance with a number of embodiments of the invention.

FIG. 29 illustrates a process for the separation of an audio input into multiple threads, in accordance with some embodiments of the invention.

FIG. 30 illustrates a transformation process for obtained audio, in accordance with a number of embodiments of the invention.

FIG. 31 illustrates an audio-directed hardware configuration, in accordance with many embodiments of the invention.

FIGS. 32A-32B illustrate a sample system of interrelated AR content, in accordance with several embodiments of the invention.

FIG. 33 conceptually illustrates an example of a process for determining the rendering of content in accordance with various embodiments of the invention.

FIG. 34 illustrates an implementation of an augmented reality (AR) non-fungible token (NFT), in accordance with a number of embodiments of the invention.

FIG. 35 conceptually illustrates an example of a process for determining the rendering of content in accordance with various embodiments of the invention.

FIG. 36 illustrates a configuration of rendering limitations, in accordance with certain embodiments of the invention.

### DETAILED DESCRIPTION

### Non-Fungible Token (NFT) Platforms

Systems and methods for incorporating non-fungible token (NFT) content into immersive environments, including Augmented Reality (AR), Virtual Reality (VR) and Mixed Reality (MR) environments, in accordance with various embodiments of the invention, are described herein. In some embodiments, NFT platforms can enable users (e.g., content creators, content originators, content users, etc.) to combine data obtained from multiple sources (e.g., sensory data, animation data, script content) for the purpose of rendering comprehensive immersive environments and/or characters. Features from various sources may be interwoven using content including, but not limited to NFTs, for more detailed virtual environments. In a number of embodiments, users may enjoy artwork in virtual environments through obtaining associated NFTs. NFTs may be associated with models allowing users to virtually duplicate real beings and/or things. Models may be made of pets, fictional characters, and celebrities (with permission), and subsequently incorporated into audiovisual renderings.

NFT platforms in accordance with a number of embodiments of the invention may use NFT technologies to configure and/or republish advertisements and promotions in the digital realm. Systems may allow businesses to obtain data on possible customers from a wide variety of contexts, including but not limited to, gaming environments. NFT content may be used as an additional incentive for advertisers through providing benefits within specific immersive environments (e.g., game promotions).

Various embodiments of the invention may incorporate techniques and systems directed to modify and optimize content received in immersive environments. In such systems, from the perspective of users, particular sources of audio may be suppressed, enhanced, and/or otherwise modified based on the priorities of the users. Moreover, modifications may be based on features including but not limited to, the location of certain sounds (e.g., suppressing sound at particular distances), the meaning of certain audio (e.g., transcribing and translating verbal statements in real-time), and/or the source of particular sounds (e.g., making voice profiles that allows users to rehear audio in the voice of specific speakers).

In a number of embodiments, users may have the capacity to associate access rights with particular data overlays. This may allow the generation of augmented reality overlays in specific places, at specific times, and/or by specific people, based on NFT policies. Users may conditionally render a wide variety of content based on access rights including, but not limited to ownership, actions, influencing factors and/or configurations. Through rendering right tokens, the freedom to possess and/or consume content may be distinguished from various other liberties like the freedom to render the content in an immersive environment.

Several embodiments of the invention may be used to control and/or limit the use of AR. AR content may be anchored and/or conditionally renderable subject to certain locations, reference objects, and/or experiences. The determination of whether and when NFT-based AR content should be rendered may be governed by external policies and certain access permissions. Rendering limitations may specify that the rendering limitation does not apply to users based on specified memberships and/or token ownerships, allowing for variety in consumable content. Systems may prioritize rendering certain content based on situational context and/or user attention (e.g., providing notice of a fire over AR displays).

While various aspects of NFT platforms, NFT configurations, immersive environments, and AR technologies are discussed above, NFT platforms and different components that can be utilized within NFT platforms in accordance with various embodiments of the invention are discussed further below.

### NFT Platforms

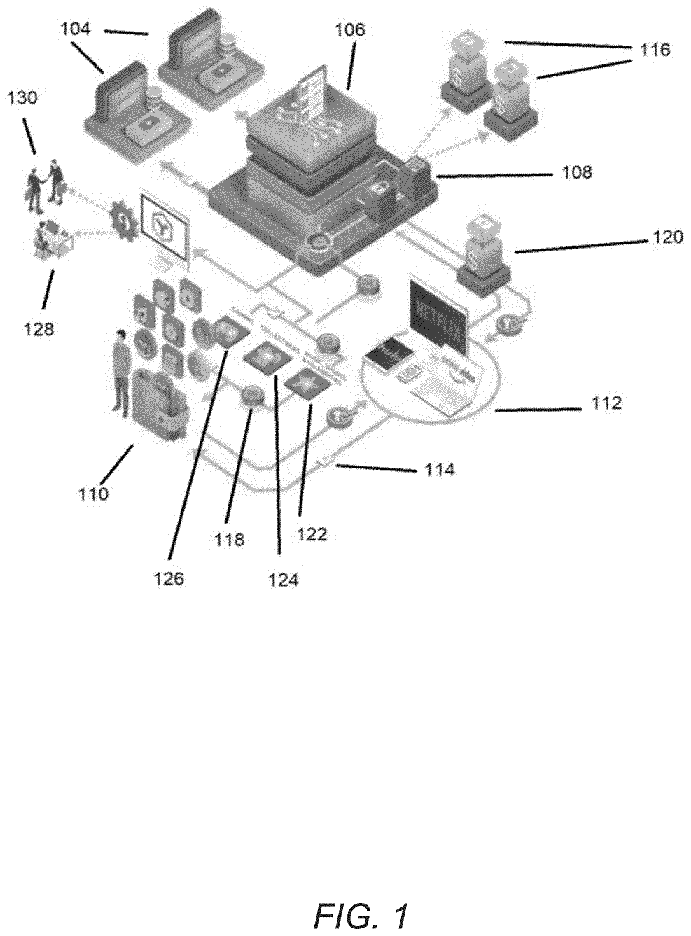

An NFT platform in accordance with an embodiment of the invention is illustrated in FIG. 1. The NFT platform 100 utilizes one or more immutable ledgers (e.g., one or more blockchains) to enable a number of verified content creators 104 to access an NFT registry service to mint NFTs 106 in a variety of forms including (but not limited to) celebrity NFTs 122, character NFTs from games 126, NFTs that are redeemable within games 126, NFTs that contain and/or enable access to collectibles 124, and NFTs that have evolutionary capabilities representative of the change from one NFT state to another NFT state.

Issuance of NFTs 106 via the NFT platform 100 enables verification of the authenticity of NFTs independently of the content creator 104 by confirming that transactions written to one or more of the immutable ledgers are consistent with the smart contracts 108 underlying the NFTs.

Content creators 104 can provide the NFTs 106 to users to reward and/or incentivize engagement with particular pieces of content and/or other user behavior including (but not limited to) the sharing of user personal information (e.g., contact information or user ID information on particular services), demographic information, and/or media consumption data with the content creator and/or other entities. In addition, the smart contracts 108 underlying the NFTs can cause payments of residual royalties 116 when users engage in specific transactions involving NFTs (e.g., transfer of ownership of the NFT).

In a number of embodiments, users utilize media wallet applications 110 on their devices to store NFTs 106 distributed using the NFT platform 100. Users can use media wallet applications 110 to obtain and/or transfer NFTs 106. In facilitating the retention or transfer of NFTs 106, media wallet applications may utilize wallet user interfaces that engage in transactional restrictions through either uniform or personalized settings. Media wallet applications 110 in accordance with some embodiments may incorporate NFT filtering systems to avoid unrequested NFT assignment. Methods for increased wallet privacy may operate through multiple associated wallets with varying capabilities. As can readily be appreciated, NFTs 106 that are implemented using smart contracts 108 having interfaces that comply with open standards are not limited to being stored within media wallets and can be stored in any of a variety of wallet applications as appropriate to the requirements of a given application. Furthermore, a number of embodiments of the invention support movement of NFTs 106 between different immutable ledgers. Processes for moving NFTs between multiple immutable ledgers in accordance with various embodiments of the invention are discussed further below.

In several embodiments, content creators 104 can incentivize users to grant access to media consumption data using offers including (but not limited to) offers of fungible tokens 118 and/or NFTs 106. In this way, the ability of the content creators to mint NFTs enables consumers to engage directly with the content creators and can be utilized to incentivize users to share with content creators' data concerning user interactions with additional content. The permissions granted by individual users may enable the content creators 104 to directly access data written to an immutable ledger. In many embodiments, the permissions granted by individual users enable authorized computing systems to access data within an immutable ledger and content creators 104 can query the authorized computing systems to obtain aggregated information. Numerous other example functions for content creators 104 are possible, some of which are discussed below.

NFT blockchains in accordance with various embodiments of the invention enable issuance of NFTs by verified users. In many embodiments, the verified users can be content creators that are vetted by an administrator of networks that may be responsible for deploying and maintaining the NFT blockchain. Once the NFTs are minted, users can obtain and conduct transactions with the NFTs. In several embodiments, the NFTs may be redeemable for items or services in the real world such as (but not limited to) admission to movie screenings, concerts, and/or merchandise.

As illustrated in FIG. 1, users can install the media wallet application 110 onto their devices and use the media wallet application 110 to purchase fungible tokens. The media wallet application could be provided by a browser, and/or by a dedicated hardware unit executing instructions provided by a wallet manufacturer. The different types of wallets may have slightly different security profiles and may offer different features, but would all be able to be used to initiate the change of ownership of tokens, such as NFTs. In many embodiments, the fungible tokens can be fully converted into fiat currency and/or other cryptocurrency. In several embodiments, the fungible tokens are implemented using split blockchain models in which the fungible tokens can be issued to multiple blockchains (e.g., Ethereum). As can readily be appreciated, the fungible tokens and/or NFTs utilized within an NFT platform in accordance with various embodiments of the invention are largely dependent upon the requirements of a given application.

In several embodiments, the media wallet application is capable of accessing multiple blockchains by deriving accounts from each of the various immutable ledgers used within an NFT platform. For each of these blockchains, the media wallet application can automatically provide simplified views whereby fungible tokens and NFTs across multiple accounts and/or multiple blockchains can be rendered as single user profiles and/or wallets. In many embodiments, the single view can be achieved using deep-indexing of the relevant blockchains and API services that can rapidly provide information to media wallet applications in response to user interactions. In certain embodiments, the accounts across the multiple blockchains can be derived using BIP32 deterministic wallet key. In other embodiments, any of a variety of techniques can be utilized by the media wallet application to access one or more immutable ledgers as appropriate to the requirements of a given application.

NFTs can be purchased by way of exchanges 130 and/or from other users. In addition, content creators can directly issue NFTs to the media wallets of specific users (e.g., by way of push download or AirDrop). In many embodiments, the NFTs are digital collectibles such as celebrity NFTs 122, character NFTs from games 126, NFTs that are redeemable within games 126, and/or NFTs that contain and/or enable access to collectibles 124. It should be appreciated that a variety of NFTs are described throughout the discussion of the various embodiments described herein and can be utilized in any NFT platform and/or with any media wallet application.

While the NFTs are shown as static in the illustrated embodiment, content creators can utilize users' ownership of NFTs to engage in additional interactions with the user. In this way, the relationship between users and particular pieces of content and/or particular content creators can evolve over time around interactions driven by NFTs. In a number of embodiments, collection of NFTs can be gamified to enable unlocking of additional NFTs. In addition, leaderboards can be established with respect to particular content and/or franchises based upon users' aggregation of NFTs. As is discussed further below, NFTs and/or fungible tokens can be utilized by content creators to incentivize users to share data.

NFTs minted in accordance with several embodiments of the invention may incorporate a series of instances of digital content elements in order to represent the evolution of the digital content over time. Each one of these digital elements can have multiple numbered copies, just like a lithograph, and each such version can have a serial number associated with it, and/or digital signatures authenticating its validity. The digital signature can associate the corresponding image to an identity, such as the identity of the artist. The evolution of digital content may correspond to the transition from one representation to another representation. This evolution may be triggered by the artist, by an event associated with the owner of the artwork, by an external event measured by platforms associated with the content, and/or by specific combinations or sequences of event triggers. Some such NFTs may have corresponding series of physical embodiments. These may be physical and numbered images that are identical to the digital instances described above. They may be physical representations of another type, e.g., clay figures or statues, whereas the digital representations may be drawings. The physical embodiments may further be of different aspects that relate to the digital series. Evolution in compliance with some embodiments may be used to spawn additional content, for example, one NFT directly creating one or more secondary NFTs.

When the user wishes to purchase an NFT using fungible tokens, media wallet applications can request authentication of the NFT directly based upon the public key of the content creator and/or indirectly based upon transaction records within the NFT blockchain. As discussed above, minted NFTs can be signed by content creators and administrators of the NFT blockchain. In addition, users can verify the authenticity of particular NFTs without the assistance of entities that minted the NFT by verifying that the transaction records involving the NFT within the NFT blockchain are consistent with the various royalty payment transactions required to occur in conjunction with transfer of ownership of the NFT by the smart contract underlying the NFT.

Applications and methods in accordance with various embodiments of the invention are not limited to media wallet applications or use within NFT platforms. Accordingly, it should be appreciated that the data collection capabilities of any media wallet application described herein can be implemented outside the context of an NFT platform and/or in a dedicated application and/or in an application unrelated to the storage of fungible tokens and/or NFTs. Various systems and methods for implementing NFT platforms and media wallet applications in accordance with various embodiments of the invention are discussed further below.

### NFT Platform Network Architectures

NFT platforms in accordance with many embodiments of the invention utilize public blockchains and permissioned blockchains. In several embodiments, the public blockchain is decentralized and universally accessible. Additionally, in a number of embodiments, private/permissioned blockchains are closed systems that are limited to publicly inaccessible transactions. In many embodiments, the permissioned blockchain can be in the form of distributed ledgers, while the blockchain may alternatively be centralized in a single entity.

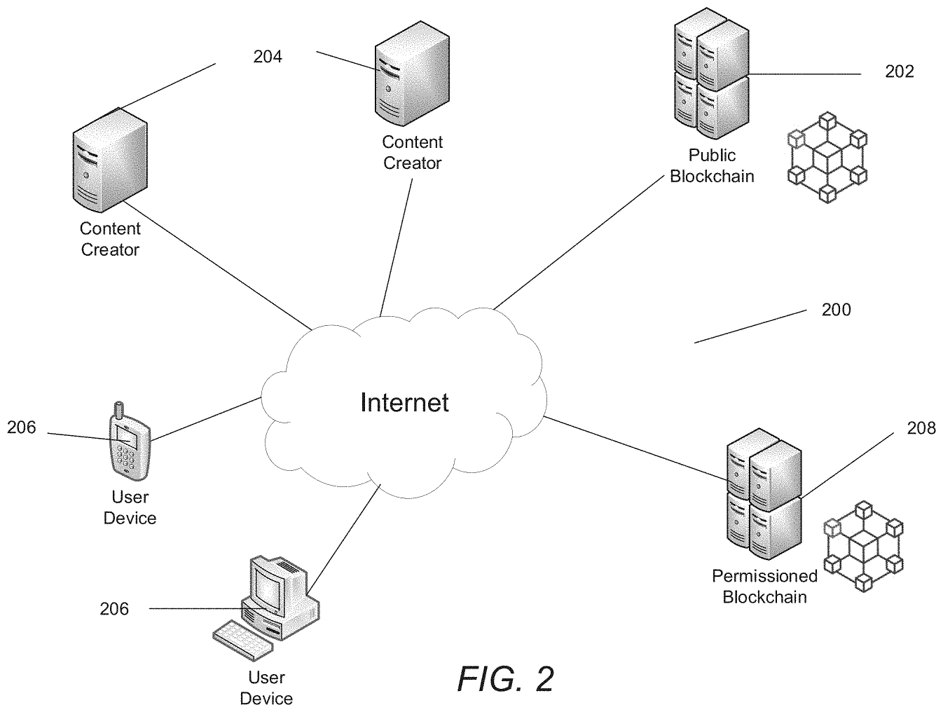

An example of network architecture that can be utilized to implement an NFT platform including a public blockchain and a permissioned blockchain in accordance with several embodiments of the invention is illustrated in FIG. 2. The NFT platform 200 utilizes computer systems implementing a public blockchain 202 such as (but not limited to) Ethereum and Solana. A benefit of supporting interactions with public blockchains 202 is that the NFT platform 200 can support minting of standards based NFTs that can be utilized in an interchangeable manner with NFTs minted by sources outside of the NFT platform on the public blockchain. In this way, the NFT platform 200 and the NFTs minted within the NFT platform are not part of a walled garden, but are instead part of a broader blockchain-based ecosystem. The ability of holders of NFTs minted within the NFT platform 200 to transact via the public blockchain 202 increases the likelihood that individuals acquiring NFTs will become users of the NFT platform. Initial NFTs minted outside the NFT platform can be developed through later minted NFTs, with the initial NFTs being used to further identify and interact with the user based upon their ownership of both NFTs. Various systems and methods for facilitating the relationships between NFTs, both outside and within the NFT platform are discussed further below.

Users can utilize user devices configured with appropriate applications including (but not limited to) media wallet applications to obtain NFTs. In many embodiments, media wallets are smart device enabled, front-end applications for fans and/or consumers, central to all user activity on an NFT platform. As is discussed in detail below, different embodiments of media wallet applications can provide any of a variety of functionality that can be determined as appropriate to the requirements of a given application. In the illustrated embodiment, the user devices 206 are shown as mobile phones and personal computers. As can readily be appreciated user devices can be implemented using any class of consumer electronics device including (but not limited to) tablet computers, laptop computers, televisions, game consoles, virtual reality headsets, mixed reality headsets, augmented reality headsets, media extenders, and/or set top boxes as appropriate to the requirements of a given application.

In many embodiments, NFT transaction data entries in the permissioned blockchain 208 are encrypted using users' public keys so that the NFT transaction data can be accessed by the media wallet application. In this way, users control access to entries in the permissioned blockchain 208 describing the user's NFT transaction. In several embodiments, users can authorize content creators 204 to access NFT transaction data recorded within the permissioned blockchain 208 using one of a number of appropriate mechanisms including (but not limited to) compound identities where the user is the owner of the data and the user can authorize other entities as guests that can access the data. As can readily be appreciated, particular content creators' access to the data can be revoked by revoking their status as guests within the compound entity authorized to access the NFT transaction data within the permissioned blockchain 208. In certain embodiments, compound identities are implemented by writing authorized access records to the permissioned blockchain using the user's public key and the public keys of the other members of the compound entity.

When content creators wish to access particular pieces of data stored within the permissioned blockchain 208, they can make a request to a data access service. The data access service may grant access to data stored using the permissioned blockchain 208 when the content creators' public keys correspond to public keys of guests. In a number of embodiments, guests may be defined within a compound identity. The access record for the compound entity may authorize the compound entity to access the particular piece of data. In this way, users has complete control over access to their data at any time by admitting and/or revoking content creators to a compound entity, and/or modifying the access policies defined within the permissioned blockchain 208 for the compound entity. In several embodiments, the permissioned blockchain 208 supports access control lists and users can utilize a media wallet application to modify permissions granted by way of the access control list. In many embodiments, the manner in which access permissions are defined enables different restrictions to be placed on particular pieces of information within a particular NFT transaction data record within the permissioned blockchain 208. As can readily be appreciated, the manner in which NFT platforms and/or immutable ledgers provide fine-grained data access permissions largely depends upon the requirements of a given application.

In many embodiments, storage nodes within the permissioned blockchain 208 do not provide content creators with access to entire NFT transaction histories. Instead, the storage nodes simply provide access to encrypted records. In several embodiments, the hash of the collection of records from the permissioned blockchain is broadcast. Therefore, the record is verifiably immutable and each result includes the hash of the record and the previous/next hashes. As noted above, the use of compound identities and/or access control lists can enable users to grant permission to decrypt certain pieces of information and/or individual records within the permissioned blockchain. In several embodiments, the access to the data is determined by computer systems that implement permission-based data access services.

In many embodiments, the permissioned blockchain 208 can be implemented using any blockchain technology appropriate to the requirements of a given application. As noted above, the information and processes described herein are not limited to data written to permissioned blockchains 208, and NFT transaction data simply provides an example. Systems and methods in accordance with various embodiments of the invention can be utilized to enable applications to provide fine-grained permission to any of a variety of different types of data stored in an immutable ledger as appropriate to the requirements of a given application in accordance with various embodiments of the invention.

While various implementations of NFT platforms are described above with reference to FIG. 2, NFT platforms can be implemented using any number of immutable and pseudo-immutable ledgers as appropriate to the requirements of specific applications in accordance with various embodiments of the invention. Blockchain databases in accordance with various embodiments of the invention may be managed autonomously using peer-to-peer networks and distributed timestamping servers. In some embodiments, any of a variety of consensus mechanisms may be used by public blockchains, including but not limited to Proof of Space mechanisms, Proof of Work mechanisms, Proof of Stake mechanisms, and hybrid mechanisms.

NFT platforms in accordance with many embodiments of the invention may benefit from the oversight and increased security of private blockchains. As can readily be appreciated, a variety of approaches can be taken to the writing of data to permissioned blockchains and the particular approach is largely determined by the requirements of particular applications. As such, computer systems in accordance with various embodiments of the invention can have the capacity to create verified NFT entries written to permissioned blockchains.

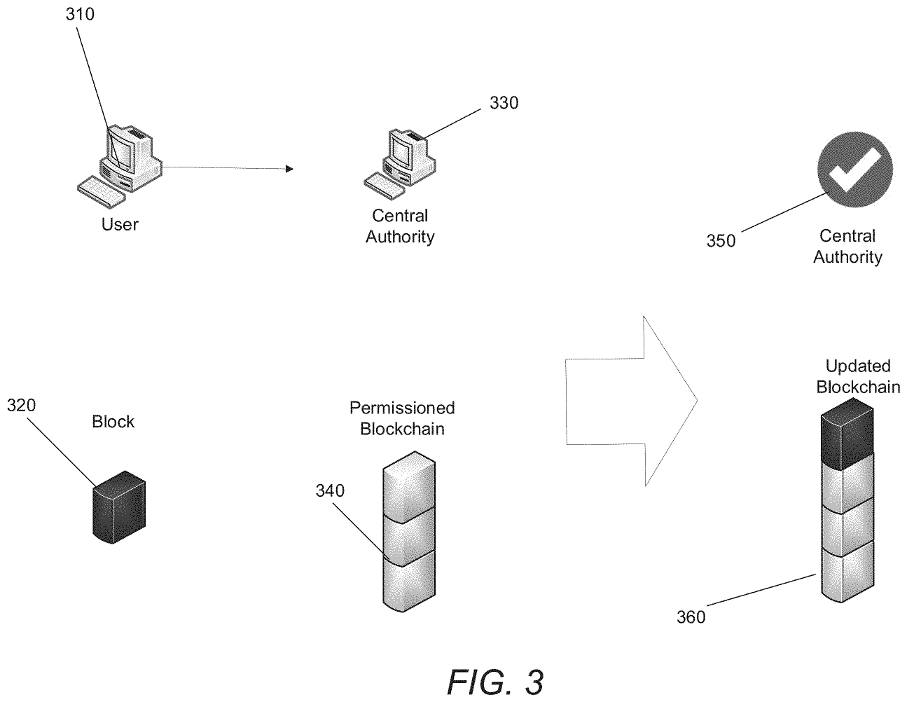

An implementation of permissioned (or private) blockchains in accordance with some embodiments of the invention is illustrated in FIG. 3. Permissioned blockchains 340 can typically function as closed computing systems in which each participant is well defined. In several embodiments, private blockchain networks may require invitations. In a number of embodiments, entries, also referred to as blocks 320, to private blockchains can be validated. In some embodiments, the validation may come from central authorities 330. Private blockchains can allow an organization and/or a consortium of organizations to efficiently exchange information and record transactions. Specifically, in a permissioned blockchain, a preapproved central authority 330 (which should be understood as potentially encompassing multiple distinct authorized authorities) can approve a change to the blockchain. In a number of embodiments, approval may come without the use of a consensus mechanism involving multiple authorities. As such, through a direct request from users 310 to the central authority 330, the determination of whether blocks 320 can be allowed access to the permissioned blockchain 340 can be determined. Blocks 320 needing to be added, eliminated, relocated, and/or prevented from access may be controlled through these means. In doing so the central authority 330 may manage accessing and controlling the network blocks incorporated into the permissioned blockchain 340. Upon the approval 350 of the central authority, the now updated blockchain 360 can reflect the added block 320.

NFT platforms in accordance with many embodiments of the invention may benefit from the anonymity and accessibility of a public blockchain. Therefore, NFT platforms in accordance with many embodiments of the invention can have the capacity to create verified NFT entries written to a permissioned blockchain.

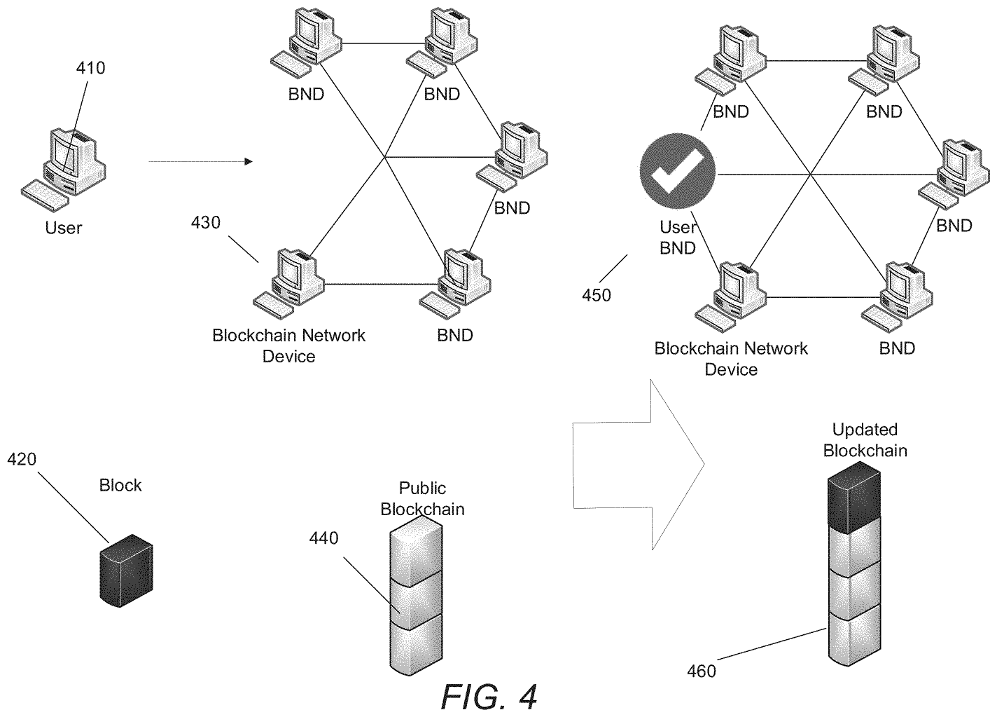

An implementation of a permissionless, decentralized, or public blockchain in accordance with an embodiment of the invention is illustrated in FIG. 4. In a permissionless blockchain, individual users 410 can directly participate in relevant networks and operate as blockchain network devices 430. As blockchain network devices 430, parties would have the capacity to participate in changes to the blockchain and participate in transaction verifications (via the mining mechanism). Transactions are broadcast over the computer network and data quality is maintained by massive database replication and computational trust. Despite being decentralized, an updated blockchain 460 cannot remove entries, even if anonymously made, making it immutable. In many decentralized blockchains, many blockchain network devices 430, in the decentralized system may have copies of the blockchain, allowing the ability to validate transactions. In many instances, the blockchain network device 430 can personally add transactions, in the form of blocks 420 appended to the public blockchain 440. To do so, the blockchain network device 430 would take steps to allow for the transactions to be validated 450 through various consensus mechanisms (Proof of Work, Proof of Stake, etc.). A number of consensus mechanisms in accordance with various embodiments of the invention are discussed further below.

Additionally, in the context of blockchain configurations, the term smart contract is often used to refer to software programs that run on blockchains. While a standard legal contract outlines the terms of a relationship (usually one enforceable by law), a smart contract enforces a set of rules using self-executing code within NFT platforms. As such, smart contracts may have the means to automatically enforce specific programmatic rules through platforms. Smart contracts are often developed as high-level programming abstractions that can be compiled down to bytecode. Said bytecode may be deployed to blockchains for execution by computer systems using any number of mechanisms deployed in conjunction with the blockchain. In many instances, smart contracts execute by leveraging the code of other smart contracts in a manner similar to calling upon a software library.

A number of existing decentralized blockchain technologies intentionally exclude or prevent rich media assets from existing within the blockchain, because they would need to address content that is not static (e.g., images, videos, music files). Therefore, NFT platforms in accordance with many embodiments of the invention may address this with blockchain mechanisms, that preclude general changes but account for updated content.

NFT platforms in accordance with many embodiments of the invention can therefore incorporate decentralized storage pseudo-immutable dual blockchains. In some embodiments, two or more blockchains may be interconnected such that traditional blockchain consensus algorithms support a first blockchain serving as an index to a second, or more, blockchains serving to contain and protect resources, such as the rich media content associated with NFTs.

In storing rich media using blockchain, several components may be utilized by an entity (“miner”) adding transactions to said blockchain. References, such as URLs, may be stored in the blockchain to identify assets. Multiple URLs may be stored when the asset is separated into pieces. An alternative or complementary option may be the use of APIs to return either the asset or a URL for the asset. In accordance with many embodiments of the invention, references can be stored by adding a ledger entry incorporating the reference enabling the entry to be timestamped. In doing so, the URL, which typically accounts for domain names, can be resolved to IP addresses. However, when only files of certain types are located on particular resources, or where small portions of individual assets are stored at different locations, users may require methods to locate assets stored on highly-splintered decentralized storage systems. To do so, systems may identify at least primary asset destinations and update those primary asset destinations as necessary when storage resources change. The mechanisms used to identify primary asset destinations may take a variety of forms including, but not limited to, smart contracts.

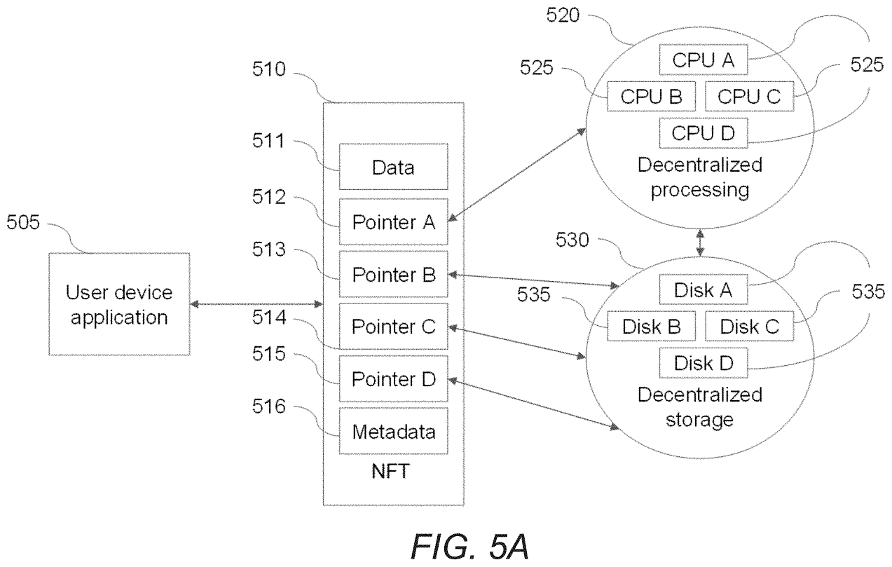

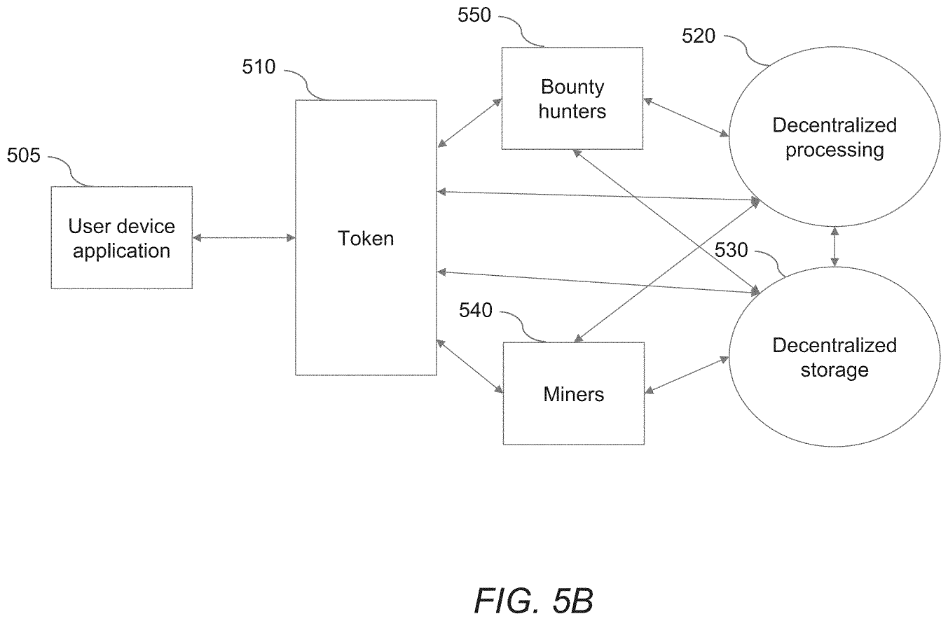

A dual blockchain, including decentralized processing 520 and decentralized storage 530 blockchains, in accordance with some embodiments of the invention is illustrated in FIG. 5A. Application running on devices 505, may interact with or make a request related to NFTs 510 interacting with such a blockchain. An NFT 510 in accordance with several embodiments of the invention may include many values including generalized data 511 (e.g., URLs), and pointers such as pointer A 512, pointer B 513, pointer C 514, and pointer D 515. In accordance with many embodiments of the invention, the generalized data 511 may be used to access corresponding rich media through the NFT 510. The NFT 510 may additionally have associated metadata 516.

Pointers within the NFT 510 may direct an inquiry toward a variety of on or off-ledger resources. In some embodiments of the invention, as illustrated FIG. 5A, pointer A 512 can direct the need for processing to the decentralized processing network 520. Processing systems are illustrated as CPU A, CPU B, CPU C, and CPU D 525. The CPUs 525 may be personal computers, server computers, mobile devices, edge IoT devices, etc. Pointer A may select one or more processors at random to perform the execution of a given smart contract. The code may be secure or nonsecure and the CPU may be a trusted execution environment (TEE), depending upon the needs of the request. In the example reflected in FIG. 5A, pointer B 513, pointer C 514, and pointer D 515 all point to a decentralized storage network 530 including remote off-ledger resources including storage systems illustrated as Disks A, B, C, and D 535.

The decentralized storage system may co-mingle with the decentralized processing system as the individual storage systems utilize CPU resources and connectivity to perform their function. From a functional perspective, the two decentralized systems may be separate. Pointer B 513 may point to one or more decentralized storage networks 530 for the purposes of maintaining an off-chain log file of token activity and requests. Pointer C 514 may point to executable code within one or more decentralized storage networks 530. And Pointer D 515 may point to rights management data, security keys, and/or configuration data within one or more decentralized storage networks 530.

Dual blockchains may additionally incorporate methods for detection of abuse, essentially operating as a “bounty hunter” 550. FIG. 5B illustrates the inclusion of bounty hunters 550 within dual blockchain structures implemented in accordance with an embodiment of the invention. Bounty hunters 550 allow NFTs 510, which can point to networks that may include decentralized processing 520 and/or storage networks 530, to be monitored. The bounty hunter's 550 objective may be to locate incorrectly listed or missing data and executable code within the NFT 510 or associated networks. Additionally, the miner 540 can have the capacity to perform all necessary minting processes or any process within the architecture that involves a consensus mechanism.

Bounty hunters 550 may choose to verify each step of a computation, and if they find an error, submit evidence of this in return for some reward. This can have the effect of invalidating the incorrect ledger entry and, potentially based on policies, all subsequent ledger entries. Such evidence can be submitted in a manner that is associated with a public key, in which the bounty hunter 550 proves knowledge of the error, thereby assigning value (namely the bounty) with the public key.

Assertions made by bounty hunters 550 may be provided directly to miners 540 by broadcasting the assertion. Assertions may be broadcast in a manner including, but not limited to posting it to a bulletin board. In some embodiments of the invention, assertions may be posted to ledgers of blockchains, for instance, the blockchain on which the miners 540 operate. If the evidence in question has not been submitted before, this can automatically invalidate the ledger entry that is proven wrong and provide the bounty hunter 550 with some benefit.

Applications and methods in accordance with various embodiments of the invention are not limited to use within NFT platforms. Accordingly, it should be appreciated that the capabilities of any blockchain configuration described herein can be implemented outside the context of an NFT platform network architecture and in contexts unrelated to the storage of fungible tokens and/or NFTs. A variety of components, mechanisms, and blockchain configurations that can be utilized within NFT platforms are discussed further below. Moreover, any of the blockchain configurations described herein with reference to FIGS. 3-5B (including permissioned, permissionless, and/or hybrid mechanisms) can be utilized within any of the networks implemented within the NFT platforms described above.

### NFT Platform Consensus Mechanisms

NFT platforms in accordance with many embodiments of the invention can depend on consensus mechanisms to achieve agreement on network state, through proof resolution, to validate transactions. In accordance with many embodiments of the invention, Proof of Work (PoW) mechanisms may be used as a means of demonstrating non-trivial allocations of processing power. Proof of Space (PoS) mechanisms may be used as a means of demonstrating non-trivial allocations of memory or disk space. As a third possible approach, Proof of Stake mechanisms may be used as a means of demonstrating non-trivial allocations of fungible tokens and/or NFTs as a form of collateral. Numerous consensus mechanisms are possible in accordance with various embodiments of the invention, some of which are expounded on below.

Traditional mining schemes, such as Bitcoin, are based on Proof of Work, based on performing the aforementioned large computational tasks. The cost of such tasks may not only be computational effort, but energy expenditure, a significant environmental concern. To address this problem, mining methods operating in accordance with many embodiments of the invention may instead operate using Proof of Space mechanisms to accomplish network consensus, wherein the distinguishing factor can be memory rather than processing power. Specifically, Proof of Space mechanisms can perform this through network optimization challenges. In several embodiments the network optimization challenge may be selected from any of a number of different challenges appropriate to the requirements of specific applications including graph pebbling. In some embodiments, graph pebbling may refer to a resource allocation game played on discrete mathematics graphs, ending with a labeled graph disclosing how a player might get at least one pebble to every vertex of the graph.

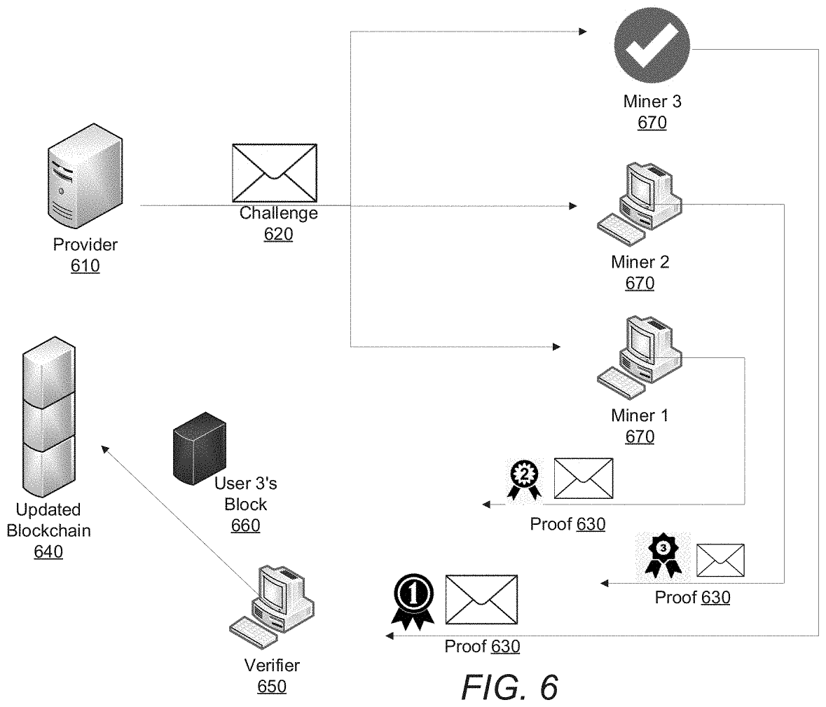

An example of Proof of Work consensus mechanisms that may be implemented in decentralized blockchains, in accordance with a number of embodiments of the invention, is conceptually illustrated in FIG. 6. The example disclosed in this figure is a challenge—response authentication, a protocol classification in which one party presents a complex problem (“challenge”) 610 and another party must broadcast a valid answer (“proof”) 620 to have clearance to add a block to the decentralized ledger that makes up the blockchain 630. As a number of miners may be competing to have this ability, there may be a need for determining factors for the addition to be added first, which in this case is processing power. Once an output is produced, verifiers 640 in the network can verify the proof, something which typically requires much less processing power, to determine the first device that would have the right to add the winning block 650 to the blockchain 630. As such, under a Proof of Work consensus mechanism, each miner involved can have a success probability proportional to the computational effort expended.

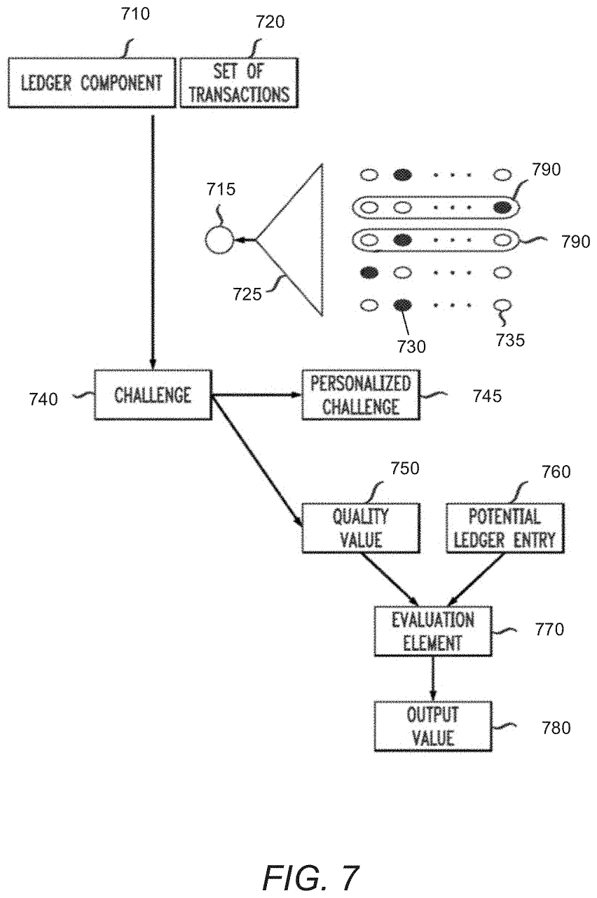

An example of Proof of Space implementations on devices in accordance with some embodiments of the invention is conceptually illustrated in FIG. 7. The implementation includes a ledger component 710, a set of transactions 720, and a challenge 740 computed from a portion of the ledger component 710. A representation 715 of a miner's state may be recorded in the ledger component 710 and be publicly available.

In some embodiments, the material stored on the memory of the device includes a collection of nodes 730, 735, where nodes that depend on other nodes have values that are functions of the values of the associated nodes on which they depend. For example, functions may be one-way functions, such as cryptographic hash functions. In several embodiments the cryptographic hash function may be selected from any of a number of different cryptographic hash functions appropriate to the requirements of specific applications including (but not limited to) the SHA1 cryptographic hash function. In such an example, one node in the network may be a function of three other nodes. Moreover, the node may be computed by concatenating the values associated with these three nodes and applying the cryptographic hash function, assigning the result of the computation to the node depending on these three parent nodes. In this example, the nodes are arranged in rows, where two rows 790 are shown. The nodes are stored by the miner, and can be used to compute values at a setup time. This can be done using Merkle tree hash-based data structures 725, or another structure such as a compression function and/or a hash function.

Challenges 740 may be processed by the miner to obtain personalized challenges 745, made to the device according to the miner's storage capacity. The personalized challenge 745 can be the same or have a negligible change, but could undergo an adjustment to account for the storage space accessible by the miner, as represented by the nodes the miner stores. For example, when the miner does not have a large amount of storage available or designated for use with the Proof of Space system, a personalized challenge 745 may adjust challenges 740 to take this into consideration, thereby making a personalized challenge 745 suitable for the miner's memory configuration.

In some embodiments, the personalized challenge 745 can indicate a selection of nodes 730, denoted in FIG. 7 by filled-in circles. In the FIG. 7 example specifically, the personalized challenge corresponds to one node per row. The collection of nodes selected as a result of computing the personalized challenge 745 can correspond to a valid potential ledger entry 760. However, here a quality value 750 (referred to herein as a qualifying function value) can be computed from the challenge 740, or from other public information that is preferably not under the control of any one miner.

A miner may perform matching evaluations 770 to determine whether the set of selected nodes 730 matches the quality value 750. This process can take into consideration what the memory constraints of the miner are, causing the evaluation 770 to succeed with a greater frequency for larger memory configurations than for smaller memory configurations. This can simultaneously level the playing field to make the likelihood of the evaluation 770 succeeding roughly proportional to the size of the memory used to store the nodes used by the miner. In some embodiments, non-proportional relationships may be created by modifying the function used to compute the quality value 750. When the evaluation 770 results in success, then the output value 780 may be used to confirm the suitability of the memory configuration and validate the corresponding transaction.

In many embodiments, nodes 730 and 735 can correspond to public keys. The miner may submit valid ledger entries, corresponding to a challenge-response pair including one of these nodes. In that case, public key values can become associated with the obtained NFT. As such, miners can use a corresponding secret/private key to sign transaction requests, such as purchases. Additionally, any type of digital signature can be used in this context, such as RSA signatures, Merkle signatures, DSS signatures, etc. Further, the nodes 730 and 735 may correspond to different public keys or to the same public key, the latter preferably augmented with a counter and/or other location indicator such as a matrix position indicator, as described above. Location indicators in accordance with many embodiments of the invention may be applied to point to locations within a given ledger. In accordance with some embodiments of the invention, numerous Proof of Space consensus configurations are possible, some of which are discussed below.

Hybrid methods of evaluating Proof of Space problems can be implemented in accordance with many embodiments of the invention. In many embodiments, hybrid methods can be utilized that conceptually correspond to modifications of Proof of Space protocols in which extra effort is expanded to increase the probability of success, or to compress the amount of space that may be applied to the challenge. Both come at a cost of computational effort, thereby allowing miners to improve their odds of winning by spending greater computational effort. Accordingly, in many embodiments of the invention dual proof-based systems may be used to reduce said computational effort. Such systems may be applied to Proof of Work and Proof of Space schemes, as well as to any other type of mining-based scheme.

When utilizing dual proofs in accordance with various embodiments of the invention, the constituent proofs may have varying structures. For example, one may be based on Proof of Work, another on Proof of Space, and a third may be a system that relies on a trusted organization for controlling the operation, as opposed to relying on mining for the closing of ledgers. Yet other proof structures can be combined in this way. The result of the combination will inherit properties of its components. In many embodiments, the hybrid mechanism may incorporate a first and a second consensus mechanism. In several embodiments, the hybrid mechanism includes a first, a second, and a third consensus mechanisms. In a number of embodiments, the hybrid mechanism includes more than three consensus mechanisms. Systems in accordance with some of these embodiments can utilize consensus mechanisms selected from the group including (but not limited to) Proof of Work, Proof of Space, and Proof of Stake without departing from the scope of the invention. Depending on how each component system is parametrized, different aspects of the inherited properties will dominate over other aspects.

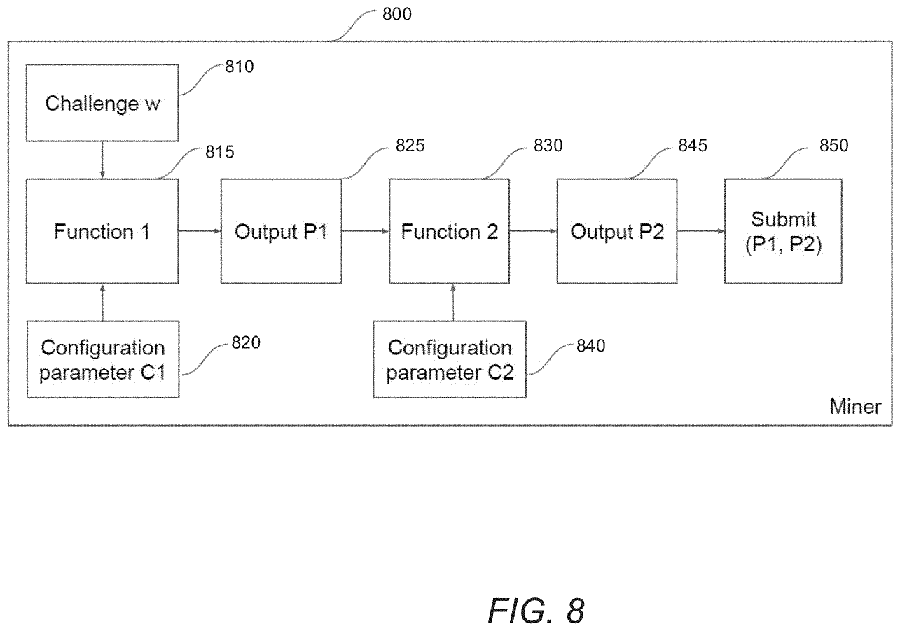

Dual proof configurations in accordance with a number of embodiments of the invention is illustrated in FIG. 8. A proof configuration in accordance with some embodiments of the invention may tend to use the notion of quality functions for tie-breaking among multiple competing correct proofs relative to a given challenge (w) 810. This classification of proof can be described as a qualitative proof, inclusive of proofs of work and proofs of space. In the example reflected in FIG. 8, proofs P1 and P2 are each one of a Proof of Work, Proof of Space, Proof of Stake, and/or any other proof related to a constrained resource, wherein P2 may be of a different type than P1, or may be of the same type.

Systems in accordance with many embodiments of the invention may introduce the notion of a qualifying proof, which, unlike qualitative proofs, are either valid or not valid, using no tie-breaking mechanism. Said systems may include a combination of one or more qualitative proofs and one or more qualifying proofs. For example, it may use one qualitative proof that is combined with one qualifying proof, where the qualifying proof is performed conditional on the successful creation of a qualitative proof. FIG. 8 illustrates challenge w 810, as described above, with a function 1 815, which is a qualitative function, and function 2 830, which is a qualifying function.

To stop miners from expending effort after a certain amount of effort has been spent, thereby reducing the environmental impact of mining, systems in accordance with a number of embodiments of the invention can constrain the search space for the mining effort. This can be done using a configuration parameter that controls the range of random or pseudo-random numbers that can be used in a proof. Upon challenge w 810 being issued to one or more miners 800, it can be input to Function 1 815 along with configuration parameter C1 820. Function 1 815 may output proof P1 825, in this example the qualifying proof to Function 2 830. Function 2 830 is provided with configuration parameter C2 840 and computes qualifying proof P2 845. The miner 800 can then submit the combination of proofs (P1, P2) 850 to a verifier, in order to validate a ledger associated with challenge w 810. In some embodiments, miner 800 can submit the proofs (P1, P2) 850 to be accessed by a 3rd-party verifier.

NFT platforms in accordance with many embodiments of the invention may additionally benefit from alternative energy-efficient consensus mechanisms. Therefore, computer systems in accordance with several embodiments of the invention may instead use consensus-based methods alongside or in place of proof-of-space and proof-of-space based mining. In particular, consensus mechanisms based instead on the existence of a Trusted Execution Environment (TEE), such as ARM TrustZone™ or Intel SGX™ may provide assurances exist of integrity by virtue of incorporating private/isolated processing environments.

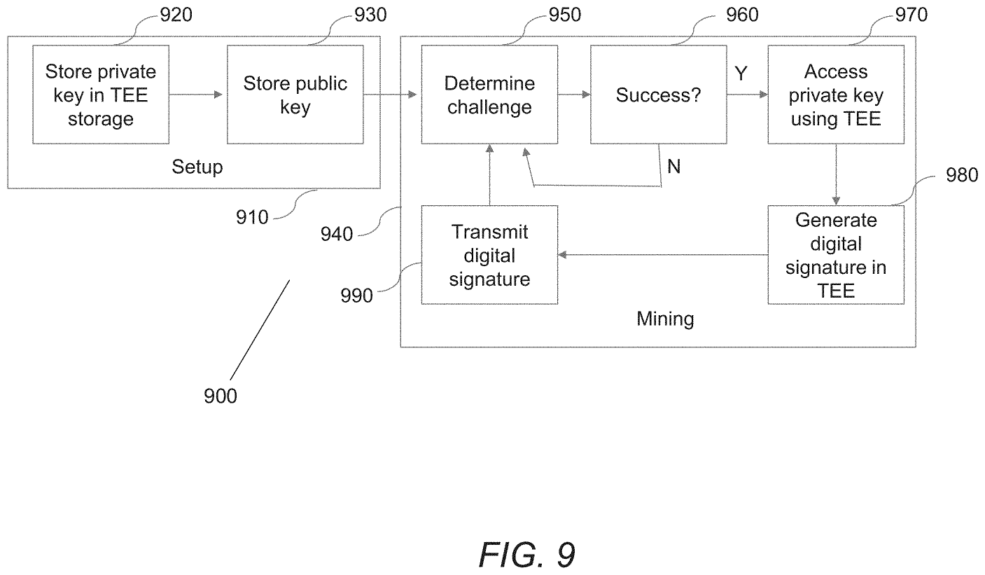

An illustration of sample process 900 undergone by TEE-based consensus mechanisms in accordance with some embodiments of the invention is depicted in FIG. 9. In some such configurations, a setup 910 may be performed by an original equipment manufacturer (OEM) or a party performing configurations of equipment provided by an OEM. Once a private key/public key pair is generated in the secure environment, process 900 may store (920) the private key in TEE storage (i.e. storage associated with the Trusted Execution Environment). While storage may be accessible from the TEE, it can be shielded from applications running outside the TEE. Additionally, processes can store (930) the public key associated with the TEE in any storage associated with the device containing the TEE. Unlike the private key, the public key may be accessible from applications outside the TEE. In a number of embodiments, the public key may be certified. Certification may come from OEMs or trusted entities associated with the OEMs, wherein the certificate can be stored with the public key.

In many embodiments of the invention, mining-directed steps can be influenced by the TEE. In the illustrated embodiment, the process 900 can determine (950) a challenge. For example, this may be by computing a hash of the contents of a ledger. In doing so, process 900 may determine whether the challenge corresponds to success 960. In some embodiments of the invention, the determination of success may result from some pre-set portion of the challenge matching a pre-set portion of the public key, e.g., the last 20 bits of the two values matching. In several embodiments the success determination mechanism may be selected from any of a number of alternate approaches appropriate to the requirements of specific applications. The matching conditions may be modified over time. For example, modification may result from an announcement from a trusted party or based on a determination of a number of participants having reached a threshold value.

When the challenge does not correspond to a success 960, process 900 can return to determine (950) a new challenge. In this context, process 900 can determine (950) a new challenge after the ledger contents have been updated and/or a time-based observation is performed. In several embodiments the determination of a new challenge may come from any of a number of approaches appropriate to the requirements of specific applications, including, but not limited to, the observation of as a second elapsing since the last challenge. If the challenge corresponds to a success 960, then the processing can continue on to access (970) the private key using the TEE.

When the private key is accessed, process can generate (980) a digital signature using the TEE. The digital signature may be on a message that includes the challenge and/or which otherwise references the ledger entry being closed. Process 900 can transmit (980) the digital signature to other participants implementing the consensus mechanism. In cases where multiple digital signatures are received and found to be valid, a tie-breaking mechanism can be used to evaluate the consensus. For example, one possible tie-breaking mechanism may be to select the winner as the party with the digital signature that represents the smallest numerical value when interpreted as a number. In several embodiments the tie-breaking mechanism may be selected from any of a number of alternate tie-breaking mechanisms appropriate to the requirements of specific applications.

Applications and methods in accordance with various embodiments of the invention are not limited to use within NFT platforms. Accordingly, it should be appreciated that consensus mechanisms described herein can be implemented outside the context of an NFT platform network architecture and in contexts unrelated to the storage of fungible tokens and/or NFTs. Moreover, any of the consensus mechanisms described herein with reference to FIGS. 6-9 (including Proof of Work, Proof of Space, Proof of Stake, and/or hybrid mechanisms) can be utilized within any of the blockchains implemented within the NFT platforms described above with reference to FIGS. 3-5B. Various systems and methods for implementing NFT platforms and applications in accordance with numerous embodiments of the invention are discussed further below.

### NFT Platform Constituent Devices and Applications

A variety of computer systems that can be utilized within NFT platforms and systems that utilize NFT blockchains in accordance with various embodiments of the invention are illustrated below. The computer systems in accordance with many embodiments of the invention may implement a processing system 1010, 1120, 1220 using one or more CPUs, GPUs, ASICs, FPGAs, and/or any of a variety of other devices and/or combinations of devices that are typically utilized to perform digital computations. As can readily be appreciated each of these computer systems can be implemented using one or more of any of a variety of classes of computing devices including (but not limited to) mobile phone handsets, tablet computers, laptop computers, personal computers, gaming consoles, televisions, set top boxes and/or other classes of computing device.

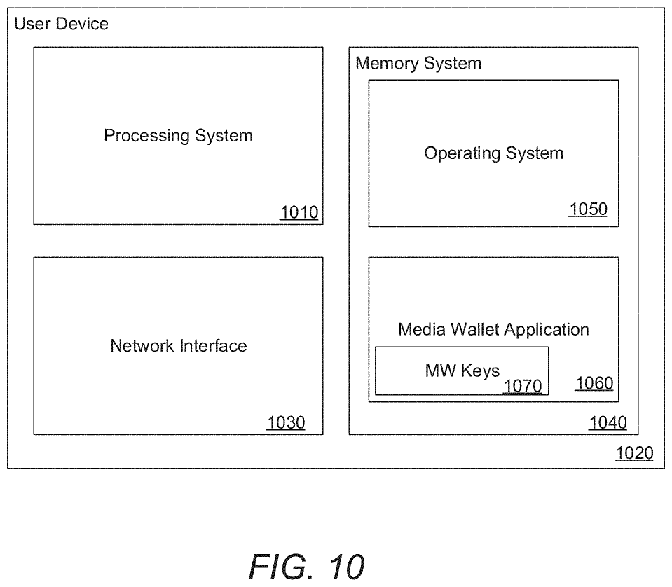

A user device capable of communicating with an NFT platform in accordance with an embodiment of the invention is illustrated in FIG. 10. The memory system 1040 of particular user devices may include an operating system 1050 and media wallet applications 1060. Media wallet applications may include sets of media wallet (MW) keys 1070 that can include public key/private key pairs. The set of MW keys may be used by the media wallet application to perform a variety of actions including, but not limited to, encrypting and signing data. In many embodiments, the media wallet application enables the user device to obtain and conduct transactions with respect to NFTs by communicating with an NFT blockchain via the network interface 1030. In some embodiments, the media wallet applications are capable of enabling the purchase of NFTs using fungible tokens via at least one distributed exchange. User devices may implement some or all of the various functions described above with reference to media wallet applications as appropriate to the requirements of a given application in accordance with various embodiments of the invention.

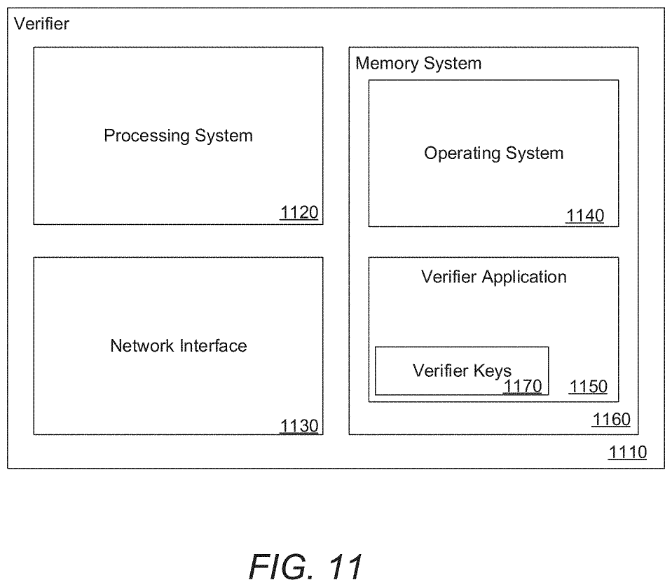

A verifier 1110 capable of verifying blockchain transactions in an NFT platform in accordance with many embodiments of the invention is illustrated in FIG. 11. The memory system 1160 of the verifier computer system includes an operating system 1140 and a verifier application 1150 that enables the verifier 1110 computer system to access a decentralized blockchain in accordance with various embodiments of the invention. Accordingly, the verifier application 1150 may utilize a set of verifier keys 1170 to affirm blockchain entries. When blockchain entries can be verified, the verifier application 1150 may transmit blocks to the corresponding blockchains. The verifier application 1150 can implement some or all of the various functions described above with reference to verifiers as appropriate to the requirements of a given application in accordance with various embodiments of the invention.

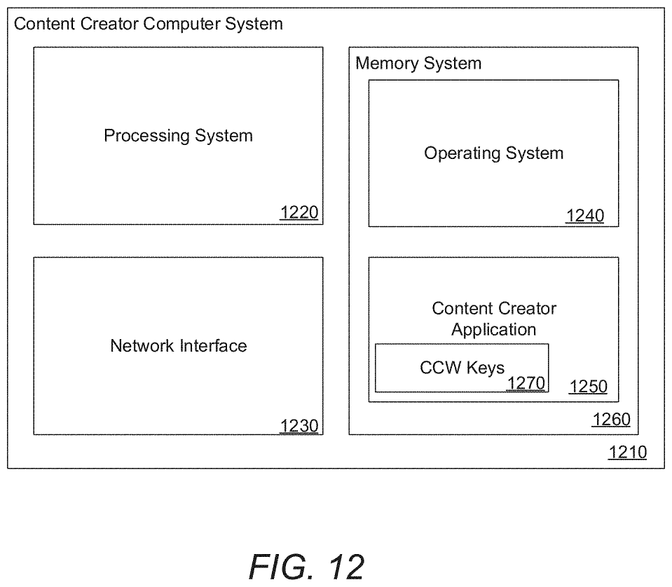

A content creator system 1210 capable of disseminating content in an NFT platform in accordance with an embodiment of the invention is illustrated in FIG. 12. The memory system 1260 of the content creator computer system may include an operating system 1240 and a content creator application 1250. The content creator application 1250 may enable the content creator computer system to mint NFTs by writing smart contracts to blockchains via the network interface 1230. The content creator application can include sets of content creator wallet (CCW) keys 1270 that can include a public key/private key pairs. Content creator applications may use these keys to sign NFTs minted by the content creator application. The content creator application can implement some or all of the various functions described above with reference to content creators as appropriate to the requirements of a given application in accordance with various embodiments of the invention.

Computer systems in accordance with many embodiments of the invention incorporate digital wallets (herein referred to as “wallets” or “media wallets”) for NFT and/or fungible token storage. In several embodiments, the digital wallet may securely store rich media NFTs and/or other tokens. Additionally, in some embodiments, the digital wallet may display user interface through which user instructions concerning data access permissions can be received.

In a number of embodiments of the invention, digital wallets may be used to store at least one type of token-directed content. Example content types may include, but are not limited to crypto currencies of one or more sorts; non-fungible tokens; and user profile data.

Example user profile data may incorporate logs of user actions. In accordance with some embodiments of the invention, example anonymized user profile data may include redacted, encrypted, and/or otherwise obfuscated user data. User profile data in accordance with some embodiments may include, but are not limited to, information related to classifications of interests, determinations of a post-advertisement purchases, and/or characterizations of wallet contents.

Media wallets, when storing content, may store direct references to content. Media wallets may reference content through keys to decrypt and/or access the content. Media wallets may use such keys to additionally access metadata associated with the content. Example metadata may include, but is not limited to, classifications of content. In a number of embodiments, the classification metadata may govern access rights of other parties related to the content.

Access governance rights may include, but are not limited to, whether a party can indicate their relationship with the wallet; whether they can read summary data associated with the content; whether they have access to peruse the content; whether they can place bids to purchase the content; whether they can borrow the content, and/or whether they are biometrically authenticated.

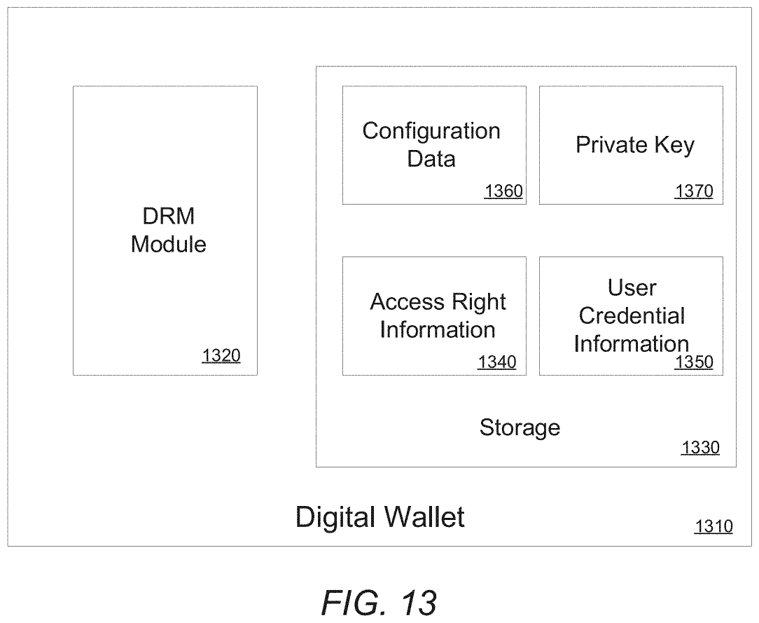

An example of a media wallet 1310 capable of storing rich media NFTs in accordance with an embodiment of the invention is illustrated in FIG. 13. Media wallets 1310 may include a storage component 1330, including access right information 1340, user credential information 1350, token configuration data 1360, and/or at least one private key 1370. In accordance with many embodiments of the invention, a private key 1370 may be used to perform a plurality of actions on resources, including but not limited to decrypting NFT and/or fungible token content. Media wallets may correspond to a public key, referred to as a wallet address. An action performed by private keys 1370 may be used to prove access rights to digital rights management modules. Additionally, private keys 1370 may be applied to initiating ownership transfers and granting NFT and/or fungible token access to alternate wallets. In accordance with some embodiments, access right information 1340 may include lists of elements that the wallet 1310 has access to. Access right information 1340 may express the type of access provided to the wallet. Sample types of access include, but are not limited to, the right to transfer NFT and/or fungible ownership, the right to play rich media associated with a given NFT, and the right to use an NFT and/or fungible token. Different rights may be governed by different cryptographic keys. Additionally, the access right information 1340 associated with a given wallet 1310 may utilize user credential information 1350 from the party providing access.

In accordance with many embodiments of the invention, third parties initiating actions corresponding to requesting access to a given NFT may require user credential information 1350 of the party providing access to be verified. User credential information 1350 may be taken from the group including, but not limited to, a digital signature, hashed passwords, PINs, and biometric credentials. User credential information 1350 may be stored in a manner accessible only to approved devices. In accordance with some embodiments of the invention, user credential information 1350 may be encrypted using a decryption key held by trusted hardware, such as a trusted execution environment. Upon verification, user credential information 1350 may be used to authenticate wallet access.

Available access rights may be determined by digital rights management (DRM) modules 1320 of wallets 1310. In the context of rich media, encryption may be used to secure content. As such, DRM systems may refer to technologies that control the distribution and use of keys required to decrypt and access content. DRM systems in accordance with many embodiments of the invention may require a trusted execution zone. Additionally, said systems may require one or more keys (typically a certificate containing a public key/private key pair) that can be used to communicate with and register with DRM servers. DRM modules 1320 in some embodiments may use one or more keys to communicate with a DRM server. In several embodiments, the DRM modules 1320 may include code used for performing sensitive transactions for wallets including, but not limited to, content access. In accordance with a number of embodiments of the invention, the DRM module 1320 may execute in a Trusted Execution Environment. In a number of embodiments, the DRM may be facilitated by an Operating System (OS) that enables separation of processes and processing storage from other processes and their processing storage.

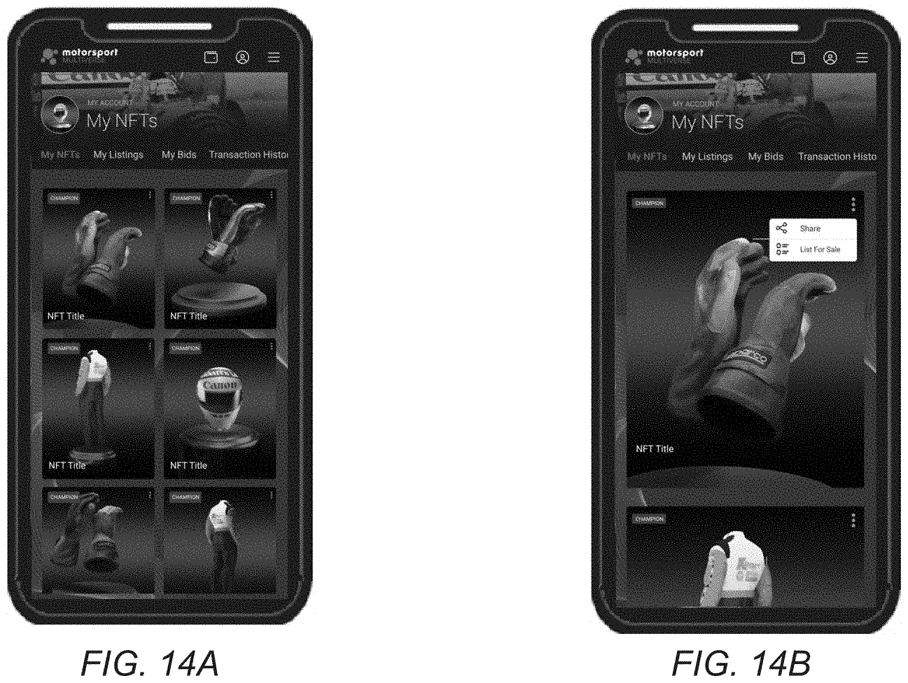

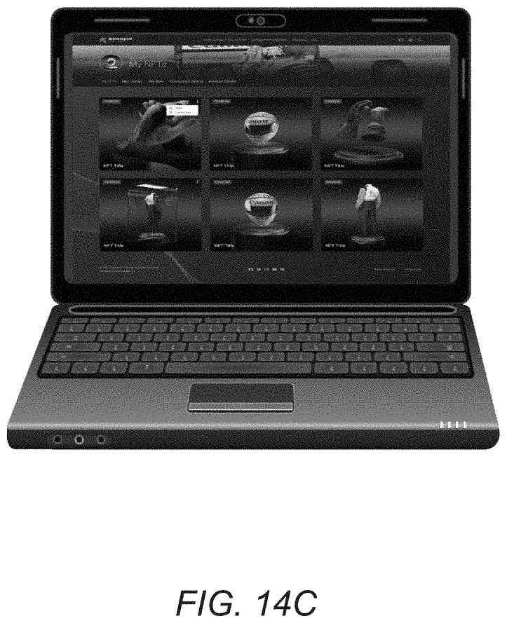

Operation of media wallet applications implemented in accordance with some embodiments of the invention is conceptually illustrated by way of the user interfaces shown in FIGS. 14A-14C. In many embodiments, media wallet applications can refer to applications that are installed upon user devices such as (but not limited to) mobile phones and tablet computers running the iOS, Android and/or similar operating systems. Launching media wallet applications can provide a number of user interface contexts. In many embodiments, transitions between these user interface contexts can be initiated in response to gestures including (but not limited to) swipe gestures received via a touch user interface. As can readily be appreciated, the specific manner in which user interfaces operate through media wallet applications is largely dependent upon the user input capabilities of the underlying user device. In several embodiments, a first user interface context is a dashboard (see, FIGS. 14A, 14C) that can include a gallery view of NFTs owned by the user. In several embodiments, the NFT listings can be organized into category index cards. Category index cards may include, but are not limited to digital merchandise/collectibles, special event access/digital tickets, fan leaderboards. In certain embodiments, a second user interface context (see, for example, FIG. 14B) may display individual NFTs. In a number of embodiments, each NFT can be main-staged in said display with its status and relevant information shown. Users can swipe through each collectible and interacting with the user interface can launch a collectible user interface enabling greater interaction with a particular collectible in a manner that can be determined based upon the smart contract underlying the NFT.

A participant of an NFT platform may use a digital wallet to classify wallet content, including NFTs, fungible tokens, content that is not expressed as tokens such as content that has not yet been minted but for which the wallet can initiate minting, and other non-token content, including executable content, webpages, configuration data, history files and logs. This classification may be performed using a visual user interface. Users interface may enable users to create a visual partition of a space. In some embodiments of the invention, a visual partition may in turn be partitioned into sub-partitions. In some embodiments, a partition of content may separate wallet content into content that is not visible to the outside world (“invisible partition”), and content that is visible at least to some extent by the outside world (“visible partition”). Some of the wallet content may require the wallet use to have an access code such as a password or a biometric credential to access, view the existence of, or perform transactions on. A visible partition may be subdivided into two or more partitions, where the first one corresponds to content that can be seen by anybody, the second partition corresponds to content that can be seen by members of a first group, and/or the third partition corresponds to content that can be seen by members of a second group.

For example, the first group may be users with which the user has created a bond, and invited to be able to see content. The second group may be users who have a membership and/or ownership that may not be controlled by the user. An example membership may be users who own non-fungible tokens (NFTs) from a particular content creator. Content elements, through icons representing the elements, may be relocated into various partitions of the space representing the user wallet. By doing so, content elements may be associated with access rights governed by rules and policies of the given partition.

One additional type of visibility may be partial visibility. Partial visibility can correspond to a capability to access metadata associated with an item, such as an NFT and/or a quantity of crypto funds, but not carry the capacity to read the content, lend it out, or transfer ownership of it. As applied to a video NFT, an observer to a partition with partial visibility may not be able to render the video being encoded in the NFT but see a still image of it and a description indicating its source.

Similarly, a party may have access to a first anonymized profile which states that the user associated with the wallet is associated with a given demographic. The party with this access may be able to determine that a second anonymized profile including additional data is available for purchase. This second anonymized profile may be kept in a sub-partition to which only people who pay a fee have access, thereby expressing a form of membership. Alternatively, only users that have agreed to share usage logs, aspects of usage logs or parts thereof may be allowed to access a given sub-partition. By agreeing to share usage log information with the wallet comprising the sub-partition, this wallet learns of the profiles of users accessing various forms of content, allowing the wallet to customize content, including by incorporating advertisements, and to determine what content to acquire to attract users of certain demographics.

Another type of membership may be held by advertisers who have sent promotional content to the user. These advertisers may be allowed to access a partition that stores advertisement data. Such advertisement data may be encoded in the form of anonymized profiles. In a number of embodiments, a given sub-partition may be accessible only to the advertiser to whom the advertisement data pertains. Elements describing advertisement data may be automatically placed in their associated partitions, after permission has been given by the user. This partition may either be visible to the user. Visibility may depend on a direct request to see “system partitions.” A first partition may correspond to material associated with a first set of public keys, a second partition to material associated with a second set of public keys not overlapping with the first set of public keys, wherein such material may comprise tokens such as crypto coins and NFTs. A third partition may correspond to usage data associated with the wallet user, and a fourth partition may correspond to demographic data and/or preference data associated with the wallet user. Yet other partitions may correspond to classifications of content, e.g., child-friendly vs. adult; classifications of whether associated items are for sale or not, etc.

The placing of content in a given partition may be performed by a drag-and-drop action performed on a visual interface. By selecting items and clusters and performing a drag-and-drop to another partition and/or to a sub-partition, the visual interface may allow movement including, but not limited to, one item, a cluster of items, and a multiplicity of items and clusters of items. The selection of items can be performed using a lasso approach in which items and partitions are circled as they are displayed. The selection of items may be performed by alternative methods for selecting multiple items in a visual interface, as will be appreciated by a person of skill in the art.

Some content classifications may be automated in part or full. For example, when user place ten artifacts, such as NFTs describing in-game capabilities, in a particular partition, they may be asked if additional content that are in-game capabilities should be automatically placed in the same partition as they are acquired and associated with the wallet. When “yes” is selected, then this placement may be automated in the future. When “yes, but confirm for each NFT” is selected, then users can be asked, for each automatically classified element, to confirm its placement. Before the user confirms, the element may remain in a queue that corresponds to not being visible to the outside world. When users decline given classifications, they may be asked whether alternative classifications should be automatically performed for such elements onwards. In some embodiments, the selection of alternative classifications may be based on manual user classification taking place subsequent to the refusal.

Automatic classification of elements may be used to perform associations with partitions and/or folders. The automatic classification may be based on machine learning (ML) techniques considering characteristics including, but not limited to, usage behaviors exhibited by the user relative to the content to be classified, labels associated with the content, usage statistics; and/or manual user classifications of related content.

Multiple views of wallets may be accessible. One such view can correspond to the classifications described above, which indicates the actions and interactions others can perform relative to elements. Another view may correspond to a classification of content based on use, type, and/or users-specified criterion. For example, all game NFTs may be displayed in one collection view. The collection view may further subdivide the game NFTs into associations with different games or collections of games. Another collection may show all audio content, clustered based on genre. users-specified classification may be whether the content is for purposes of personal use, investment, or both. A content element may show up in multiple views. users can search the contents of his or her wallet by using search terms that result in potential matches.

Alternatively, the collection of content can be navigated based the described views of particular wallets, allowing access to content. Once a content element has been located, the content may be interacted with. For example, located content elements may be rendered. One view may be switched to another after a specific item is found. For example, this may occur through locating an item based on its genre and after the item is found, switching to the partitioned view described above. In some embodiments, wallet content may be rendered using two or more views in a simultaneous manner. They may select items using one view.

Media wallet applications in accordance with various embodiments of the invention are not limited to use within NFT platforms. Accordingly, it should be appreciated that applications described herein can be implemented outside the context of an NFT platform network architecture and in contexts unrelated to the storage of fungible tokens and/or NFTs. Moreover, any of the computer systems described herein with reference to FIGS. 10-14C can be utilized within any of the NFT platforms described above.

### NFT Platform NFT Interactions

NFT platforms in accordance with many embodiments of the invention may incorporate a wide variety of rich media NFT configurations. The term “Rich Media Non-Fungible Tokens” can be used to refer to blockchain-based cryptographic tokens created with respect to a specific piece of rich media content and which incorporate programmatically defined digital rights management. In some embodiments of the invention, each NFT may have a unique serial number and be associated with a smart contract defining an interface that enables the NFT to be managed, owned and/or traded.

Under a rich media blockchain in accordance with many embodiments of the invention, a wide variety of NFT configurations may be implemented. Some NFTs may be referred to as anchored NFTs (or anchored tokens), used to tie some element, such as a physical entity, to an identifier. Of this classification, one sub-category may be used to tie users' real-world identities and/or identifiers to a system identifier, such as a public key. In this disclosure, this type of NFT applied to identifying users, may be called a social NFT, identity NFT, identity token, and a social token. In accordance with many embodiments of the invention, an individual's personally identifiable characteristics may be contained, maintained, and managed throughout their lifetime so as to connect new information and/or NFTs to the individual's identity. A social NFT's information may include, but are not limited to, personally identifiable characteristics such as name, place and date of birth, and/or biometrics.

An example social NFT may assign a DNA print to a newborn's identity. In accordance with a number of embodiments of the invention, this first social NFT might then be used in the assignment process of a social security number NFT from the federal government. In some embodiments, the first social NFT may then be associated with some rights and capabilities, which may be expressed in other NFTs. Additional rights and capabilities may be directly encoded in a policy of the social security number NFT.

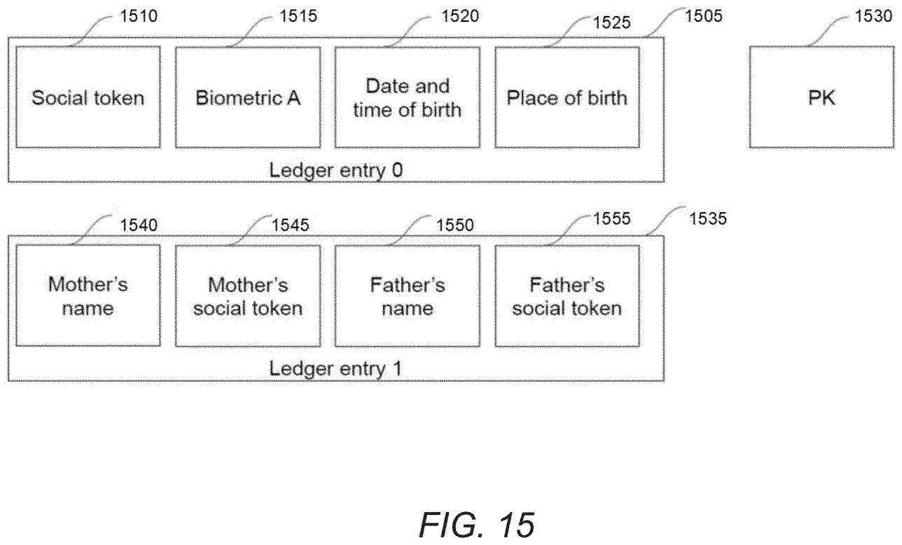

A social NFT may exist on a personalized branch of a centralized and/or decentralized blockchain. Ledger entries related to an individual's social NFT in accordance with several embodiments of the invention are depicted in FIG. 15. Ledger entries of this type may be used to build an immutable identity foundation whereby biometrics, birth and parental information are associated with an NFT. As such, this information may be protected with encryption using a private key 1530. The initial entry in a ledger, “ledger entry 0” 1505, may represent a social token 1510 assignment to an individual with a biometric “A” 1515. In this embodiment, the biometric may include but is not limited to a footprint, a DNA print, and a fingerprint. The greater record may include the individual's date and time of birth 1520 and place of birth 1525. A subsequent ledger entry 1 1535 may append parental information including but not limited to mothers' name 1540, mother's social token 1545, father's name 1550, and father's social token 1555.

In a number of embodiments, the various components that make up a social NFT may vary from situation to situation. In a number of embodiments, biometrics and/or parental information may be unavailable in a given situation and/or period of time. Other information including, but not limited to, race gender, and governmental number assignments such as social security numbers, may be desirable to include in the ledger. In a blockchain, future NFT creation may create a life-long ledger record of an individual's public and private activities. In accordance with some embodiments, the record may be associated with information including, but not limited to, identity, purchases, health and medical records, access NFTs, family records such as future offspring, marriages, familial history, photographs, videos, tax filings, and/or patent filings. The management and/or maintenance of an individual's biometrics throughout the individual's life may be immutably connected to the first social NFT given the use of a decentralized blockchain ledger.

In some embodiments, a certifying third party may generate an NFT associated with certain rights upon the occurrence of a specific event. In one such embodiment, the DMV may be the certifying party and generate an NFT associated with the right to drive a car upon issuing a traditional driver's license. In another embodiment, the certifying third party may be a bank that verifies a person's identity papers and generates an NFT in response to a successful verification. In a third embodiment, the certifying party may be a car manufacturer, who generates an NFT and associates it with the purchase and/or lease of a car.

In many embodiments, a rule may specify what types of policies the certifying party may associate with the NFT. Additionally, a non-certified entity may generate an NFT and assert its validity. This may require putting up some form of security. In one example, security may come in the form of a conditional payment associated with the NFT generated by the non-certified entity. In this case, the conditional payment may be exchangeable for funds if abuse can be detected by a bounty hunter and/or some alternate entity. Non-certified entities may relate to a publicly accessible reputation record describing the non-certified entity's reputability.

Anchored NFTs may additionally be applied to automatic enforcement of programming rules in resource transfers. NFTs of this type may be referred to as promise NFTs. A promise NFT may include an agreement expressed in a machine-readable form and/or in a human-accessible form. In a number of embodiments, the machine-readable and human-readable elements can be generated one from the other. In some embodiments, an agreement in a machine-readable form may include, but is not limited to, a policy and/or an executable script. In some embodiments, an agreement in a human-readable form may include, but is not limited to, a text and/or voice-based statement of the promise.

In some embodiments, regardless of whether the machine-readable and human-readable elements are generated from each other, one can be verified based on the other. Smart contracts including both machine-readable statements and human-accessible statements may be used outside the implementation of promise NFTs. Moreover, promise NFTs may be used outside actions taken by individual NFTs and/or NFT-owners. In some embodiments, promise NFTs may relate to general conditions, and may be used as part of a marketplace.

In one such example, horse betting may be performed through generating a first promise NFT that offers a payment of $10 if a horse does not win. Payment may occur under the condition that the first promise NFT is matched with a second promise NFT that causes a transfer of funds to a public key specified with the first promise NFT if horse X wins.

A promise NFT may be associated with actions that cause the execution of a policy and/or rule indicated by the promise NFT. In some embodiments of the invention, a promise of paying a charity may be associated with the sharing of an NFT. In this embodiment, the associated promise NFT may identify a situation that satisfies the rule associated with the promise NFT, thereby causing the transfer of funds when the condition is satisfied (as described above). One method of implementation may be embedding in and/or associating a conditional payment with the promise NFT. A conditional payment NFT may induce a contract causing the transfer of funds by performing a match. In some such methods, the match may be between the promise NFT and inputs that identify that the conditions are satisfied, where said input can take the form of another NFT. In a number of embodiments, one or more NFTs may relate to investment opportunities.

For example, a first NFT may represent a deed to a first building, and a second NFT a deed to a second building. Moreover, the deed represented by the first NFT may indicate that a first party owns the first property. The deed represented by the second NFT may indicate that a second party owns the second property. A third NFT may represent one or more valuations of the first building. The third NFT may in turn be associated with a fourth NFT that may represent credentials of a party performing such a valuation. A fifth NFT may represent one or more valuations of the second building. A sixth may represent the credentials of one of the parties performing a valuation. The fourth and sixth NFTs may be associated with one or more insurance policies, asserting that if the parties performing the valuation are mistaken beyond a specified error tolerance, then the insurer would pay up to a specified amount.

A seventh NFT may then represent a contract that relates to the planned acquisition of the second building by the first party, from the second party, at a specified price. The seventh NFT may make the contract conditional provided a sufficient investment and/or verification by a third party. A third party may evaluate the contract of the seventh NFT, and determine whether the terms are reasonable. After the evaluation, the third party may then verify the other NFTs to ensure that the terms stated in the contract of the seventh NFT agree. If the third party determines that the contract exceeds a threshold in terms of value to risk, as assessed in the seventh NFT, then executable elements of the seventh NFT may cause transfers of funds to an escrow party specified in the contract of the sixth NFT.

Alternatively, the first party may initiate the commitment of funds, conditional on the remaining funds being raised within a specified time interval. The commitment of funds may occur through posting the commitment to a ledger. Committing funds may produce smart contracts that are conditional on other events, namely the payments needed to complete the real estate transaction. The smart contract may have one or more additional conditions associated with it. For example, an additional condition may be the reversal of the payment if, after a specified amount of time, the other funds have not been raised. Another condition may be related to the satisfactory completion of an inspection and/or additional valuation.

NFTs may be used to assert ownership of virtual property. Virtual property in this instance may include, but is not limited to, rights associated with an NFT, rights associated with patents, and rights associated with pending patents. In a number of embodiments, the entities involved in property ownership may be engaged in fractional ownership. In some such embodiments, two parties may wish to purchase an expensive work of digital artwork represented by an NFT. The parties can enter into smart contracts to fund and purchase valuable works. After a purchase, an additional NFT may represent each party's contribution to the purchase and equivalent fractional share of ownership.

Another type of NFTs that may relate to anchored NFTs may be called “relative NFTs.” This may refer to NFTs that relate two or more NFTs to each other. Relative NFTs associated with social NFTs may include digital signatures that is verified using a public key of a specific social NFT. In some embodiments, an example of a relative NFT may be an assertion of presence in a specific location, by a person corresponding to the social NFT. This type of relative NFT may be referred to as a location NFT and a presence NFT. Conversely, a signature verified using a public key embedded in a location NFT may be used as proof that an entity sensed by the location NFT is present. Relative NFTs are derived from other NFTs, namely those they relate to, and therefore may be referred to as derived NFTs. An anchored NFT may tie to another NFT, which may make it both anchored and relative. An example of such may be called pseudonym NFTs.

Pseudonym NFTs may be a kind of relative NFT acting as a pseudonym identifier associated with a given social NFT. In some embodiments, pseudonym NFTs may, after a limited time and/or a limited number of transactions, be replaced by a newly derived NFTs expressing new pseudonym identifiers. This may disassociate users from a series of recorded events, each one of which may be associated with different pseudonym identifiers. A pseudonym NFT may include an identifier that is accessible to biometric verification NFTs. Biometric verification NFTs may be associated with a TEE and/or DRM which is associated with one or more biometric sensors. Pseudonym NFTs may be output by social NFTs and/or pseudonym NFTs.

Inheritance NFTs may be another form of relative NFTs, that transfers rights associated with a first NFT to a second NFT. For example, computers, represented by an anchored NFT that is related to a physical entity (the hardware), may have access rights to WiFi networks. When computers are replaced with newer models, users may want to maintain all old relationships, for the new computer. For example, users may want to retain WiFi hotspots. For this to be facilitated, a new computer can be represented by an inheritance NFT, inheriting rights from the anchored NFT related to the old computer. An inheritance NFT may acquire some or all pre-existing rights associated with the NFT of the old computer, and associate those with the NFT associated with the new computer.

More generally, multiple inheritance NFTs can be used to selectively transfer rights associated with one NFT to one or more NFTs, where such NFTs may correspond to users, devices, and/or other entities, when such assignments of rights are applicable. Inheritance NFTs can be used to transfer property. One way to implement the transfer of property can be to create digital signatures using private keys. These private keys may be associated with NFTs associated with the rights. In accordance with a number of embodiments, transfer information may include the assignment of included rights, under what conditions the transfer may happen, and to what NFT(s) the transfer may happen. In this transfer, the assigned NFTs may be represented by identifies unique to these, such as public keys. The digital signature and message may then be in the form of an inheritance NFT, or part of an inheritance NFT. As rights are assigned, they may be transferred away from previous owners to new owners through respective NFTs. Access to financial resources is one such example.

However, sometimes rights may be assigned to new parties without taking the same rights away from the party (i.e., NFT) from which the rights come. One example of this may be the right to listen to a song, when a license to the song is sold by the artist to consumers. However, if the seller sells exclusive rights, this causes the seller not to have the rights anymore.

In accordance with many embodiments of the invention, multiple alternative NFT configurations may be implemented. One classification of NFT may be an employee NFT or employee token. Employee NFTs may be used by entities including, but not limited to, business employees, students, and organization members. Employee NFTs may operate in a manner analogous to key card photo identifications. In a number of embodiments, employee NFTs may reference information including, but not limited to, company information, employee identity information and/or individual identity NFTs.

Additionally, employee NFTs may include associated access NFT information including but not limited to, what portions of a building employees may access, and what computer system employees may utilize. In several embodiments, employee NFTs may incorporate their owner's biometrics, such as a face image. In a number of embodiments, employee NFTs may operate as a form of promise NFT. In some embodiments, employee NFT may comprise policies or rules of employing organization. In a number of embodiments, the employee NFT may reference a collection of other NFTs.

Another type of NFT may be referred to as the promotional NFT or promotional token. Promotional NFTs may be used to provide verification that promoters provide promotion winners with promised goods. In some embodiments, promotional NFTs may operate through decentralized applications for which access restricted to those using an identity NFT. The use of a smart contract with a promotional NFT may be used to allow for a verifiable release of winnings. These winnings may include, but are not limited to, cryptocurrency, money, and gift card NFTs useful to purchase specified goods. Smart contracts used alongside promotional NFTs may be constructed for winners selected through random number generation.

Another type of NFT may be called the script NFT or script token. Script tokens may incorporate script elements including, but not limited to, story scripts, plotlines, scene details, image elements, avatar models, sound profiles, and voice data for avatars. Script tokens may utilize rules and policies that describe how script elements are combined. Script tokens may include rightsholder information, including but not limited to, licensing and copyright information. Executable elements of script tokens may include instructions for how to process inputs; how to configure other elements associated with the script tokens; and how to process information from other tokens used in combination with script tokens.

Script tokens may be applied to generate presentations of information. In accordance with some embodiments, these presentations may be developed on devices including but not limited to traditional computers, mobile computers, and virtual reality display devices. Script tokens may be used to provide the content for game avatars, digital assistant avatars, and/or instructor avatars. Script tokens may comprise audio-visual information describing how input text is presented, along with the input text that provides the material to be presented. It may comprise what may be thought of as the personality of the avatar, including how the avatar may react to various types of input from an associated user.

In some embodiments, script NFTs may be applied to govern behavior within an organization. For example, this may be done through digital signatures asserting the provenance of the scripts. Script NFTs may also, in full and/or in part, be generated by freelancers. For example, a text script related to a movie, an interactive experience, a tutorial, and/or other material, may be created by an individual content creator. This information may then be combined with a voice model or avatar model created by an established content producer. The information may then be combined with a background created by additional parties. Various content producers can generate parts of the content, allowing for large-scale content collaboration.

Features of other NFTs can be incorporated in a new NFT using techniques related to inheritance NFTs, and/or by making references to other NFTs. As script NFTs may consist of multiple elements, creators with special skills related to one particular element may generate and combine elements. This may be used to democratize not only the writing of storylines for content, but outsourcing for content production. For each such element, an identifier establishing the origin or provenance of the element may be included. Policy elements can be incorporated that identify the conditions under which a given script element may be used. Conditions may be related to, but are not limited to execution environments, trusts, licenses, logging, financial terms for use, and various requirements for the script NFTs. Requirements may concern, but are not limited to, what other types of elements the given element are compatible with, what is allowed to be combined with according the terms of service, and/or local copyright laws that must be obeyed.

Evaluation units may be used with various NFT classifications to collect information on their use. Evaluation units may take a graph representing subsets of existing NFTs and make inferences from the observed graph component. From this, valuable insights into NFT value may be derived. For example, evaluation units may be used to identify NFTs whose popularity is increasing or waning. In that context, popularity may be expressed as, but not limited to, the number of derivations of the NFT that are made; the number of renderings, executions or other uses are made; and the total revenue that is generated to one or more parties based on renderings, executions or other uses.

Evaluation units may make their determination through specific windows of time and/or specific collections of end-users associated with the consumption of NFT data in the NFTs. Evaluation units may limit assessments to specific NFTs (e.g., script NFTs). This may be applied to identify NFTs that are likely to be of interest to various users. In addition, systems in accordance with various embodiments may use rule-based approaches to identify NFTs of importance, wherein importance may be ascribed to, but is not limited to, the origination of the NFTs, the use of the NFTs, the velocity of content creation of identified clusters or classes, the actions taken by consumers of NFT, including reuse of NFTs, the lack of reuse of NFTs, and the increased or decreased use of NFTs in selected social networks.

Evaluations may be repurposed through recommendation mechanisms for individual content consumers and/or as content originators. Another example may address the identification of potential combination opportunities, by allowing ranking based on compatibility. Accordingly, content creators such as artists, musicians and programmers can identify how to make their content more desirable to intended target groups.

The generation of evaluations can be supported by methods including, but not limited to machine learning (ML) methods, artificial intelligence (AI) methods, and/or statistical methods. Anomaly detection methods developed to identify fraud can be repurposed to identify outliers. This can be done to flag abuse risks or to improve the evaluation effort.

Multiple competing evaluation units can make competing predictions using alternative and proprietary algorithms. Thus, different evaluation units may be created to identify different types of events to different types of subscribers, monetizing their insights related to the data they access.

In a number of embodiments, evaluation units may be a form of NFTs that derive insights from massive amounts of input data. Input data may correspond, but is not limited to the graph component being analyzed. Such NFTs may be referred to as evaluation unit NFTs.

The minting of NFTs may associate rights with first owners and/or with an optional one or more policies and protection modes. An example policy and/or protection mode directed to financial information may express royalty requirements. An example policy and/or protection mode directed to non-financial requirements may express restrictions on access and/or reproduction. An example policy directed to data collection may express listings of user information that may be collected and disseminated to other participants of the NFT platform.

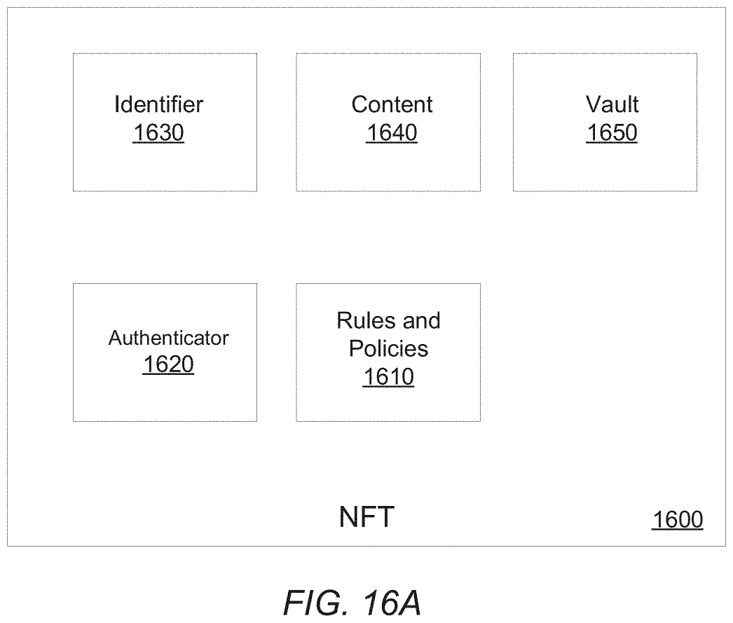

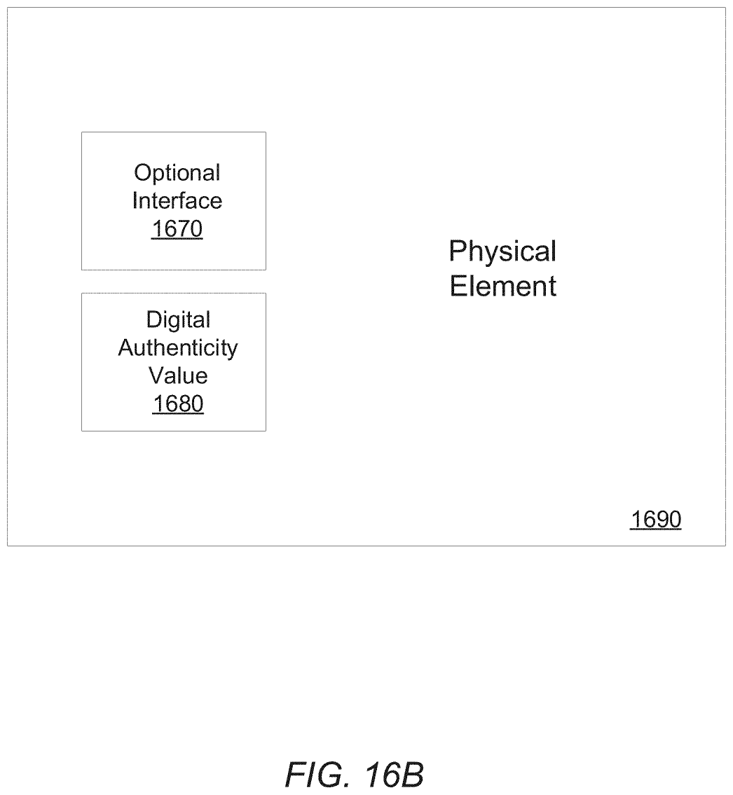

An example NFT which may be associated with specific content in accordance with several embodiments of the invention is illustrated in FIG. 16. In some embodiments, an NFT 1600 may utilize a vault 1650, which may control access to external data storage areas. Methods of controlling access may include, but are not limited to, user credential information 1350. In accordance with a number of embodiments of the invention, control access may be managed through encrypting content 1640. As such, NFTs 1600 can incorporate content 1640, which may be encrypted, not encrypted, yet otherwise accessible, or encrypted in part. In accordance with some embodiments, an NFT 1600 may be associated with one or more content 1640 elements, which may be contained in or referenced by the NFT. A content 1640 element may include, but is not limited to, an image, an audio file, a script, a biometric user identifier, and/or data derived from an alternative source. An example alternative source may be a hash of biometric information). An NFT 1600 may include an authenticator 1620 capable of affirming that specific NFTs are valid.

In accordance with many embodiments of the invention, NFTs may include a number of rules and policies 1610. Rules and policies 1610 may include, but are not limited to access rights information 1340. In some embodiments, rules and policies 1610 may state terms of usage, royalty requirements, and/or transfer restrictions. An NFT 1600 may include an identifier 1630 to affirm ownership status. In accordance with many embodiments of the invention, ownership status may be expressed by linking the identifier 1630 to an address associated with a blockchain entry.

In accordance with a number of embodiments of the invention, NFTs may represent static creative content. NFTs may be representative of dynamic creative content, which changes over time. In accordance with many examples of the invention, the content associated with an NFT may be a digital content element.

One example of a digital content element in accordance with some embodiments may be a set of five images of a mouse. In this example, the first image may be an image of the mouse being alive. The second may be an image of the mouse eating poison. The third may be an image of the mouse not feeling well. The fourth image may be of the mouse, dead. The fifth image may be of a decaying mouse.

The user credential information 1350 of an NFT may associate each image to an identity, such as of the artist. In accordance with a number of embodiments of the invention, NFT digital content can correspond to transitions from one representation (e.g., an image of the mouse, being alive) to another representation (e.g., of the mouse eating poison). In this disclosure, digital content transitioning from one representation to another may be referred to as a state change and/or an evolution. In a number of embodiments, an evolution may be triggered by the artist, by an event associated with the owner of the artwork, randomly, and/or by an external event.

When NFTs representing digital content are acquired in accordance with some embodiments of the invention, they may be associated with the transfer of corresponding physical artwork, and/or the rights to said artwork. The first ownership records for NFTs may correspond to when the NFT was minted, at which time its ownership can be assigned to the content creator. Additionally, in the case of “lazy” minting, rights may be directly assigned to a buyer.

In some embodiments, as a piece of digital content evolves, it may change its representation. The change in NFTs may send a signal to an owner after it has evolved. In doing so, a signal may indicate that the owner has the right to acquire the physical content corresponding to the new state of the digital content. Under an earlier example, buying a live mouse artwork, as an NFT, may carry the corresponding painting, and/or the rights to it. A physical embodiment of an artwork that corresponds to that same NFT may be able to replace the physical artwork when the digital content of the NFT evolves. For example, should the live mouse artwork NFT change states to a decaying mouse, an exchange may be performed of the corresponding painting for a painting of a decaying mouse.

The validity of one of the elements, such as the physical element, can be governed by conditions related to an item with which it is associated. For example, a physical painting may have a digital authenticity value that attests to the identity of the content creator associated with the physical painting.

An example of a physical element 1690 corresponding to an NFT, in accordance with some embodiments of the invention is illustrated in FIG. 16. A physical element 1690 may be a physical artwork including, but not limited to, a drawing, a statue, and/or another physical representation of art. In a number of embodiments, physical representations of the content (which may correspond to a series of paintings) may each be embedded with a digital authenticity value (or a validator value) value. In accordance with many embodiments of the invention, a digital authenticity value (DAV) 1680 may be therefore be associated with a physical element 1690 and a digital element. A digital authenticity value may be a value that includes an identifier and a digital signature on the identifier. In some embodiments the identifier may specify information related to the creation of the content. This information may include the name of the artist, the identifier 1630 of the digital element corresponding to the physical content, a serial number, information such as when it was created, and/or a reference to a database in which sales data for the content is maintained. A digital signature element affirming the physical element may be made by the content creator and/or by an authority associating the content with the content creator.

In some embodiments, the digital authenticity value 1680 of the physical element 1690 can be expressed using a visible representation. The visible representation may be an optional physical interface 1670 taken from a group including, but not limited to, a barcode and a quick response (QR) code encoding the digital authenticity value. In some embodiments, the encoded value may be represented in an authenticity database. Moreover, the physical interface 1670 may be physically associated with the physical element. One example of such may be a QR tag being glued to or printed on the back of a canvas. In some embodiments of the invention, the physical interface 1670 may be possible to physically disassociate from the physical item it is attached to. However, if a DAV 1680 is used to express authenticity of two or more physical items, the authenticity database may detect and block a new entry during the registration of the second of the two physical items. For example, if a very believable forgery is made of a painting the forged painting may not be considered authentic without the QR code associated with the digital element.

In a number of embodiments, the verification of the validity of a physical item, such as a piece of artwork, may be determined by scanning the DAV. In some embodiments, scanning the DAV may be used to determine whether ownership has already been assigned. Using techniques like this, each physical item can be associated with a control that prevents forgeries to be registered as legitimate, and therefore, makes them not valid. In the context of a content creator receiving a physical element from an owner, the content creator can deregister the physical element 1690 by causing its representation to be erased from the authenticity database used to track ownership. Alternatively, in the case of an immutable blockchain record, the ownership blockchain may be appended with new information. Additionally, in instances where the owner returns a physical element, such as a painting, to a content creator in order for the content creator to replace it with an “evolved” version, the owner may be required to transfer the ownership of the initial physical element to the content creator, and/or place the physical element in a stage of being evolved.

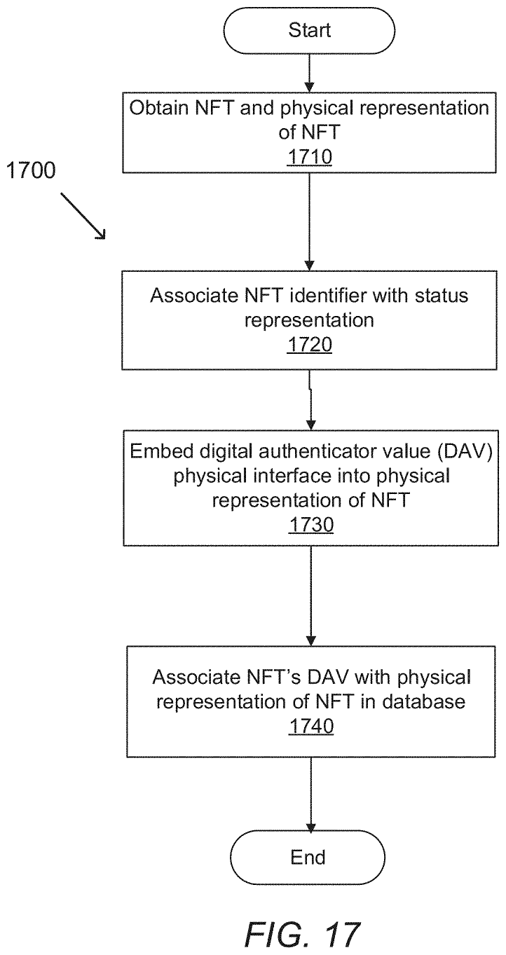

An example of a process for connecting an NFT digital element to physical content in accordance with some embodiments of the invention is illustrated in FIG. 17. Process 1700 may obtain (1710) an NFT and a physical representation of the NFT in connection with an NFT transaction. Under the earlier example, this may be a painting of a living mouse and an NFT of a living mouse. By virtue of establishing ownership of the NFT, the process 1700 may associate (1720) an NFT identifier with a status representation of the NFT. The NFT identifier may specify attributes including, but not limited to, the creator of the mouse painting and NFT (“Artist”), the blockchain the NFT is on (“NFT-Chain”), and an identifying value for the digital element (“no. 0001”). Meanwhile, the status representation may clarify the present state of the NFT (“alive mouse”). Process 1700 may embed (1730) a DAV physical interface into the physical representation of the NFT. In a number of embodiments of the invention, this may be done by implanting a QR code into the back of the mouse painting. In affirming the connection between the NFT and painting, Process 1700 can associate (1740) the NFT's DAV with the physical representation of the NFT in a database. In some embodiments, the association can be performed through making note of the transaction and clarifying that it encapsulates both the mouse painting and the mouse NFT.

While specific processes are described above with reference to FIGS. 15-17, NFTs can be implemented in any of a number of different ways to enable as appropriate to the requirements of specific applications in accordance with various embodiments of the invention. Additionally, the specific manner in which NFTs can be utilized within NFT platforms in accordance with various embodiments of the invention is largely dependent upon the requirements of a given application.

### NFT Platform Immersive Environment Facilitation

NFT platforms in accordance with many embodiments of the invention may implement systems directed to incorporating immersive environments to NFT management. An immersive environment may refer to, but is not limited to Augmented Reality (AR), Virtual Reality (VR) and Mixed Reality (MR) environments. In some embodiments of the invention, immersive environments may incorporate a series of techniques and user interfaces in order to enable the transferal and consumption of NFTs within NFT platforms.

### A. Immersive Environment Implementation

A number of embodiments of the invention may utilize a virtual reality component that can combine data from multiple sources to be rendered in a VR environment. Rendering of data sources may be performed on a rendering unit. A rendering unit may, for example, be a VR headset.

For example, a background source may be rendered to be applied to backgrounds for VR environments. Background sources in accordance with some embodiments of the invention may be obtained using optical and/or auditory instruments, including but not limited to, cameras and/or microphones. Instruments used to obtain background sources may represent the areas being viewed by the users of the instruments. An example user may be the wearer of a VR headset. In certain embodiments, background sources can be obtained from location sources that are externally selected. Background sources in accordance with various embodiments of the invention may be rendered to represent locales including, but not limited to, an office, a park, and/or the home of an additional participant of the VR environment.

Character sources in accordance with certain embodiments of the invention may be rendered to become facial elements that represent participants. In numerous embodiments, facial elements may be obtained from additional participants of the VR environment. Character sources may be obtained using optical and/or auditory instruments, including but not limited to, cameras and microphones. Facial elements may represent elements including, but not limited to, participants, the facial expressions of participants, and/or the audio input of participants. Audio input in accordance with several embodiments of the invention may include, but is not limited to, spoken words captured by microphones associated with participants. In numerous embodiments, character sources can be taken from characters. Character sources may, for example, be the face of a fictional character. Character sources may be used to create character representations of living beings, including but not limited to participants and/or famous people. For example, character sources may be selected from, but not limited to, oneself, anime characters, cartoon characters, book characters, and/or celebrities. Once chosen, character sources may be modified in real-time to render in a manner representative of the corresponding facial expressions of participants. For example, character sources may include features of both the participant and an anime character. In cases where a character source corresponds to a human face, there may be a visual indication of whether the rendered facial elements correspond to the other participant. In many embodiments, there may be a visual indication of when the rendered facial elements correspond to a representation of a person selected to represent this other participant (e.g., a celebrity).

In several embodiments, rights to use fictional characters and/or people as character sources may be obtained by the participants through the purchase of non-fungible tokens (NFTs). Rights to use fictional characters and/or people may be incorporated as part of using of material tied to commercial content, including, but not limited to product promotions. NFTs may come with limited rights of use regarding the relevant entities. Limitations may include, but are not limited to, time constraints, usage restrictions, and compatibility with other NFTs (including, but not limited to, alternate voices that may be implemented in the form of policies). In various embodiments, viewers of the participant's image may be able to select from several facial element options that the participant has made available. For example, a viewer may be able to choose whether the participants' facial elements reflect a cartoon character and/or a famous athlete. An indication can be provided when the represented visual is of a real person other than the participant. This indication may be absent for representations of fictional persons, for example, Santa Claus. In certain embodiments, indications may be displayed based on a user's preferences. Indications can, for example, be a small text associated with the visual of the “impersonated” participant, said indication specifying that this is not that person.

In several embodiments, sources can include connective visual sources. Connective visuals in accordance with a variety of embodiments of the invention may be used to smooth the combination between participants and other sources. For example, if a participant, in reality, is sitting down wearing pajamas, when a background source is a crowded bar, then the connective visual source may include the visual of a person standing up, dressed in clothing fit for a bar. In such an example, the participant may select, from the connective visual source, a leather jacket and/or other bar appropriate clothing. In this example, the visuals of the connective visual source may combine with the facial elements of a character source.

Features of one source may be interwoven with the other sources and/or additional information. For example, the light sources of a background source may influence the eventual rendering of character sources and/or connective visual sources. In the earlier example, the participant may have the appearance, to the viewer for whom this is rendered, of the participant's face, in a body with clothing selected by the participant, and in the context of the background associated with the background source. Features, including but not limited to perspective, angle, lighting, color, and physical attributes, may adjust based on changes in the location of the viewer. When incorporating multiple sources, representations of participants in accordance with many embodiments of the invention may be interpolated from the feeds of two or more cameras. The representation of a participant may be extrapolated from the feed of one or more cameras. In numerous embodiments, the representation of the participant may be derived from previously captured multimedia streams and/or from computer-generated multimedia experiences. Interpolation and/or extrapolation may be determined based on pre-generated models of the participant. In various embodiments, models of participants may be related to user profiles that are generated at setup and further improved on during the course of using the technology.

Visual streams generated by the combination of sources, interpolation, and/or extrapolation may result from a variety of methods. In several embodiments, machine learning (ML) technology and/or Artificial Intelligence (AI) technology, including, but not limited to a generative adversarial networks (GANs), may be used to smoothly generate output visual streams. Visual streams may be informed by the relative locations of the two or more users in the VR context. GANs may be used to create a synthesized visualization using both the real-world camera input, as well as a trained generative adversarial network to help form a new simulation for the desired effect. Tokens used alongside these visual streams can be in the form of NFTs, which can be generated, recorded, and transferred as disclosed in U.S. Pat. No. 11,348,099, entitled “Systems and Methods for Implementing Blockchain-Based Content Engagement Platforms Utilizing Media Wallets,” issued May 31, 2022, the disclosure of which is incorporated by reference in its entirety.

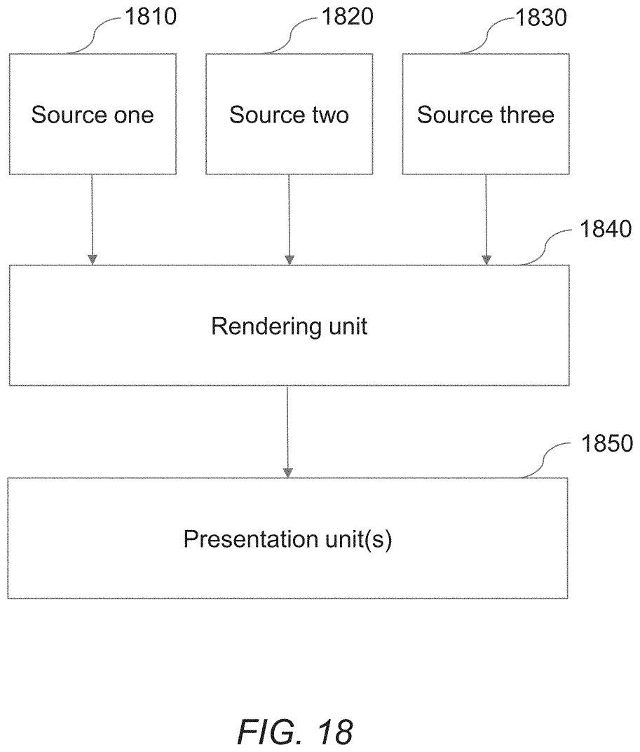

An example implementation of combining sources to render presentation units in accordance with some embodiments of the invention is illustrated in FIG. 18. In this example, sources 1810-1830 act as inputs to rendering unit 1840 to produce presentation unit 1850. Sources 1810-1830 may be various sources of various types of content in accordance with many embodiments of the invention. In this example, source one 1810 may be a sensor input, including, but not limited to an image sensor on a participant's virtual reality goggles. Source two 1820 may be particular facial (or character) elements. Source three 1830 may be connective visuals, including, but not limited to clothing and/or animated character features. The rendering unit 1840 may take many forms, including but not limited to a mobile device computing system, a personal computer, wearable technology, cloud-based computing, etc. The presentation unit(s) 1850 may take many forms, including but not limited to a mobile device multimedia output system, a personal computer and connected peripherals, a holographic display system, virtual reality goggles, augmented reality glasses, etc. For example, a prospective home buyer may be contemplating homes in different neighborhoods prior to visiting the homes in person. Alice, the home buyer, may be looking through online offerings on various real estate agent websites. As Alice identifies homes in her price and desirability range, she can enter a virtual tour of each home. Since Alice is not yet working with a specific agent, each agency may offer a virtual tour with various guided tour options based upon a self-directed tour, animated character-based tour, and/or a virtual tour with an agent's avatar.

In this example, source one 1810 may use a pre-recorded sequence of video images of the home that have been stored for use by the rendering unit 1840. Source two 1820 may use the animated character from Alice's favorite childhood comic strip. The character may be licensed from the cartoon company by the real estate agent and/or Alice herself. Source three may use connective multimedia elements including, but not limited to audio and video from a crackling fire in the fireplace. The connective multimedia elements may involve elements that were not operational at the time of that source one 1810 was captured to memory. Rendering unit 1840 combines these sources into an immersive guided tour for Alice as presented on her presentation unit(s) 1850, her desktop computer multimedia system. In another example, Alice has contracted with a single real estate agent, Bob, who is prepared to perform a virtual walk-through of three homes in his inventory with Alice. In this example, Bob's face is represented as source two 1820 instead of the animated character and Bob can directly participate in Alice's three guided tours.

Systems and methods in accordance with a variety of embodiments of the invention may apply to virtual reality improvements. In many embodiments, real-world items, people, and locations may be used to augment virtual reality environments including, but not limited to digital representations of company offices in augmented reality and virtual reality. Additionally, the techniques and ideas disclosed here may readily apply to other communication aspects including, but not limited to, audio and/or touch.

Several embodiments may incorporate combining visuals, as disclosed above, with audible elements. Audible elements may include, but are not limited to vocal music, speech, audible advertisements, background music, etc. For example, listening to a song in virtual and/or augmented reality environments may be allowed with ownership and/or proof of license. Ownership and/or proof of license to listen to particular songs may be shown with an ownership token and/or a license token, as disclosed in U.S. patent application Ser. No. 17/808,264, entitled “Systems and Methods for Token Creation and Management,” filed Jun. 22, 2022, the disclosure of which is incorporated by reference herein in its entirety. Users that have purchased NFTs from musicians and bands may have accumulated significant libraries of songs that they wish to listen to on their own devices without the need for music streaming services. They may use ownership and/or proof of license to prove the right to listen to the song and/or provide the artists with an ability to license their artistic products directly to individuals and organizations. This may allow the artists to enjoy direct relationships with users. Users, having purchased specific rights to digital, virtual, and/or physical goods may be enabled by policies to listen to the song in a variety of manners including but not limited to on mobile device applications, in home environments, with augmented and/or virtual reality systems, etc.

Users may purchase pieces of physical artwork with accompanying NFTs. In doing so, they may enable, by policy, the reproduction of the artwork. This may allow digital use in augmented and/or virtual environments, including, but not limited to a virtual work office. The use of artwork in this manner may be performed by combining image and/or audible sources as described above.

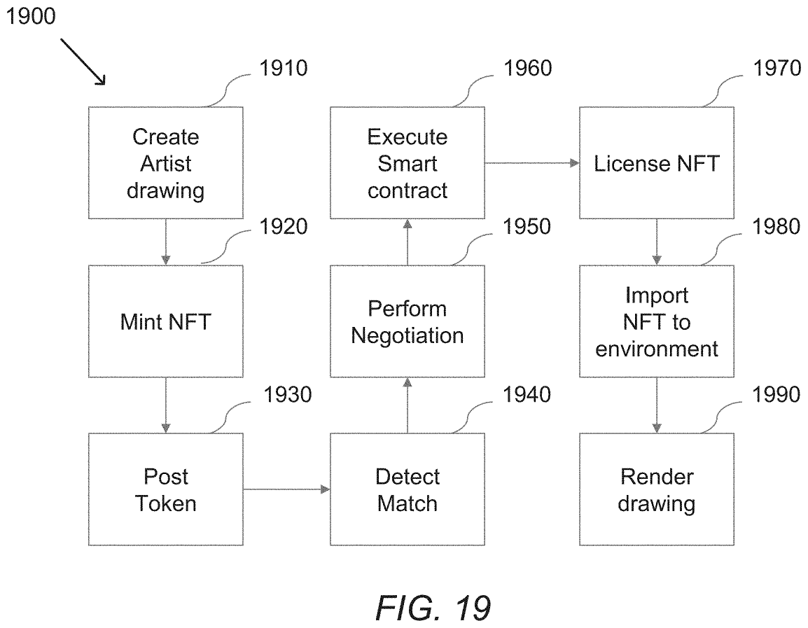

A representation of a process 1900 of minting, advertising, licensing, and rendering an artist's work in a virtual environment experience, in accordance with a number of embodiments of the invention, is illustrated in FIG. 19. Process 1900 creates (1910) a digital drawing, alternate digital artwork, and/or a digital representation of a physical artwork. Process mints (1920) an NFT (1920) corresponding to the artwork enabling the transfer of rights. Process 1900 posts (1930) a token indicating a need to license on a distributed marketplace. The token may be posted in a manner as disclosed in U.S. patent application Ser. No. 17/808,264, entitled “Systems and Methods for Token Creation and Management,” filed Jun. 22, 2022, the disclosure of which is incorporated by reference herein in its entirety. Tokens indicating a need to license may include, but are not limited to, advertisement tokens (also referred to as advertisement NFTs and advertising tokens) as disclosed in U.S. patent application Ser. No. 17/808,264, entitled “Systems and Methods for Token Creation and Management,” filed Jun. 22, 2022, the disclosure of which is incorporated by reference herein in its entirety. Process 1900 detects (1940) a match in the form of one or more interested licensees. The match may be facilitated by bounty hunters and/or other decentralized applications, as disclosed in U.S. patent application Ser. No. 17/808,264, entitled “Systems and Methods for Token Creation and Management,” filed Jun. 22, 2022, the disclosure of which is incorporated by reference herein in its entirety. Process 1900 performs (1950) a negotiation for licensing between the artist of the digital artwork and the prospective licensees. At the conclusion of the successful negotiation, process 1900 executes (1960) a smart contract. In accordance with some embodiments, an agreement and/or a physical contract may be implemented. In executing the agreement, process 1900 licenses (1970) the NFT. When the licensee is a participant in a virtual environment experience, process 1900 imports (1980) the NFT to the environment experience of the licensee. When the NFT is imported, the process 1900 renders (1990) the drawing, digital artwork, and/or physical representation in the virtual environment. The participant may be able to use the licensed artwork in a variety of settings based on the terms of the license. This may include, but is not limited to, as a background in a business meeting and/or as artwork on the wall of their virtual condominium.

Some embodiments may incorporate collections of computational entities, including but not limited to sensor units, combination units, and/or rendering units. Examples of sensor units may include but are not limited to cameras and/or microphones. In some contexts, pressure-sensitive sensors may be used to detect changes in pressure, for example. Example combination units may include, but are not limited to cloud computers and/or other powerful computers co-located with one or more of the participants. Combination units may perform at least some of the processing described above, including but not limited to combining the three types of sources of visual information with associated audio and other sensor data. To a large extent, greater computational capabilities can improve the ability to combine sources. Therefore, when users do not have access to powerful computers, at least some of the processing may be performed on one or more cloud computers. An example rendering unit may be a VR headset, but rendering may be performed on a traditional computer screen and/or a wide-screen TV.

In some embodiments, special-purpose wearable computers with actuators can be used as part of rendering devices for one or more participants in virtual meetings. The actuators can help convey pressure and be used to identify the application of pressure by participants. The use of actuation combined with sensing of pressure can be used to identify and create feedback to participants. For example, users reaching their arms out to tap another person on the shoulder may cause the conveyance of pressure on the fingers of the users doing the tapping at the time the tappers' fingers are rendered. The pressure on the shoulder of the person whose shoulder is tapped, may be conveyed on the shoulder of that person. Computational entities in accordance with many embodiments of the invention may be connected using a network, including, but not limited to the Internet, and/or a proprietary end-to-end connection between the two or more participants. In many embodiments, rendering units may be connected to this network by ways including, but not limited to, a wireless connection, such as a WiFi and/or Bluetooth Low Energy (BLE) connection, and other types of wireless network connections. The sensor units may be connected to this network. In some embodiments, the sensor units can be co-located with the rendering units. For example, the sensors may be housed in the same physical components, including, but not limited to a wearable computing unit with a screen. In some embodiments, some sensor units may be free-standing. For example, sensor units may be placed in the environment of the users participating in the virtual reality meeting. Sensors can be used to determine when users gesticulate, allowing the corresponding body representation of the user performing the same and/or related movements. This may occur when users utilize wearable computing devices in accordance with several embodiments of the invention.

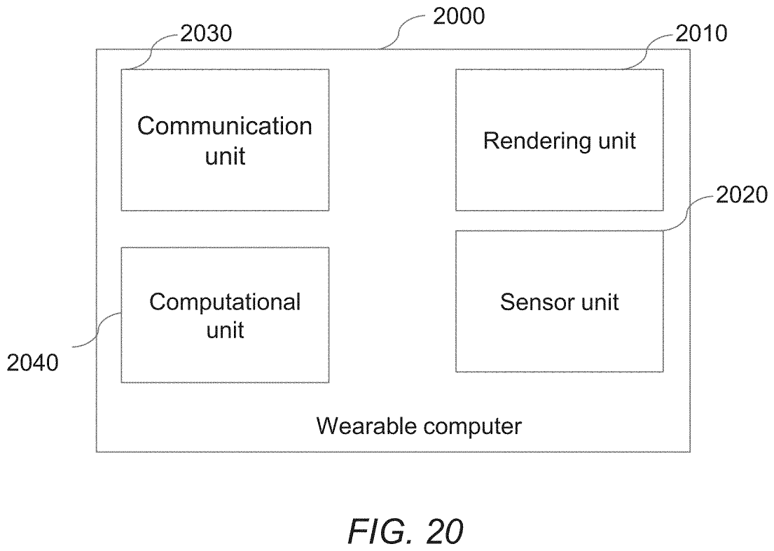

A configuration of a wearable computing device, in accordance with several embodiments of the invention is disclosed in FIG. 20. A wearable computer 2000 may include a rendering unit 2010, as referenced above. The rendering unit 2010 may include, but is not limited to a screen and a headset speaker. The wearable computer 2000 may incorporate a sensor unit 2020. The sensor unit 2020 may include, but is not limited to a directional sensor, a microphone, and one or more cameras. Additionally, the wearable computer may include a communication unit 2030 and a computational unit 2040. The communication unit 2030 may utilize a Bluetooth and/or WiFi radio. The computational unit 2040 may include one or more processors. The processor may be a single Central Processing Unit, CPU, but could include two or more processing units. For example, the processor may include general-purpose microprocessors; instruction set processors and/or related chips sets and/or special-purpose microprocessors including, but not limited to Application Specific Integrated Circuits, ASICs. The processor may include board memory for caching purposes. The computational unit 2040 may execute a Trusted Execution Environment (TEE), a DRM, and/or tokens including executable content. The computational unit 2040 may combine content elements received using the communication unit 2030. Content elements may include associated tokens. The computational unit 2040 may use inputs from sensor unit 2020 to modify received content. The computational unit 2040 may transmit modified content to be rendered on the rendering unit 2010.

Processes in accordance with some embodiments of the invention may have the ability to classify and/or personalize gestures and movement. Classification and/or personalization may occur in collaboration with the body sensor network described above and/or through camera technology. The body sensor network and/or camera technology may create a skeleton version of the human user in virtual reality space. Using ML and/or AI, systems can extract pertinent gestural data and mannerisms from users over time, that may be unique to them. In many embodiments, systems may apply the gestural data and mannerisms for recognition purposes. For example, if user A is a teacher and gathers a virtual class together by rolling her hands in a certain pattern, the system can learn to recognize this series of gestures and learn that this is unique to user A. In several embodiments, systems may be constructed to identify human gestures and verbalizations from the start and/or end of each session. The systems may be constructed to build a long-term behavioral model for each participant. In the latter case, the systems may obtain participant consent first. Systems in accordance with some embodiments of the invention may use recognizing and regenerating the unique personal characteristics of the participants to improve interpersonal relationships between participants. User B may roll their eyes whenever a particular subject arises. User C might nod their head whenever their boss is speaking. User D may have a hand gesture they use whenever they are done speaking and use the gesture to allow the team to continue the discussion. Again, systems in accordance with a variety of embodiments can be used to learn these unique gestures, which can aid with multi-point user authentication, gamification, and developing new methodologies of socialization. Gestures and mannerisms may be applied to computer-enhanced, and/or computer-generated implementations of participants in virtual environments. Alternatively or additionally, certain gestures and/or mannerisms may be adopted by corresponding fictional characters, physical representations, and/or avatars. Unique and unusual gestures and mannerisms can be tokenized. These unusual gestures and mannerisms may be purchased for individuals, corresponding fictional characters, physical representations, and/or avatars. For example, User A may create a new electric slide dance move, as part of a dance class being taught virtually online. These series of moves can be captured into an NFT and other users may be able to purchase it for themselves and/or their avatar. In certain embodiments, users may be able to create new modified versions of the moves that can be repackaged for other users to purchase.

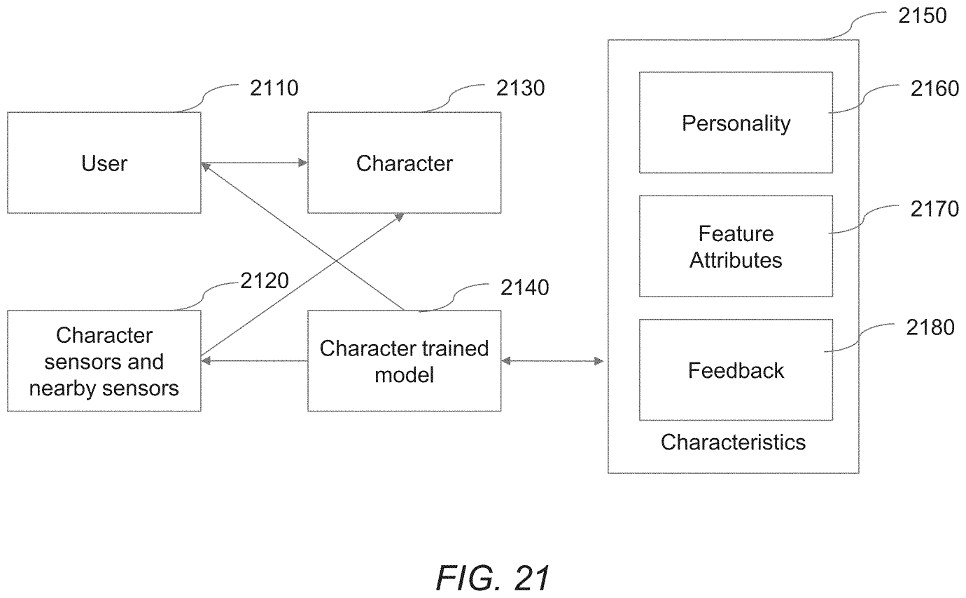

An interaction system that may be implemented by users to update the characteristics of fictional characters, in accordance with several embodiments of the invention, is illustrated in FIG. 21. Users 2110 may interact with characters 2130 that can be incorporated into immersive environments. In systems and methods in accordance with a number of embodiments of the invention, characters may refer to fictional characters (e.g., the cast of a cartoon, custom-made characters), representations of living beings (e.g., popular celebrities, participants to the immersive environment), etc. Interaction with characters may include, but is not limited to, digitally perceiving and/or reacting to characters rendered in immersive environments. As users 2110 interact with the characters, character sensors 2120 and/or nearby sensors can capture information related to the character trained models 2140. Character sensors 2120 may include sensors on phones, microphones, accelerometers, etc. Character sensors 2120 may be associated with the application in which representations of the characters 2130 are executed, evaluated, configured, parameterized and/or rendered. Information obtained by character sensors 2120 may include, but is not limited to, information that can be applied to a character trained model 2140. This may include, but is not limited to, information from the real world that can be translated to facilitate character 2130 responses. Character trained models 2140 may be based on living beings and/or fictional characters. Character trained models 2140 can consist of various programmable functions and/or artificial intelligence to continue to evolve. Functions related to character trained models 2140 may be personalized through user interaction with the characters 2130. AI and/or functions may be used to store information about characters 2130 in a characteristics space 2150. Such information may include, but is not limited to, vocal cadence, personality 2160 details and history, feature attributes 2170, and feedback 2180 details and history associated with the characters 2130. Information of the characters 2130 kept in the characteristics space 2150 may later be used to refine character representations.

For example, Edward may hire Felicity to design a virtual pet named Curly. Felicity, the user 2110, may use character sensors attached to and surrounding Curly to train a character trained model 2140. The eventual representation of Curly, the character 2130, may seem very lifelike in Edward's virtual environments. Some of the characteristics 2150 that Felicity might capture and model include personality 2160, feature attributes 2170 and feedback 2180. Felicity's AI instantiation can translate the data from the sensors and uses digital signal processing to signal condition the data in real-time. Felicity's AI can extract appropriate features which act as inputs into the machine learning algorithm. The same AI instantiation, and/or an alternative instantiation, may serve to monitor Edward's behavior and personality in the virtual environments so that the representation of Curly's character may evolve as Edward's behavior changes with time.

Several embodiments of the invention can allow for combining sources for one or more users. Combining sources may be used to create audio-visual renderings for the users. In various embodiments, inactive and/or temporarily absent users can be rendered as having minor variations of recent facial expressions and/or common facial expressions of theirs. This may reduce the computational requirements for rendering such users. In a number of embodiments, another method of reducing the computational requirements may be to identify what viewers, i.e., the parties for whom the rendering is performed, are focusing on. Thus, higher-quality renderings can be performed for a participant that the viewers are focusing on. Similarly, participants that are actively speaking and/or gesticulating may be rendered with a higher-quality threshold of rendering. Higher quality rendering may include, but is not limited to more accurate shadows; more accurate micro-movements, and/or more detailed facial expressions being rendered. Thus, the computational entities may include and/or be connected to sensors that can determine the attention and/or focus of a viewer for whom rendering is performed. When this occurs, the determined attention and/or focus may be used to prioritize the processing for the combination of sources. In some embodiments, the identification of focus and/or attention may be used to determine from what speakers the computational entity performing the combination of sources ought to receive signals. In some embodiments, the granularity and/or bandwidth of such signals may be determined. Thus, in situations with limited bandwidth, the computational units used for processing and combining sources can indicate to other nodes on the network what bandwidth and/or granularity is required. These nodes may include the computational units of other participants. In accordance with certain embodiments of the invention, less bandwidth-consuming signals may be sent from parties that are inactive and/or not the focus of attention.

In a number of situations, audio data may be transmitted to other participants, along with data representing the visual aspects of the user without a camera. In particular, this may occur for users that have a microphone but no camera. The visual aspects transmitted may include, but are not limited to, images and/or facial models associated with the user, and/or indications of what avatar to use for a visual representation of the visually absent user. Avatars in accordance with various embodiments of the invention may include a facial model representation disclosing how it moves for various sounds, gestures, and/or mannerisms. When microphone data is conveyed from the camera-less user to other participants, the microphone data may be used in conjunction with the visual models to generate a visual representation of the camera-less user that corresponds to the utterances detected from the microphone source. In certain embodiments, this processing can be performed on a computational unit representing the camera-less user.

Systems may, in various embodiments, restrict the focus to one pre-selected speaker, including, but not limited to an instance where a speech is given. The systems may respond to requests that restrict focus by making other participants out of focus. If the pre-selective speaker enters a Q&A session and/or allows other participants to speak, the focus can be assigned according to a particular rule. For instance, the rule may have an identified participant placed in everybody's focus, while other participants can be suppressed in terms of their impact on the rendering. In some embodiments, an identified participant can be an audience member who has requested to speak by providing input. The speaker can provide input to have the focus revert to them and/or choose and enable other participants to become in focus.

Some embodiments of the invention may involve systems used for instructional purposes. Instructional purposes may refer to instances in which one or more participants join an immersive session in which one speaker provides instruction. An example of instruction may be teaching the other participants how to make risotto. Instructors in accordance with several embodiments may correspond to human users that join VR sessions just like the other participants, similar to the speaker example above. Alternatively or additionally, speakers can be computer-generated, based on scripts provided as input. In the latter case, the script may include a series of segments that are stitched together using interpolation methods. When segments are stitched together, AI components may identify, parse and process questions from participants, selecting what segments to use to address questions. When questions asked do not have corresponding answers provided in a script, then there may be one or more pre-configured catch-all responses that are given. Additionally or alternatively, human admins with the capability to provide material selection can be alerted. In some embodiments, AI components can be used to identify sentiment, including, but not limited to sarcasm and/or satirical humor. AI components may be able to identify emotion in the question, disgust for example, to help facilitate feedback from users in an intelligent and corresponding tone and expression.

In some embodiments human admins may determine what the best responses are, and provide pre-recorded scripts to address questions and/or provide responses that are mapped to the computer-generated speakers. This may be used to create a continuity such that participants can maintain a feeling that the same speaker (instructor) that is answering the questions provided previous guidance. In many embodiments, guidance directed to continuity may be useful for a variety of educational settings as well, including, but not limited to classes in which individual students are given instruction by instructors that are computer-generated and/or admin-controlled. In some embodiments, outsourcing of much of the instruction to computer-generated entities may allow one human admin to simultaneously act as the one-on-one instructor for large numbers of students. In the case of a language class, the admin can answer questions that the script fails to address, without needing to have the same voice. Instead, the voice of the human admin can be replaced by the voice used for the computer-generated instructor, simply using the spoken content for the guidance of the avatar that represents the instructor. For example, a math class can have 200 students, each one of which feels they are getting individual attention all the time from the instructor since the system succeeds in answering almost all questions using a script. In contrast, more complicated and/or subjective may optimize at lower class sizes. For instance, an upper-division philosophy class may have only 10 students feeling they get individual attention, given that many more questions may be difficult for a script to answer using the guidance of the AI component. Thus, the size of the class and/or the extent to which students perceive getting individual attention may depend on the extent to which the AI element that is part of a computational entity can determine the nature of the questions, the overlap of the questions, and the likely correct answers. Therefore, the need for human instruction may not be limited, as many embodiments of the invention can permit the scaling of efforts to enable a greater extent of perceived one-on-one guidance.

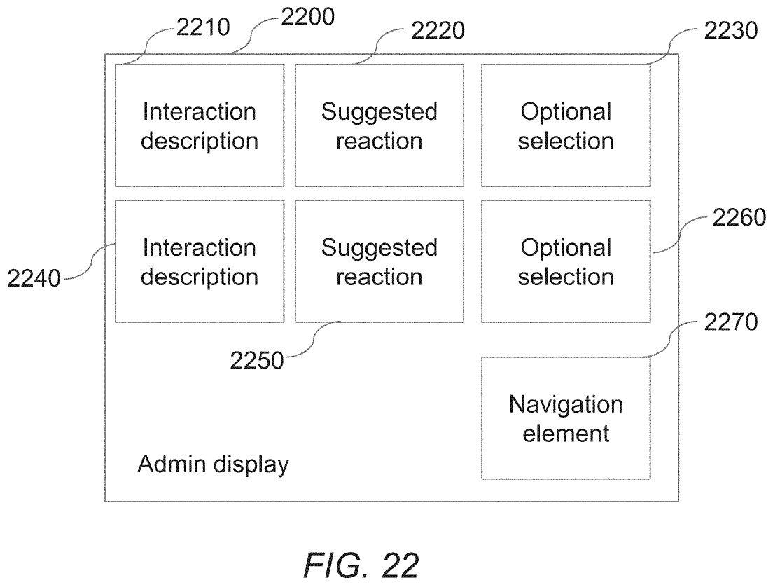

A user interface that may be used by admin users in accordance with several embodiments of the invention is disclosed in FIG. 22. In some scenarios, AI components may leave some participant questions unanswered. In accordance with many embodiments, admin displays 2200 may be used to address the unanswered questions. An admin display 2200 may show one or more interaction descriptions, one or more suggested reactions (from the characters to the interaction descriptions) and/or one or more optional selections (that can be chosen in place of suggested reactions). The representation depicted in FIG. 22 shows a first interaction description 2210, a first suggested reaction 2220, and a first optional selection 2230, as well as a second interaction description 2240, a second suggested reaction 2250, and a second optional selection 2260.

Admin displays 2200 may incorporate navigational elements 2270. Admins can use navigation elements 2270 to view other interaction descriptions. Multiple admin users may use different instances of admin displays 2200 to view interaction descriptions, suggested reactions, and/or optional selections. As one admin user commits to addressing an interaction description by, for example, clicking on the representation of the interaction description, then the interaction description may no longer being made available to other admins. The one admin user can then resolve the corresponding request by approving a suggested reaction and/or providing a selection.

In various embodiments, interaction descriptions, suggested reactions, and optional selections may be applied to guide character interactions. The first interaction description 2210 may be a representation of what one end-user has provided as input. In a number of embodiments, user input may include, but is not limited to, user requests, questions, and/or particular situations. The representation may be in the form of, but is not limited to, a written request, a video and/or audio segment illustrating a situation, and/or a transcription of a spoken sentence. The first suggested reaction 2220 may be a representation of a possible response to the first interaction description 2210. Suggested reactions may be AI-generated and/or decided upon by participants. For example, the first interaction description 2210 may correspond to a question (e.g., “Next now?”), in reference to a language course in an immersive environment. Upon receiving this question, the first suggested reaction 2220 may be a representation of a response stating “You cannot proceed yet. Please practice more. Try to roll your tongue when you say it. Like this: ‘RRRRR.”’ An admin can click on the first suggested reaction 2220 to cause this to be generated as a response to the first interaction description 2210. Additionally or alternatively, admins can select the first optional selection 2230 to provide an optional response. In a number of embodiments, optional responses may involve, but is not limited to, recording a response, typing a response, editing a response, showing a motion, and/or selecting another potential response different from the first suggested reaction 2220. In the latter case, admins can use the first optional selection 2230 to cause the first interaction description 2210 to be ignored and no longer be displayed on the admin display 2200. The second interaction description 2240 may be another representation of users' requests, questions and/or situations. The second suggested reaction 2250 may be another response to the second interaction description 2240. The second optional selection 2260 may allow for another alternative response.

As AIs improve, fewer interaction descriptions may need support from admins for an appropriate response to be generated. Two or more admins may address questions, each one of them being represented by the same instructor. Admins may be represented by different instructors. Each admin may have the ability to prioritize a particular reaction to another admin. For example, a more qualified admin. Systems may learn what interaction descriptions typically are resolved by what admin user, and prioritize the admin displays 2200 accordingly.

When human instructors respond to questions, their responses and guidance may be used to improve system efficiency. For instance, when AI components cannot determine answers with a sufficient level of certainty, the parsed question and/or the parsed response from the human instructors can be recorded and used to train the AI components. The AI components can therefore improve as additional guidance is provided by human admins. This may allow the systems to be bootstrapped. When AI elements have not been trained, instruction may be performed by human admins. As such, the human admins' didactical capabilities may be fundamental for the rapid conversion and correctness of the AI elements. After some time of silent observation and training, the AI components can learn to answer more of the questions. Additionally, in some situations, the AI components may propose answers requiring the human admin approval and/or edits. In addition to answering questions, the AI components can be used to modulate scripts, corresponding to lecture plans. For example, feedback from participants may induce scripts to speed up and/or slow down based on the feedback. In certain embodiments, different participants may perceive different instructional elements, selected to optimally benefit them, based on their progress and/or lack thereof.

Systems and methods in accordance with various embodiments may implement virtual assistants. Virtual assistants, like virtual instructors, may select what material to present based on past observations and recent observations related to the user. For example, when a calendar indicates that a user may pick up a friend at the airport at 11 am, and the travel time is normally 1 h to the airport, then the virtual assistant may remind the user to leave at 10:55 am when the system perceives, based on recently observed events and actions, that they are dressed and ready, and the traffic is normal. However, if there are indications that the user is taking a shower at 10:30, then the virtual assistant may determine that an early reminder to leave in 30 minutes would be helpful to the user. Conversely, if the user leaves home in their car at 10:50, and is headed in a direction consistent with going to the airport, then the virtual assistant may not remind the user to pick up their friend at the airport. In accordance with a number of embodiments, systems may detect events indicating that users have changed destinations. In the earlier example, the virtual assistant may determine that the user no longer is on the way to the airport based on events, including, but not limited to the user stopping at a store and/or making a turn onto the highway in a direction that is not consistent with going to the airport. In many embodiments, the timing for reminders may be determined based on previous observations. For example, some users may need more time to get ready than others, and therefore, may benefit from an earlier reminder. How much time users need can be determined from the time it takes to get ready and leave from the time of the reminder, and/or simply based upon the users' general levels of tardiness, for a number of observations. Systems in accordance with various embodiments of the invention may determine how long it takes for the user to get ready to leave based on observations of user actions and movements, and changes in behavior. For example, users who remain sitting for ten minutes after being reminded, and then take an additional ten minutes to get ready to leave may only need ten minutes to leave when in a different situation. In a number of embodiments, determinations of when to generate reminders can be made based on known reactions to events. For example, if a user is watching an episode of a TV show, where five minutes remain, and often seems to complete watching episodes before changing tasks, then the right time for a non-urgent reminder may be at the very end of the episode. However, for more urgent reminders, an interruption may be made regardless. In many embodiments, the likely urgency of situations can be inferred from factors including, but not limited to, the type of event scheduled, previous observations related to punctuality, and indications made by the user whether the time of the event is precise and/or approximate. Some events may be known to be precise, including, but not limited to the beginning of a game on TV. Other events may be less precise such as going shopping. Some events may depend on other individuals. For example, a meeting with a friend. In such cases, systems can infer degrees of urgency based on progress updates from systems associated with the other parties to the meeting. If a user has a 30-minute drive to the meeting location and has not yet left home, then the meeting cannot take place for at least 30 minutes. Therefore, if users, for whom a reminder is to be generated, are 10 minutes from the meeting place, there may only be a low urgency. If a user is an hour away from the meeting, and the other party has already left home, then there may be a very high urgency.

In various embodiments, virtual assistants may offer recommendations based upon the context of real-time situations involving participants. A user involved in a discussion about a leaky toilet, may be presented with advertisements and/or recommendations for local plumbers. In another example, the virtual assistant, recognizing that the participant's wardrobe is rather limited from day to day, may recommend fashionable clothing based upon the clothing the participant normally wears. In another example, the participant may be in a discussion related to the desirability and/or scarcity of an item and/or service including, but not limited to a new artist offering at a local show. Content recommendations can be created using the techniques disclosed in U.S. patent application Ser. No. 17/806,728, entitled “Systems and Methods for Encrypting and Controlling Access to Encrypted Data Based Upon Immutable Ledgers,” filed Jun. 13, 2022, the disclosure of which is incorporated by reference herein in its entirety.

Systems and methods in accordance with some embodiments of the invention may be implemented in gaming environments. In various embodiments, systems may be used for online gaming and/or virtual entertainment. The implementations may be similar to the aforementioned virtual office environments, online conference call environments, and school and/or training environments. A common gaming environment may be a massively multiplayer online gaming experience where tens and hundreds of thousands of players enter a completely virtual online world, including, but not limited to Minecraft™. In the online game setting, individuals may make use of environments constructed by the gaming provider and as modified by other gamers and the individual. For instance, theoretical gaming environments might allow individuals to purchase virtual condominiums and enable the individuals to virtually occupy the condominiums just as they would in the real world, but with virtual possessions. Individuals may choose to hang artwork for themselves and visitors to enjoy by purchasing NFTs inside the gaming environment. The individuals may purchase the NFTs outside the environment with the ability to import the artwork into the virtual world. At the same time, the individual may want to play a list of favorite music songs within the condominium. Songs from the list may be represented by one or more NFTs. Access to the online condominium might be controlled with individuals' identities and/or biometric confirmations. Confirmation may be governed by one or more tokens including, but not limited to access tokens disclosed in U.S. patent application Ser. No. 17/808,264, entitled “Systems and Methods for Token Creation and Management,” filed Jun. 22, 2022, the disclosure of which is incorporated by reference herein in its entirety.

Tokens purchased in gaming environments and/or externally, may have restrictions for use. Example restrictions may include, but are not limited to that obtained songs might only be heard by a purchaser of the corresponding NFT, artwork may only be seen by two persons at a time, and/or artwork may only be seen in one virtual system at a time. In some embodiments, artwork NFTs may be installed in more than one environment. For instance, an NFT of a Florida sunset might be artwork on the wall in a virtual condominium while simultaneously serving as a background image for the same individual's work conference call background. In various embodiments, individuals might choose to utilize alias tokens for pseudonymous identity in one or more gaming environments as disclosed in U.S. patent application Ser. No. 17/808,264, entitled “Systems and Methods for Token Creation and Management,” filed Jun. 22, 2022, the disclosure of which is incorporated by reference herein in its entirety.

Several embodiments of the invention can be used to incorporate features of users into games. For instance, human users might be able to incorporate their facial features and/or expressions. Incorporation may be done by applying these and/or related expressions to in-game characters, including, but not limited to human-controlled avatars in Minecraft™. Incorporation may further be used to blend elements from reality with elements from the game, harmonizing these in a manner disclosed herein.

In various embodiments, systems may be used for virtual shopping experiences. For example, traditional local shopping malls can reproduce virtual mall experiences. In doing so, virtual mall experiences may offer the traditional in-real-world physical items and/or services for purchase as would be in a traditional shopping mall and offer virtual and digital items and/or services. For instance, shoppers may select new bed frames for purchase in virtual worlds and delivery in the real world. A shopper might choose to purchase an NFT representing a lamp to decorate their virtual condominium, using the example environment above. Users who provide their measurements may try on clothing on avatars, and view the avatar from various angles and settings. Multiple participants may join in one and the same experience. Additionally, parties may be disinclined to join such an experience, but pressured to participate. In such a case, they may sneakily enroll avatars in their place, where the avatars are configured to act in plausible manners and/or similar to the parties. When questions are posed to avatars that an AI cannot answer on their behalf evasive answers may be given. Alternatively or additionally, notifications may be generated and parties may be shown video clips describing the context, and/or parties may be asked to provide responses, if applicable.) Thus, there are many desirable applications of the technologies disclosed alongside illustrative examples of such uses to explain applications of many embodiments of the invention.

In various embodiments, real-world events may be configured into “virtually there” experiences. Individuals may use certain embodiments to purchase a virtual seat at an Atlanta Braves baseball game and experience the view of the real-world event, whether live and/or recorded, from the perspective of that seat remotely. In some embodiments, use of “virtually there” experiences can allow many users to be provided with the very best seat of the house. Multiple users can occupy the same virtual spaces without having to feel crowded. Thus, a number of embodiments may selectively represent other users based on a policy. Coming back to the above example, the same individual may want to once again experience the 2005 Chicago White Sox World Series in a virtual environment version of the same seat that the individual experienced in real life in 2005. The virtual broadcast of the game might feature the individual's favorite NFT songs over the virtual loudspeakers in place of the music that was actually played during the event. These NFT songs may be played in real-time and/or from the past.

In various embodiments, individuals may solicit artists to create virtual versions of their real-life pets. The virtual pets may be created in the form of NFTs that can be used within virtual environments. For instance, a virtual pet may be used in the virtual condominium described above. Individuals may have the ability to experience their pet virtually, far beyond the lifetime of their real pets. Individuals may make use of the same pet artwork token in other immersive environments, e.g., a business conference call. In several embodiments, machine learning and/or artificial intelligence (AI) may be incorporated into the design of the virtual pets such that the virtual pets adapt to the unique circumstances of their respective owners' environments and behaviors. A single virtual pet design, when licensed to multiple licensees, can benefit from gaining unique behaviors, traits, and/or mannerisms according to the experiences of each licensee's environments and behaviors. In various embodiments, systems, through AIs, may translate data from sensors and use digital signal processing to signal condition the data in real-time. The AIs may extract appropriate features which can act as inputs into a machine learning algorithm. Systems in accordance with several embodiments of the invention may detect certain features to train personality classifiers which may be based on the interaction from the users including, but not limited to voice, external sensors, shared preferences, and more. Each virtual pet may be unique by incorporating personality classifiers that evolve with inputs from the owner within the immersive environments. Virtual pets may be owned and/or licensed by participants and maintained in a library of content, including, but not limited to NFTs, within a media wallet, as disclosed in U.S. Pat. No. 11,348,099, entitled “Systems and Methods for Implementing Blockchain-Based Content Engagement Platforms Utilizing Media Wallets,” issued May 31, 2022, the disclosure of which is incorporated by reference in its entirety.

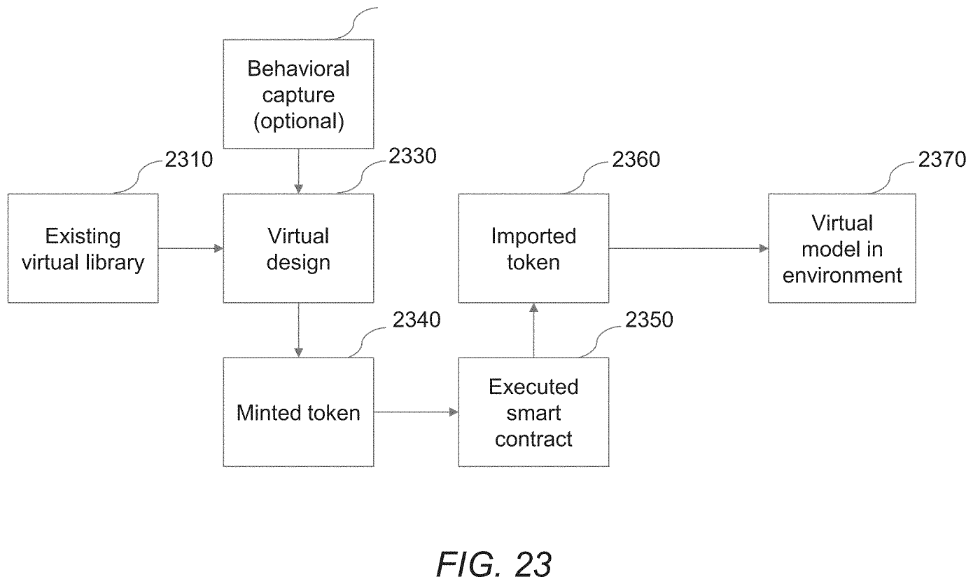

A depiction of various systems of creation, minting, and licensing a virtual model for immersive environments, in accordance with some embodiments of the invention, is conceptually illustrated in FIG. 23. A digital artist may intend to create a virtual model complete with motion, sound, behaviors and/or mannerisms. The virtual model may, for example, be of an owner's real dog. In a number of embodiments, systems may include an existing virtual library 2310 involving various virtual features that can be applied to models. Given a specific entity (e.g., a pet), virtual features may be adapted based upon behavioral capture 2320 of the real entity. In the event a purely virtual entity is being assembled, the behavior capture may be unnecessary. The virtual design 2330 may be based upon the existing virtual library 2310 and/or the optional behavioral capture 2320. Upon completion of the model, a minted token 2340 may be constructed based on the model. To facilitate licensing, a smart contract 2350 may be executed between the artist and the prospective owner (e.g., digital pet owner) and/or another prospective licensee. The smart contract and negotiations may be performed before and/or after the virtual design 2330 has been completed. Once the artist and prospective owner and/or licensee execute the smart contract 2350, the token may be imported to the desired immersive environments. The owner and/or licensee of the imported token 2360, can enjoy a virtual model in the environment 2370 of their choice. The use of the token may thereafter depend upon the use conditions of the smart contract.

For example, Edward may like the famous artist Felicity to create a virtual representation of his labradoodle Curly for use in his virtual condominium and as a companion in his gaming environments. The digital version of Curly may live an infinite life in the digital realms—a substantial benefit given Curly's short lifetime. Felicity may quote a price of 1 bitcoin for the model and Edward may agree to pay upon receipt of the virtual pet. Felicity may have a labradoodle in an existing virtual pet library. Felicity may ask Edward to spend a day with Edward and Curly observing Curly with the aid of cameras, microphones, and a specially designed accelerometer dog suit. A period of observation may allow Felicity to capture Curly's precision motions for her behavioral capture system. After spending a day with Edward and Curly, Felicity may return to her studio and design the virtual pet design. When finished, she can mint a token that enables Edward to license the model in perpetuity. The license may have the singular use restrictions that the virtual pet may not be used for commercial purposes. Adding Curly to a digital advertising commercial, for example, may require Edward and Felicity to negotiate a new smart contract. Edward, having licensed the virtual Curly, can perform a pet token import into his gaming system and virtual condominium where Curly can wait patiently for Edward to come home to his virtual pet in the immersive environment.

In certain embodiments, systems may be used to augment reality. The Atlanta Braves baseball fan mentioned above may elect to attend a game in-person and augment the game environment with augmented reality hardware, including, but not limited to goggles that enable the fan to purchase autographed photographs of moments during the game, and/or previous games. The images might be printed and mailed to particular residences and/or tokenized in an NFT format for use in whatever environment and/or digital experience the individual might desire. For example, the Atlanta Braves baseball event attendee might be a sports reporter that augments their game report with images and videos, in the form of NFTs, of the game. In many embodiments, NFTs may be presented in an augmented reality display, including, but not limited to augmented reality glasses.

In various embodiments, spectators may be offered the ability to relive experiences by attending physical events and enjoying similar and/or related experiences in augmented reality environments. During such replay situations, users may be able to focus on different aspects of an experience. In the baseball game example, this may include being able to see moves that they missed during the actual, physical game. In various embodiments, a spectator in the first seat of a real-life game may pay an upgrade fee after the game to be able to view the game from a better seat in an augmented reality version of the same game. This may be enabled by the deployment of multiple cameras in various locations of the game environment. The feeds from multiple cameras may be interpolated, where applicable. For instance, users may be offered the capability of watching the goal in a soccer game from the perspective of the goalie. These and other enhancements may significantly improve the experience of spectators and offer the opportunity to monetize games to a larger extent.

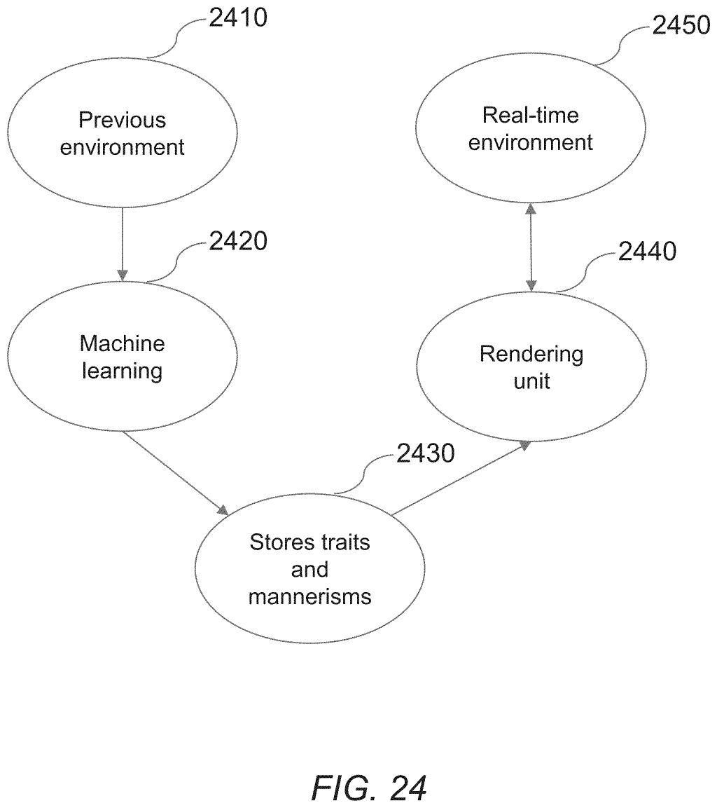

In various embodiments, many different implementations of immersive environments may be further enhanced over time. Possible updates in response to immersive environment monitoring, in accordance with a number of embodiments of the invention, are disclosed in FIG. 24. Monitoring of experiences, through machine learning in immersive environments, may allow for the improvement of subsequent experiences. A previous environment 2410 may be the first of two experiences in chronological order. The previous environment 2410 may represent the period where the immersive environment is monitored, and possible updates are determined. During the previous environment 2410, a computer system with machine learning 2420 can observe the environment and the participants for visual and audio information. The observed information may include, but is not limited to trait and mannerism 2430 data. The observed information can then be used to assist the rendering unit during subsequent experiences. The machine learning 2420 configuration can work with a rendering unit 2440 in real-time to affect the previous environment 2410 when the opportunity presents itself. Real-time environment 2450 may therefore be a second experience. In real-time, machine learning 2420 configurations may improve the second experience by updating the previous environment 2410. Machine learning 2420 configurations may initially store trait and mannerism 2430 data and/or other observed information derived from the previous environment 2410, in memory. The trait and mannerism 2430 data and other observed information may be used by systems to render the immersive environment during the second experience real-time environment 2450.

For example, Charlie may have attended a meeting two weeks ago in a previous environment 2410. During that virtual experience, Charlie may have made a combination tight-lipped smile and head nod movement several times in reaction to his manager's inputs. The machine learning 2420 system can recognize the context of those mannerisms and store the context and traits in memory for future use. The rendering unit 2440 may incorporate that data during a subsequent real-time environment 2450. During the real-time environment 2450 Charlie may later represent himself during a portion of the call with his avatar. The avatar may then be updated to nod ever so slightly with a tight-lipped smile when his boss said something contextually similar to previous environment 2410.

In many embodiments, users may purchase NFTs of artwork that is built for immersive environments. Users who purchase licenses to this artwork can then enter the immersive environments. The environments can be fully in the virtual world where participants join from various locations. Environments in accordance with many embodiments of the invention can take place in augmented reality, using projection mapping technology, and/or smart homes/offices. Such environments may have embedded walls and/or an embedded ceiling that serves as a large-format display. The environments may use holography.

In various embodiments, NFTs may be used to represent immersive environment features. As such, features including, but not limited to scripts, rules, executable components to combine sources, and/or AI entities to determine actions, can be included in and governed by one or more tokens. This may be done in a manner as disclosed in U.S. patent application Ser. No. 17/808,264, entitled “Systems and Methods for Token Creation and Management,” filed Jun. 22, 2022, the disclosure of which is incorporated by reference herein in its entirety. Tokens can be used to represent content, including, but not limited to the model associated with an animated character, a model used for interpolating and extrapolating between user-provided imagery, and commercial content like an advertisement, product placement material, and more. The content from different tokens can be combined and rendered. Some tokens, including, but not limited to those related to rules and scripts, may govern how content is generated, combined, and/or rendered, as well as conditions the former can be done. For example, some content may only be permissible to render on certified devices, in pre-selected execution environments, when a payment is performed, and/or by users having certain access rights. Other rules may specify how content is rendered on different platforms, and/or what types of sensor inputs can be used to govern the generation and/or combination of sources. Rules may correspond to and/or be represented by tokens. Some content may correspond to NFTs, which may cause additional constraints in terms of access and/or usage rights. Certain content may require payment to its designated owner when such content is integrated with other content and/or otherwise rendered on a system that does not have ownership rights to the NFT.

The intricacies of content combination can be facilitated through additional systems. In several embodiments, control of payments can be managed by Digital Rights Management (DRM) units and/or Trusted Execution Environments (TEEs). Alternatively, and/or in combination with such methods, logging can be performed, where logs are later audited for purposes of identifying abuse, anomalies, and discrepancies. Such audits may be outsourced to bounty hunters, for example. Some methods useful for these functions are disclosed in U.S. patent application Ser. No. 17/806,725, entitled “Grinding Resistant Cryptographic Systems and Cryptographic Systems Based on Certified Miners,” filed Jun. 13, 2022, the disclosure of which is incorporated by reference herein in its entirety. Additional methods useful in this context are disclosed in U.S. patent application Ser. No. 17/806,724, entitled “Systems and Methods for Blockchain-Based Collaborative Content Generation,” filed Jun. 13, 2022, the disclosure of which is incorporated by reference herein in its entirety.

In a variety of embodiments, content may be combined and rendered for display on vehicular infotainment systems. In such a setting, the selection of sources to be combined, as well as the manner of combining and rendering content may depend on whether the vehicle is operating. For reasons of safety, some content may not be suitable for rendering when cars are being driven. The operation of cars, including their respective speed, direction, and location, may be used as an input to determine how to prioritize the rendering of content. For example, directions may be prioritized over scheduling reminders at a time when the driver soon has to exit the highway. Alternatively or additionally, scheduling reminders may take priority when no driving decision has to be made for a while. In many embodiments, determinations of what can constitute safe content, and the prioritization of content and/or other aspects impacting rendering may be based on the location of rendering equipment. For example, whether rendering equipment is visible and/or audible to the driver and/or backseat passengers may impact the determination of safe content. Accordingly, some rendering elements, including, but not limited to rear speakers and backseat screens may be used for rendering of one content stream. Some other rendering elements, including, but not limited to driver-visible screens and front speakers may be used for the rendering of a second content stream that is different from the first content stream at least at some times and/or in some contexts. In some embodiments, attention tokens associated with drivers can be used as input to computational entities performing combinations of and/or configurations of content to be rendered.

In various embodiments, content may be rendered corresponding to the contents of script tokens. Script token configurations may follow what was disclosed in U.S. patent application Ser. No. 17/808,264, entitled “Systems and Methods for Token Creation and Management,” filed Jun. 22, 2022, the disclosure of which is incorporated by reference herein in its entirety. Script tokens may include and/or reference one or more content elements. Content elements may include, but are not limited to a storyline, an avatar model, a voice model, an executable element performing some aspect of rendering, and more.

Content elements representing the personal preferences of users for which content is rendered can be used. Content elements may correspond to personalizations generated by training an ML system on past events associated with the user. Such content elements may include, but are not limited to configuration tokens. One of more tokens of these types may represent the first, second, and connective visual sources of data, as described above. Some of these sources may correspond to real-time input streams, for example from a camera mounted in the environment of the user for whom content is rendered. Other sources may correspond to pre-generated content elements.

Sources may be combined and rendered, where combination can be informed by the type of hardware and software used for the rendering. For example, rendering may be influenced by constraints and limitations of the rendering apparatus, including, but not limited to resolution, computational capabilities, the bandwidth of a connection to the rendering apparatus, etc. In some embodiments, a first combination phase may be performed on a first computing element, including, but not limited to a powerful home computer, an enterprise server and/or a cloud server. A second combination phase may be performed on a less computationally powerful rendering device, including, but not limited to a VR headset, a tablet computer, a phone, a laptop, and/or the screen associated with a vehicular infotainment system. The representation of data may be in the form of tokens. Systems, in accordance with many embodiments, may be built that performs functions without representing at least some of the content as tokens.

Additional phases of combination may be desirable in some contexts. For example, a first rendering device like a VR headset may perform some combination and rendering efforts, while an audio headset connected with the VR headset may perform some other combination and rendering effort. Both rendering devices may operate based on a signal that was generated by a first computational element like what is described above. Executable content was disclosed in co-pending application U.S. patent application Ser. No. 17/806,724, entitled “Systems and Methods for Blockchain-Based Collaborative Content Generation,” filed Jun. 13, 2022, the disclosure of which is incorporated by reference herein in its entirety.

Systems in accordance with some embodiments of the invention may provide alerts for occurrences including (but not limited to) the determination of risks and rendering of warnings. Drivers who drive at speeds that correspond to risk that exceeds thresholds corresponding to acceptable risk may be provided a warning. A driver that breaks a specific law may be informed of this. A driver that is concerned with their insurance premium and/or gas consumption may be offered feedback that aims at lowering these costs. Such advice can be provided to the driver and/or additional recipients. For example, alerts may be placed on a rendering device only accessible to the driver. Alerts may be rendered on multiple rendering devices. Alerts can be done in real-time. For example, alerts may be made as relevant event observations are made by systems. Alternatively or additionally, logs can be generated and made available to drivers after the arrival at a destination. Logs may include, but are not limited to video feeds from car cameras; microphone data from related time periods; and guidance and/or feedback, where the latter may be presented by AR markups of video feeds and/or with spoken and/or written advice. The advice and/or alerts may be in the form of signals, symbols and images, including, but not limited to images representing speed limits, attention deficits, and/or risks caused by other drivers on the road. The purpose of such feedback may be instructional, and/or be used to protect the driver at times of an accident. When configured to do so, systems in accordance with a variety of embodiments of the invention may selectively provide data feeds to third parties, including, but not limited to insurance companies, parents, and/or rental car companies. Such data feeds may include raw data. Raw data may describe speed and/or acceleration, and may include video feeds like what is described above, and/or a combination of content types.

In a variety of embodiments, content can be configured based on attention tokens in contexts even outside the purposes of safety. For example, users falling asleep in front of the TV may be roused by increased volume, and/or put to sleep by a reduction of the volume and an eventual turning off of the rendering. The determination may be based on user preferences and/or configurations. Systems may identify when one or more users no longer pay attention. For example, users may be alerted due to falling asleep and/or receiving a phone call, in order to facilitate an easy replay of content at that point in a movie. For instructional content, attention tokens in accordance with several embodiments of the invention can be used to determine what content to select, and whether to take a break. Commercial content, including, but not limited to product placement and advertisements, can be assessed based on the extent to which users pay attention. Commercial content determined to be uninteresting to particular users may be avoided onwards. Other commercial content that particular users pay attention to may be identified and used to determine what other content the users are interested in. For example, the attention token may indicate where users look through a video feed, determining the direction of the user's gaze based on the location of the pupils relative to other facial features. When users are interested in some commercial content, systems may determine they move their gaze similarly to other users who are confirmed to have been interested in the commercial content. For example, the users may follow a person showing off some product in a rendered video. Users who are not so interested may not follow this person with their gaze and/or look away. Thus, attention tokens may indicate likely areas of attention. Areas of attention can be used to determine what users prefer and provide more content of that type. When multiple users are present when content is rendered, systems may optimize an expected outcome based on some of these persons and/or may attempt to optimize based on an average among the people watching content.

Systems and methods in accordance with several embodiments, when performing optimizations, may determine what users are observing content at given times. Determinations of this type may be based on biometric assessments. Determinations of content observation can enable systems to generate user-specific interest profiles. Generating user-specific interest profiles may enable systems to estimate what users may be interested in based on past observations as well as current attention tokens. User-specific interest profiles may be tied to pseudonyms and/or long-term identifiers. In various embodiments, the pseudonym tokens and alias tokens used may be specific to users, to genders, age groups, zip codes, and/or other demographic identifiers. When associated with groups, the pseudonym tokens and alias tokens may be used to associate a profile with such groups, thereby enabling real-time content configuration without the need to build user profiles specific to select users.

Rendering can be from one or more sources, and combined in accordance with policies associated with the different content elements. These content elements may correspond to tokens. Content originators may associate identifiers with content. Identifiers in accordance with various embodiments of the invention may describe the origin of the content, and/or include one or more policies describing the devices on which rendering may be allowed. The combination of content is disclosed in U.S. patent application Ser. No. 17/806,724, entitled “Systems and Methods for Blockchain-Based Collaborative Content Generation,” filed Jun. 13, 2022, the disclosure of which is incorporated by reference herein in its entirety.

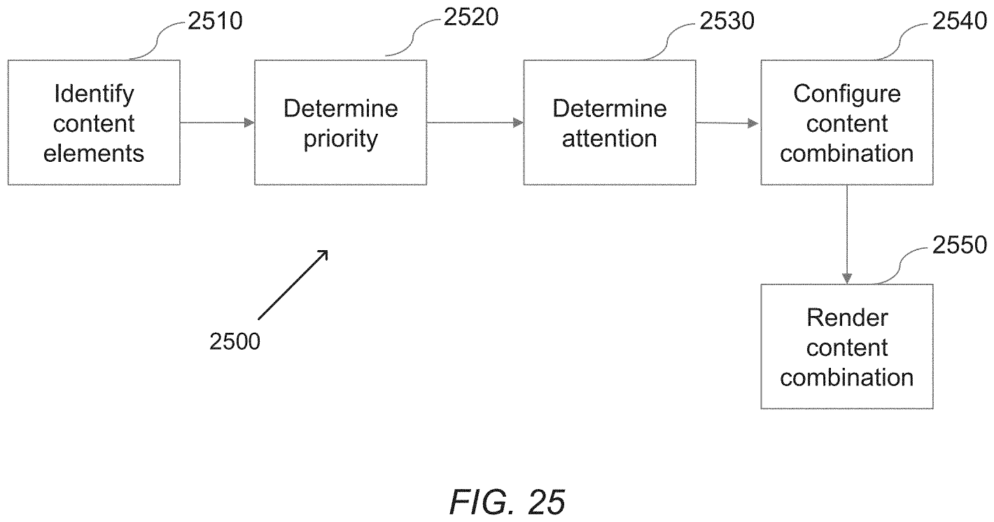

A process for the identification and rendering of content elements, in accordance with some embodiments of the invention, is disclosed in FIG. 25. The process 2500 may be applied in a scenario like, but not limited to, driving. Process 2500 identifies (2510) one or more content elements. The identification of the content may include receiving content elements from another party, retrieving content elements from local storage, obtaining content elements from one or more sensors (including, but not limited to cameras), and generating content elements (including, but not limited to alerts) based on situational information. Examples of alerts may include attention deficit alerts, traffic warnings, lane change notifications, and guidance related to directions. Process 2500 determines (2520) a priority between two or more content elements. Priority may depend on the predicted urgency and/or relevance of particular content elements to users. For example, if a turn must be in approximately five miles, that may have a lower priority than an alert that there is another driver approaching, driving in the wrong lane, driving in the wrong direction, driving at an unsafe speed, etc. Process 2500 determines (2530) the attention of engaged entities. This may involve determining whether a driver is awake, about to fall asleep, looking at a passenger for an extended period of time, appears to be emotionally perturbed, drives as if in a hurry, is looking at oncoming traffic, appears to have a medical problem, appears to have recognized a potential risk, etc. Based on the type of content identified in step 2510, the prioritization in step 2520, and the identified attention in step 2530, process 2500 configures (2540) a content combination. Content combinations may be used to control the form in which the content is displayed. This may involve, but is not limited to, determining what elements to render; what elements to temporarily suppress; the portion of a display unit to utilize and/or render; the volume to play a sound; the selection of content sources, including visual content, audio content, tactile alerts including, but not limited to steering wheel vibration notifications and/or puffs of air. Process 2500 renders (2550) the content based on the configured combination.

Content that is processed and rendered may include multiple elements, where some elements may be used in multiple contexts. This is disclosed in U.S. patent application Ser. No. 17/808,264, entitled “Systems and Methods for Token Creation and Management,” filed Jun. 22, 2022, the disclosure of which is incorporated by reference herein in its entirety. Such elements may be ranked in terms of their rising and/or falling popularity, while rankings can be used to generate recommendations. Content recommendations can be created using the techniques disclosed in U.S. patent application Ser. No. 17/806,728, entitled “Systems and Methods for Encrypting and Controlling Access to Encrypted Data Based Upon Immutable Ledgers,” filed Jun. 13, 2022, the disclosure of which is incorporated by reference herein in its entirety. Furthermore, recommendations can be generated by combining methods from these applications. Two or more recommendation sources can be harmonized into one recommendation using a variety of methods, including the use of a weighted combiner. The weights of the weighted combiner may be set differently for different users and where said weights may be set based on explicit user configurations as well as using ML techniques that set weights based on observations made of user behavior.

Similarly, the valuation predictors of U.S. patent application Ser. No. 17/806,728, entitled “Systems and Methods for Encrypting and Controlling Access to Encrypted Data Based Upon Immutable Ledgers,” filed Jun. 13, 2022, incorporated in its entirety, can be improved upon by the use of the ranking methods of U.S. patent application Ser. No. 17/808,264, entitled “Systems and Methods for Token Creation and Management,” filed Jun. 22, 2022, both applications incorporated here by reference. Improvement of the valuation predictors may be based on the principle that value is associated with popularity, and can be derived from the latter using, for example, AI methods that take the ranking and the associated trends as inputs, along with other inputs providing underlying valuation estimates. Current valuation estimates in accordance with various embodiments of the invention can be scaled based on estimates of likely future trends in popularity, which can be determined by extrapolating past rankings and other popularity estimates.

In various embodiments, derived tokens relating to content can be assessed to evaluate specific content elements. Evaluating derived tokens may enable the determination of the provenance of individual content elements and the performance of accounting computations. For accounting computations, content elements may specify usage terms when combined with other content elements. For example, a content element may indicate “for each time the element is used to render content, a payment of no less than X must be made, where X is the greater of 1/10th of a cent and 5% of the payment that is made by end-users to have the associated content rendered, assuming the user pays per rendering and does not have a subscription.” Another item may have a tiered charge that is based on the geography of where the content is being rendered, and whether any of the content producers that contribute material for the final rendering is a major studio, for example. Such rules can have multiple parts and may depend on factors including, but not limited to how content is rendered, how it is paid for, and the other elements that it is being combined with. Here, elements can include, but are not limited to script tokens.

Systems and techniques directed towards incorporating NFTs into the generation of immersive environments, in accordance with various embodiments of the invention, are not limited to use within NFT platforms. Accordingly, it should be appreciated that applications described herein can be implemented outside the context of an NFT platform network architecture and in contexts unrelated to the generation and/or storage of fungible tokens and/or NFTs. Moreover, any of the computer systems described herein with reference to FIGS. 18-25 can be utilized within any of the NFT platforms described above.

### B. Immersive Environment Advertisement Configurations

Content may be used to interact across multiple platforms and/or environments. A number of embodiments of the invention may incorporate methods for coordinating cross-platform capabilities, including, but not limited to promotion and advertising. These cross-platform capabilities may involve utilizing NFT technologies which can be created and maintained on public and/or private blockchain ledgers. Possible environments of application may include but are not limited to gaming, immersive environments, between applications on computing devices, and in real life.

Several embodiments of the invention may be used to provide commercial placement in gaming. Games, such as Pokómon™, may have players interact with game objects in augmented reality environments, e.g., using their phones. Games may therefore know users' locations and engage in location traces over given time intervals.

The backend of games may be used to determine the users' demographic profiles. For example, movement patterns may indicate that certain users sometimes play the game in and/or around a school, and/or sometimes play the game in an office park. The backend may apply connections with other users whose demographic profiles are known. Such connections may include, but are not limited to co-location, exchanges of game content, as well as explicit connections between accounts. In some instances, location may provide evidence of purchases. In various instances, purchases can be directly linked to the game state. Purchase-related data may therefore be used to provide demographic insights. Additionally, users may provide some demographic information at the time they register to participate in the game.

Based on the user location traces, activity, and demographic estimates, systems in accordance with a number of embodiments may determine what products and/or experiences may be of interest to particular users. Upon these determinations, systems in accordance with many embodiments may incorporate promotions of these in the game environment. For example, returning to the Pokémon™ example, by catching one Pokémon™, users may be told that they qualify for a 25% discount for a Boba tea drink in the neighborhood, and/or would receive a limited-edition Pokémon™ virtual reality badge by being within 100 meters of the drink store. In another example, a group of associated players may learn that if they collaborate on an in-game effort like capturing a special Pokémon™ at a given time and location, then they may all qualify for 10% off a Pokémon™ branded bag of candy at a store close to the indicated location. Such promotional information may be circulated by in-game messaging, and/or by hearing it from another group of players that had the experience and were provided with the offer. Some promotional information may be considered explicit offers, and others may be considered implicit offers. The determination of what offers to give may therefore be based on locations, social network structures, demographics, and/or on past placement interactions of one or more users. Systems and methods in accordance with various embodiments can obtain information from feedback channels relating to the conversion of offers. This information may include, but is not limited to whether a player was engaged in the game component; whether they succeeded in qualifying for the promotion; whether they went to a neighborhood, whether physical and/or virtual, associated with fulfillment of the promotion; and whether there is an indication that the transaction, and/or mission, was completed. The latter may be received by collaboration from merchants and/or other entities providing products associated with the promotions. Merchants may pay for promotions, in order to draw potential future repeat customers to their location (e.g., so they can see how nice the location is). Systems in accordance with several embodiments may pay merchants to participate in the promotion, in order for the systems to determine, using A/B testing, what selected users are interested in. Determinations of user interest may be used to generalize to other associated users, and in order to provide more accurately selected offers to the associated users. Here, two users may be associated with each other by knowing each other, exchanging information with each other, being co-located at times, having similar interests and/or behavioral patterns, and/or belonging to the same general demographic group.

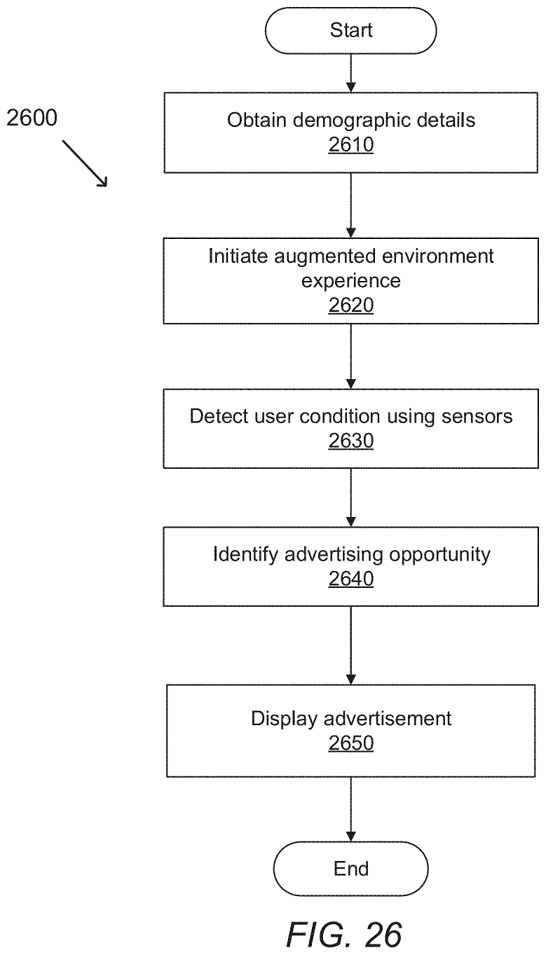

A process followed in an augmented reality environment, whereby the platform detects opportunities to advertise products in accordance with some embodiments of the invention, is disclosed in FIG. 26. Process 2600 obtains (2610) demographic information from users. Demographic information may include, but is not limited to age, race, sex, nationality, and/or sexual orientation. Demographic information may be obtained at once, including, but not limited to at the time of registration. Demographic information may be implicitly provided over time. Demographic information may be implicitly provided through observation of behavioral characteristics. Observation may be performed of users and/or user devices. Later, during the experience, process 2600 initiates (2620) an augmented environment experience. During the experience, process 2600 detects (2630) user condition using sensors. Sensors may include, but are not limited to microphones and cameras. Sensors may be placed in the users' headgear and/or other user devices. User condition may include, but is not limited to location, physical state, emotional state, immediate surroundings, and/or weather. Detection (2630) of user condition may include, but is not limited to, processing sensor information. Upon processing sensor information, process 2600 identifies (2640) an advertising opportunity. Possible advertisement opportunities may be chosen for users based on demographic information, behavioral characteristics, and/or user condition. Process 2600 displays (2650) the advertisement to users. Advertisements may be displayed on AR headgear and/or another user device. Advertisements may be displayed contemporaneously with the augmented environment experience and/or at a later time.

For example, Carol can be at work on a weekday, taking a break. She may have previously entered her demographic information into her favorite game's registration system. The demographic information may include her age, which is 38 years old. She can wear the augmented reality headgear and enter the gaming world. The headgear, having GPS capability, a microphone, and a camera system can collect information about her real-world environment. whether built-in and/or tethered from a nearby computation device. A system, in accordance with many embodiments of the invention, hearing her chair squeak as she rises, may catch a glimpse of a dilapidated chair with the camera. The system can identify an advertising opportunity for a replacement chair similar to the style she has. The advertisement can be displayed at a later time, so as not to seem creepy to Carol. Carol, thinking about her squeaky chair, may decide this particular advertisement sounds like a good idea and make a purchase.

Systems, in accordance with many embodiments of the invention, may incorporate contextual information from user environments, including, but not limited to images, color palettes, street scenes, activities, sounds, location information, time-of-day information, and co-location information. The contextual information may be used to make assessments that classify the player and their interests. For example, systems in accordance with some embodiments may perform client-side classifications of persons in sight of cameras used in AR games. The classifications may include, but are not limited to, gender, age, ethnicity, manner of dressing, as well as determinations of whether these users have been seen before. This can enable understanding of the social contexts of players. To the extent that such classifications can be made, and processed on client-side devices, bandwidth requirements may be reduced. Systems and methods in accordance with some embodiments of the invention may reduce bandwidth by periodically recording information including but not limited to images and small snippets of video that may be used for classification purposes. The information can be stored on client-side devices. In such cases, when client-side devices are charging, and/or connected to WiFi networks, snippets can be processed. Processing may involve communicating the classifications to backends.

In one example situation, a preliminary classification may be made on the client-side device. The classification may involve determining whether an image is of likely value. Other preliminary classifications may be more detailed and more demanding. Snippets that are determined to be of likely value may be later processed and/or communicated.

In some instances, privacy may be a concern while processing information. Processing may be done on user devices to a large enough extent that no personally sensitive information leaves. For example, a first processing of a classification can be made on the client-side device, with the resulting values generated from this transmitted to a backend device to be additionally processed. In doing so, the transmitted values may have less risk of causing problems to users, should they be leaked.

Simple pre-processing may be done as the snippet is recorded and/or otherwise obtained. Based on classifications and state settings, resulting data can be stored, transmitted to backends, and/or erased. An example state setting may be a setting, made by a backend, that an image feed is desirable, given the location of the user, the time of the day, and/or another signal. The image feed may reveal whether certain users are relaxed and/or stressed, based on the speed of moving. When users are determined to be receptive to promotions, e.g., based on not being stressed but not being half-asleep, systems in accordance with various embodiments may present such promotions to users.

Players can, in many embodiments, select in a configuration panel what type of data can be exported. This can be visualized as battery-vs-privacy meters, where users can set their preferred settings by moving sliders along axes. In such a meter, an explanation and/or an example may be provided in a box below the slider.

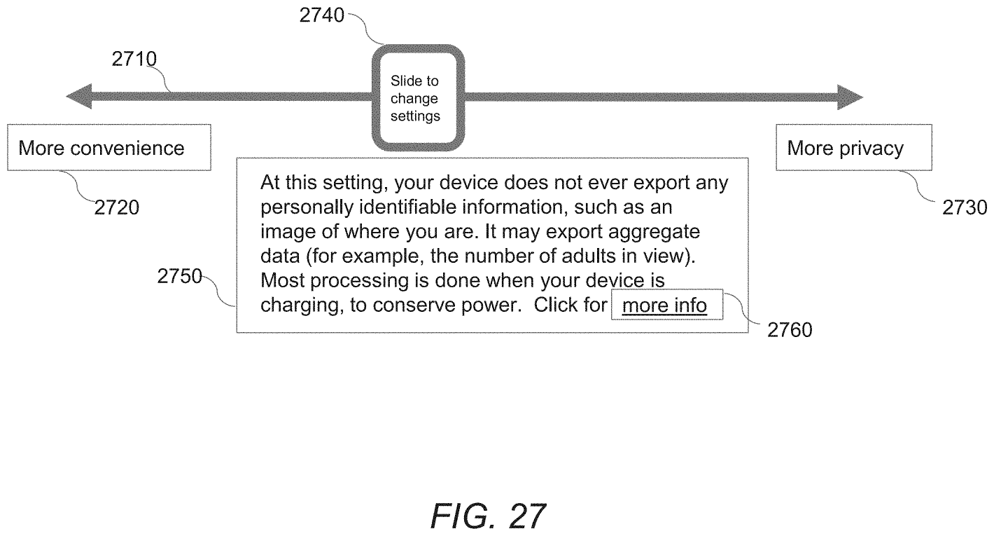

A possible one-dimensional implementation of a slider, in accordance with some embodiments of the invention, is disclosed in FIG. 27. A one-dimensional axis 2710 may have a first label 2720 and/or a second label 2730, each indicating the meaning of the two directions of the axis 2710. A movable slider 2740 can be moved along axis 2710. The moveable slider 2740 may include instructions disclosing its uses. At any location of the movable slider 2740, an explanation 2750 may indicate the meaning of the current settings of the movable slider 2740. A clickable area 2760 of the explanation can be clicked by users for additional explanations of the current settings and/or examples of the influence of the settings.

For example, an explanation may at first state “In this setting, no image data is ever transmitted to the central game server. This may mean that you may not receive promotional benefits.” By moving the slider a bit, the explanation may be changed to “In this setting, your phone scrubs image data to remove personally identifiable data before transmitting this to the game server. This may slightly reduce phone battery life, but enable in-game promotionals. Move the slider further to the right to reduce the battery impact.” In one setting, the explanation may state “In this mode, you save battery resources and enable promotional content, while protecting your privacy. Your phone may process images as it is being charged (you have to leave the application on for this to happen, though) and transmit non-identifying data to the game server when your phone is connected to a WiFi hotspot.”

Visualizations may enable informed consent in relation to features affecting user experiences. In accordance with a number of embodiments, visualizations may involve, but are not limited to, one-dimensional sliders and multi-dimensional sliders. For instance, in two-dimensional settings, one consideration (such as battery power) may be represented on one axis and another consideration (such as privacy) on another. Visual representations of the relationship between settings and associated impacts can enable users to feel in control over their data as well as other aspects, including, but not limited to where and when computation is performed.

Several embodiments of the invention may involve advertising systems. This may allow individuals and organizations to purchase characters, including but not limited to game characters and animated characters, for use in augmented and virtual environments. The purchase of such characters may enable future specials and promotions. As users make more purchases, expand their character library, expand their character capabilities and accessories, provide more personal information, and/or engage in more personal interaction with the character, the users may be sent more and better offers. Incentive structures may allow users to get more benefits from their characters for directly and/or indirectly providing knowledge into systems. An example of direct information may be answering questions posed by the character. An example of indirect information may be GPS location data that strongly suggests the individual works in a shopping mall. Promotional platforms, having benefited from the knowledge gained, can better target promotions and maximize revenue. These benefits may return to the users in the form of valuable incentives.

Obtained characters may be dedicated to tasks of believed interest to users. For example, Sheila-the-Aardvark may really like shoe discounts, so may introduce associated players to great deals. In doing so, Sheila-the-Aardvark can potentially provide extra discounts and/or early notifications to players who have downloaded the token and/or configuration information related to Sheila-the-Aardvark. Users may be offered to do this when responding to a shoe promotion in another game and/or the game in which Sheila-the-Aardvark is present.

Some characters may span multiple execution environments. For example, Sheila-the-Aardvark may reside in a first game that Alice has downloaded. However, Alice may provide her phone number as part of the registration, when her phone number is used for registration in a second application as well. The second application may allow Sheila-the-Aardvark to provide notifications at suitable times. For instance, example notifications may indicate a shoe sale within five minutes walking distance for Alice. Alice may receive these notifications because she configured that she agrees to get notifications of this type from Sheila-the-Aardvark on the second application, and/or any applicable application supporting such notifications. The determination of whether conditions are satisfied for users to get a notification may be based on a number of considerations. For example, a system may consider, but is not limited to, the determination that users are receptive to a notification; whether a notification is likely to be safe, e.g., not a distraction that is dangerous; and whether the context indicates that notification is likely to result in a conversion.

In certain embodiments, platforms may enable individuals to use their characters in a manner to recommend products and/or services to other individuals and organizations within, and/or between, the immersive environments described above. This application may involve characteristics described in U.S. patent application Ser. No. 17/806,728, entitled “Systems and Methods for Encrypting and Controlling Access to Encrypted Data Based Upon Immutable Ledgers,” filed Jun. 13, 2022, the disclosure of which is incorporated by reference herein in its entirety. Individuals may be able to post reviews on the platform such that when another individual comes upon an offer and/or a product, they can be presented with personalized and/or anonymous reviews.

For example, Bob may be playing an experiential online game and come across a virtual convenience store. whereupon he purchases a virtual tourniquet with which to patch up his gaming buddy. The virtual tourniquet may be a representation of a real-world tourniquet that Bob has used in real life as an emergency medical technician. A system, knowing that Bob has specific medical knowledge can offer Bob an opportunity to leave a review for the real-life tourniquet product. The system may have knowledge of Bob's experiences based upon his in-game chat characteristics, and/or being notified of this by the presentation, by Bob, of some real-life credentials. The notification may be in the form of a token describing his employment. Upon receiving the offer, Bob may choose to leave a review, allowing the platform to create an NFT token of Bob's review.

Another user, Cindy, who does not have any medical knowledge, may purchase a tourniquet. Since she is not knowledgeable about tourniquets she may instead be offered to provide a review of the virtual product. Reviews for real-life products and for virtual products may be labeled and stored accordingly by systems. The token may be referred to again within the game when another player is looking for a virtual tourniquet. The NFT may reside outside the gaming environment where it can be called up in real-life, in other game environments, and/or immersive environments.

Darryl, a real-world citizen may come across a review, as enabled by the presence of the token, in a real-world situation. Darryl may see the review when buying online, checking reviews on his mobile device while shopping for common medical devices for emergency planning. The existence of the NFT review and the mechanisms for requesting the review, minting the NFT, and/or reusing the NFT review may be deployed by the platform. The capacity to access reviews may be offered by another 3rd-party wishing to provide such services. Systems in accordance with several embodiments may be used beyond product reviews, including, but not limited to in an ability to transport knowledge, character learning, in-game tools, communications, etc. These varying uses may involve an end result of improving advertising and promotion success and connecting environments that are ordinarily quite separate.

In another example, Bob may provide access by a system to a marketplace profile. Access may be granted by uploading reviews on Amazon™, for instance. This may allow the system to determine Bob's preferences, skills, insights, and more. In some example embodiments, this determination of Bob's information can be done in collaboration with the example marketplace (e.g., Amazon™). For a number of embodiments, it may be achieved simply by Bob providing his Amazon handle to the system, which then accesses his Amazon reviews. Optionally, the system may request for Bob to provide a confirmation that he indeed corresponds to the indicated handle. In some instances, Bob may provide an email address from which one or more handles are determined and associated reviews and other data can be imported by the system. This can allow the system to provide virtual products related to real-life products users have purchased, for example. This way, Bob can receive a pair of virtual sunglasses to match the real-life sunglasses he just purchased. Alternatively or additionally, if Bob purchases a pair of virtual glasses in the game, he may be offered a discount for purchasing the same glasses from one or more brick-and-mortar vendors. Alternatively or additionally, Bob may purchase the sunglasses in real-life and be offered a free virtual pair of sunglasses for his virtual persona. This may correspond to a form of product placement as other players may be able to see what brand of glasses Bob favors.

Systems and methods in accordance with various embodiments of the invention may enable characters to move from their home immersive environment to another immersive environment, as described above. Characters may have capabilities in one environment, including, but not limited to interaction, learning, and display capabilities. The characters may take certain promotion, advertising, recommendation, and/or review capabilities from their native systems to other immersive environments, including, but not limited to other games, augmented, and virtual environments. The ability for the character to offer benefits in expanded settings can enable the character platform to expand its reach.

The promotion capability may go beyond commercial promotions. For example, promotion access can relate to virtuous behavior, including, but not limited to performing good deeds. Virtuous behavior may involve performing good deeds wherein doing so creates benefits in the game environment, where a situation in the game environment may be associated with a good deed, and/or where the behavior can be expected to better society at large. For example, a player might be encouraged to recycle, to help an old lady cross the street, and/or to volunteer their time to clean up a beach. This encouraging feature can be integrated into the game. For example, by picking up trash on a beach, the player may increase their odds at prevailing in an in-game environment. For instance, the in-game environment may help the user find a place to dispose of the collected trash, drawing the player to a specific location in the game. Therefore, the notion of promotion may generally be used in the context of influencing actions and/or introducing users to concepts and/or environments, no matter what the underlying reason is. In another example, a local government may sponsor some goal in the context of a game, e.g., to raise awareness of a healthy attitude, a pleasant new park, a new shopping district to which it is desirable to draw customers to reduce traffic on overburdened highways, and more.

Tokens developed in accordance with a number of embodiments of the invention may incorporate capabilities that may facilitate their use in immersive environments.

Systems in accordance with certain embodiments of the invention may incorporate self-reporting elements for token transfers. Some characters and other digital artifacts can be represented by tokens as described above. Some tokens may be tied to selected users, and be non-transferable. For example, a biometric token may be tied to a given user that it represents. This is described, for example, in U.S. patent application Ser. No. 17/808,264, entitled “Systems and Methods for Token Creation and Management,” filed Jun. 22, 2022, the disclosure of which is incorporated by reference herein in its entirety. In addition, tokens with content can be tied to users, including, but not limited to a player that “earned” the content in a game. Some tokens may be transferable, though, making them possible to sell to other players. To protect against theft of such artifacts, tokens that represent the artifacts may self-report as ownership is transferred. Self-reporting may cause a notification to multiple entities, including, but not limited to the current owner (i.e., the seller) and/or bounty hunters. Self-reporting may notify fraud detection entities that review patterns of transfer to identify likely fraud. The fraud detection entity may, for instance, use machine learning and/or artificial intelligence techniques that detect patterns in transfers. Self-reporting may notify tax authorities in jurisdictions associated with the seller, when that tax authority considers the sale of artifacts to be a taxable event. A self-reporting element can be expressed as a computational component of a token that includes a contract, e.g., a smart contract. The self-reporting element can be expressed by a filtering technique implemented by a bounty hunter, for example, where the bounty hunter identifies the event and reports it. Bounty hunters are detailed in co-pending application U.S. patent application Ser. No. 17/806,065, entitled “Systems and Methods for Maintenance of NFT Assets,” filed Jun. 8, 2022, the disclosure of which is incorporated by reference herein in its entirety.

There may be many alternative manners of implementing self-reporting capabilities, using the techniques described in this application. We may refer to the executable component determining events and actions as a policing component. Policing components may be in the form of, but are not limited to policing tokens. Policing components may incorporate parts of tokens with additional functionality. Policing components, such as the policing token, may perform the detection of events and initiation of actions, including, but not limited to those described above, relative to external resources. External resources may include but are not limited to one or more tokens that the policing token is associated with. Bounty hunters may perform such policing activities. The verification of reported events may be performed on a periodic basis, including, but not limited to once an hour. Verification may be triggered based on the detection events made by other policing tokens and/or related to other resources. Wake-up signals may be used to activate policing components and policing tokens. Wake-up signals can be caused by the set activities, including, but not limited to the logging of a given token on a ledger; the execution of a selected token; the completion of an agreement associated with a contract token, and more.

Tokens may contain executable code that can protect corresponding assets from abuse. Examples of abuse may include, but are not limited to unintended and/or unexpected asset modification, unexpected asset offline, change in ownership status, illicit duplication of token and/or asset, attempt to use of asset outside license terms, token access counter exceeding a threshold (e.g., when an advertisement is “viewed” a set number of times), and a token and/or asset under attack, e.g., DDoS and/or repeated authentication failures. Tokens may include code to take actions upon detection of potential abuse. Responsive actions may include, but are not limited to self-reporting to owner, licensee, authority, and/or third-party; self-deactivation of token and/or asset; temporary self-deactivation of token and/or asset; automatic asset replenishment (e.g., when an asset has become corrupted); self-flagging within the token and/or blockchain; royalty transaction execution; royalty reporting; anomaly reporting; flag and/or report to bounty hunter for investigation; and the ability to self-clear any of the above actions. As such, tokens may include and/or be associated with code that determines abuse indications, including, but not limited to indications that any of the previously described events have taken place, and take actions conditional with the observed events.

Several embodiments may include techniques to make advertisements and characters portable. For example, advertisements experienced by individuals and/or organizations may, according to their token policies and licenses, enable experiencing parties to add the advertisements to their digital wallets and/or similar repositories. Parties may have the capacity to add advertisements to repositories for the purpose of expanding the reach of the promotion, creating a review, creating a recommendation, and/or sending to a colleague and/or friend. The policy for a particular advertisement might, for example, enable individuals to earn credits when advertisement usage gains the manufacturer's direct sales. More generally, many embodiments may address how to make knowledge transfer contextually relevant. For example, relevance may come from providing information that enhances an experience based on providing the information when the users are in a location and/or situation that makes absorption of the knowledge more likely. The determination of context can be made based on detecting one or more of a location, an event, an activity, the presence of another user, recent consumption of a (high-caffeine) beverage, and a mood. In various embodiments, moods may be inferred from various sources, such as (but not limited to) analyzing pace and tone of voice, e.g., in a voice command and/or in a phone call. The transfer of knowledge may be performed by providing users with benefits, discounts, encouragement, rewards, etc. Benefits may be virtual and/or associated with physical goods and activities. The portability of advertising tokens may enable advertisements to be introduced in one environment and ported into another environment. For example, an advertisement may be introduced to a gaming environment, and later added to a virtual classroom. Possible environments may include, but are not limited to backgrounds on conference calls, published videos, websites, broadcasts, virtual environments, and/or augmented environments. Porting may involve the generation of second advertising tokens based upon the content and policies of the original advertising token. Rewards for porting, and/or republishing advertisement tokens, beyond the viewership of the initial token, may be provided within the token's smart contract. The conversion of views, clicks, purchases, etc. of the second token may be captured on a client-side application, including, but not limited to a game and/or mobile application located on the device of the viewer of the republished token. The conversion may occur within the server-side of the utilized gaming environment, the server-side of a similar environment, and/or within the server-side of the initial advertiser.

In accordance with some embodiments of the invention, republishing advertisements may be a mutually beneficial practice. Advertisers may set the promotional terms of advertisements. Promotional terms may be set in the policies of an NFT, for example. The advertisers can publish advertisements to be experienced by one or more users. The users, intrigued by the product, may add the item to their digital wallets. In another setting, users can re-publish the advertisement by, for instance, sending it to a friend, and/or posting the NFT in an immersive environment where others may experience it. When someone else experiences the advertisement that was republished, they may like and purchase the item. When this happens, the individuals that republished the advertisement, having made a sale for the advertiser, can get credit for the purchase.

For example, Acme Company may be selling a new patio umbrella and like to advertise the product in a way where influencers may be able to broaden the reach of their advertisement. Acme can set the promotional terms as policies within an NFT that may be associated with the primary advertisement. In this example, the advertisement may be an email to their loyal customers. Alice may receive the email, experience the advertisement from Acme, and recognize the opportunity to gain a credit with Acme. Specifically, Alice may gain a credit by adding the advertisement NFT to her digital wallet and republishing the advertisement within her favorite gaming environment using the advertisement NFT. Alice's friend Betty may experience the republished advertisement in the same game, like the item, and make a purchase. Alice, for her efforts, can get a 25% discount coupon on any Acme product for helping them sell the item.

Tokens may be used to move digital items and knowledge. This may be applied to content including, but not limited to knowledge of users' personal preferences, personas, AI-customized characters, and items of value constructed by the individual from one environment to another. For example, a gamer may have developed an alias type persona in a gaming environment. The alias may be used in another environment with the use of an alias token, as described in U.S. patent application Ser. No. 17/808,264, entitled “Systems and Methods for Token Creation and Management,” filed Jun. 22, 2022, the disclosure of which is incorporated by reference herein in its entirety. In another example, users involved in virtual real-estate environments may use the aid of minted tokens to move virtual buildings to novel environments.

In some game environments, moderators may create elements, set configurations and resolve potential conflicts. Moderator may introduce promotional material, e.g., a commercial promotion and/or a moral message. Introducing promotional material may involve adding imagery of products and specifying the functionality of the products in the context of the environments. In a game, for example, a functionality may involve a set of options (e.g., improves stamina 10%) and/or by provide an executable token and/or other script that determines the use of the item and/or character. Introduction of content in this manner may result in benefits for the game manufacturer, as well as for the moderator, when a system detects conversion. Examples of conversions may include but are not limited to purchases, clicks, detection of attention by a player, and/or usage of the product by a player in the environment. An example of attention detection may be based on eyeball tracking; another example may be that the player moves their character to avoid and/or get access to the item, suggesting recognition of its presence. Based on the type of conversion and the number of conversions, moderators may be provided with different incentives and/or benefits, including payments. Benefits may be automatic based on the actions of a participant. For example, where game-play causes the execution of a token including and/or referencing the promotional material, moderators may receive payment. The game provider may gain a benefit in various forms. One example may be a portion of the payments and/or incentives the moderator receives. Moderators may be computational entities with user interfaces. Such user interfaces may be used to receive configuration values from users with administrator roles relative to the moderator entities. Systems may have multiple moderators, and one moderator may create a token representing promotional content and use it in a game. They may enable other moderators to use the token. Tokens used by moderators may include, but are not limited to scripts, visual descriptions, audio descriptions, rules and policies. In certain embodiments, a second moderator may use promotional content from a first moderator in a game configured by the second moderator. In this context, a reward associated with a conversion related to the token may be shared by the first and the second moderator. Token sharing in accordance with a variety of embodiments of the invention may be performed according to a formula that may be enshrined in a contract element that is part of the promotional data token, and/or associated with it. Such contract elements may be a contract token, as disclosed in U.S. patent application Ser. No. 17/808,264, entitled “Systems and Methods for Token Creation and Management,” filed Jun. 22, 2022, the disclosure of which is incorporated by reference herein in its entirety. Multiple content providers may act as moderators and/or provide content for moderators in exchange for some benefit. Such collaborations may include techniques disclosed in U.S. Pat. No. 11,348,099, entitled “Systems and Methods for Implementing Blockchain-Based Content Engagement Platforms Utilizing Media Wallets,” issued May 31, 2022, the disclosure of which is incorporated by reference in its entirety.

Moderators and other content providers, may incorporate promotional content in immersive environments to enable information exchange. Advertisers may provide promotional content in the form of promotional tokens. Promotional tokens may include visual artwork, audio elements, configuration values and/or policies specifying how the item of the token may be used. Promotional tokens may include and/or reference rules specifying rewards associated with conversions. The rewards may be based on the type of conversion, the number of conversions, and/or the demographics of the player and/or other users that causes the conversion. Moderators may perform configurations related to promotional tokens. The configurations may include, but are not limited to the inclusion in immersive environments, the addition of scripts and/or, the incorporation sets of rules indicating the usage functionality of the items of the tokens. Results may be expressed as derived tokens and/or as meta-tokens that reference the derived tokens. Configured tokens may be referred to as moderator tokens. Moderator tokens may include rules for how rewards are to be shared by any other moderators that uses the moderator tokens in environments. The rules may apply to moderators that use moderator tokens in a token they create and/or configure. Moderators may share moderator tokens. Sharing moderator tokens may involve, but is not limited to, incorporating it in a game environment, making it accessible to other moderators, e.g., by posting on a public blockchain, private blockchain, other databases, and/or a combination of such actions. Multiple moderators may make incorporate single moderator tokens into game environments. The updated moderator tokens may include additional rules for sharing rewards. When moderator tokens are converted, the conversion may be recorded. Records may have contextual information including, but not limited to the demographics of players and/or users that caused the conversion. Based on the conversion information, the contextual information, and/or the rules specifying the sharing of rewards, rewards may be provided upon conversion of the moderator token.

Systems in accordance with some embodiments can be incorporated and/or implemented in various contexts. Such contexts may include, but are not limited to, fully distributed settings and/or traditional settings with integrated tokens. Such settings may include, but are not limited to what is disclosed in U.S. patent application Ser. No. 17/808,264, entitled “Systems and Methods for Token Creation and Management,” filed Jun. 22, 2022, the disclosure of which is incorporated by reference herein in its entirety. For example, traditional platforms can be used for accounting related to conversion events. For instance, a static service provider associated with a token including promotional content may be used to tally billable events and cause payments to be made. Alternatively, tokens with promotional content may contain and/or be associated with smart contracts. The smart contracts may then be completed in response to a conversion event, e.g., as observed by a trusted party that performs metering. Some types of metering technology are disclosed in U.S. Pat. No. 11,348,099, entitled “Systems and Methods for Implementing Blockchain-Based Content Engagement Platforms Utilizing Media Wallets,” issued May 31, 2022, the disclosure of which is incorporated by reference in its entirety. Alternatively or additionally, other metering technologies can be utilized.

Many embodiments of the invention may use contextual information instead of and/or in addition to keyword analysis approaches. One example of such contextual elements may information related to user action, user location, user co-locations and/or a combination of such. Use of contextual information may result in behavioral targeting with minimal intrusiveness while still understanding the general needs of users.

In many embodiments, individuals and organizations may create their own advertisement tokens, advertising third-party products. These “grass-roots” advertisements might appear as recommendations and/or reviews. The advertisements may be in the form of traditional print and/or media advertisements. Third parties in these instances may own copyrights to help protect from negative advertisements. In the case of positive advertisements, third parties, and/or manufacturers may re-publish the advertising tokens of the individuals and/or organizations. The entities publishing particular advertising tokens may set policies in the tokens that enable manufacturers and/or other third parties to republish the advertisement. Policies may allow republishing freely, and/or for fees. For example, Edward may be an artist and a big fan of a particular coffee provider. He recently created a beautiful painted artwork of a steaming cup of coffee next to a bag of the coffee he likes. Edward, wanting to extend his artistic enterprise, can mint an advertisement token with policies including the right for the coffee supplier and/or their partners to adopt the advertisement as-is. They may adopt the advertisement in a modified form. Edward's consent to this may be limited by policies, such as that they must highlight his name in the advertisement, provide him with a credit for every instance and/or viewing of the advertisement, etc.

Systems and methods in accordance with several embodiments may enable NFTs to be licensed and utilized in augmented conference call environments. Augmented call environments may include, but are not limited to doctors and patient virtual medical calls. In an augmented call with a doctor, the doctor can simply select various tokens for transfers and actions. For example, a doctor prescribing an over-the-counter daily aspirin might select a token that emails instructions to the patient along with an advertisement for his preferred brand. In doing so, the doctor may receive a credit from the manufacturer and/or distributor. The same doctor may prescribe a pharmaceutical to the patient, whereby information may pass to the patient, the patient's recommended pharmacy, and any coupons and/or discounts that may be available. The use of the tokens can create entries in the patient's records. Such systems may benefit various providers and manufacturers wishing to track the influence and product and/or service sales resulting from medical professionals. The use of tokens may be synergistic with tokenized patient identities and patient records whereby newly applied tokens to the patient may be easily incorporated in the tokenized patient records.

For example, a doctor and a patient may engage in a virtual medical visit. The doctor can have access to the patient records. Access to records may be enabled by tokens, and/or other methods. With some pointed questions, the doctor can diagnose a problem and suggest the patient begin a daily aspirin regimen to help thin the patient's blood. To assist the patient, the doctor may display an aspirin token from his wallet, and/or his company's wallet. The token may allow the patient to view the information surrounding the regimen in a virtual environment. Accepting the aspirin token may carry an accompanying brand coupon. The brand coupon may mitigate the eventual cost of the aspirin regimen. After the visit, the patient can further review the aspirin details and, if they choose, purchase the aspirin with the coupon token. The combination of aspirin purchase and coupon use may enable a smart contract to execute an update to the patient records regarding the purchase of aspirin. An additional alert to notify the doctor may be provided for the doctor's knowledge.

Temporary care providers may, in the impromptu treatment of a patient, use tokens. Specifically, temporary care providers may apply biometric, identity, and/or medical record tokens to facilitate care. Patients may be involved in accidents, wherein EMTs and/or other emergency workers are called, arrive on the scene, and make triage assessments of the patients' conditions. The EMTs may log into a system where the patients' tokenized records are held. In doing so, they may identify the patients, access the patients' records, recognize a medicine usage, perform the relevant medical procedure based on the records, updates the patient records with information on the accident and/or notify the patients' respective care providers.

Tokenized patient records may be beneficial in emergency situations. Specifically, tokenized patient records protected with identity and biometric tokens may allow an emergency medical technician to perform biometric identity authentications and immediately access the medical records of emergency patients. EMTs may be able to access the records with a simple biometric scan of the patient, possibly aided by the patient's electronic devices. Patient access records may be updated, in compliance with national privacy laws, to record the identity token of the EMT. The tokens may contain executable code to self-report the use of medications to authorities. Systems and methods in accordance with many embodiments may be utilized in-person at the doctor's office with the help of a computer and display. The sharing of tokens may initiate reporting, e.g., to drug manufacturers and/or authorities. Reporting may involve, but is not limited to, who prescribed the medicine, to whom, who shared certain instructions and/or to whom.

For example, Alice may be involved in an accident causing her to lose blood. EMTs may be called and arrive on the scene. The EMTs may make a rapid assessment that Alice's blood loss is significant. The EMTs may decide between multiple treatment options. Option 1 may be to apply bandages and pressure to halt the blood flow and allow clotting. Option 2 may be to apply bandages and pressure, but apply a tourniquet. Applying a tourniquet may be considered a slightly riskier procedure due to the lack of blood flow to the limb. Bob, the EMT, may seek more information, and log into his medical computer system. The log-in may be performed using an identity token and biometric token validation of Bob's. Alice may be identified in any of a number of different ways. Alice may have a mobile device with emergency medical information, and/or a wallet with printed identification. Bob may find her phone and locate her name. Identification may be performed with a rapid biometric fingerprint authentication using tokens of Alice's. Tokens may be used to access Alice's available patient records. The token system, recognizing Bob's credentials, may log his access of Alice's patient records. Bob's quick scan of Alice's records may indicate that Alice recently started a daily aspirin regimen and decides the best course of action is Option 2 because the aspirin may prevent the blood from clotting sufficiently without a tourniquet. Bob can then apply the tourniquet, noting the time of application. Bob may make a quick note of the tourniquet on his computer, which can alert the hospital staff and Alice's personal physician.

Systems and techniques directed towards incorporating NFTs into advertisement generation within immersive environments, in accordance with various embodiments of the invention, are not limited to use within NFT platforms. Accordingly, it should be appreciated that applications described herein can be implemented outside the context of an NFT platform network architecture unrelated to the generation and/or storage of fungible tokens and/or NFTs. Moreover, any of the systems described herein with reference to FIGS. 26-27 can be utilized within any of the NFT platforms and/or immersive environment configurations described above.

### C. Immersive Environment Audio-Optimization Techniques

Some embodiments of the invention may incorporate techniques directed to modify and improve audio as perceived by end-users. Such audio-based Augmented Reality (AR) and Mixed Reality (MR) techniques, may collectively be referred to as Enhanced Audio-based Reality (EAR).

Systems in accordance with several embodiments of the invention may include, but are not limited to, one or more input elements, processing elements, and output elements. Input elements may include, but are not limited to one or more microphones, and a receiver to receive signals. The signals received by the input elements may represent audio information and data to process audio information. Systems operating in accordance with certain embodiments may include one or more input elements related to non-audio information. Non-audio information may include, but is not limited to video, GPS, bio-signals, gesture and motion data, social media data, information from machine-learned models of user preferences and other phenomena, and/or other data. Example biodata may include but is not limited to heart rate, galvanic skin response, pupil dilation, breath rate, and EEG. Such signals can be obtained from user devices with associated sensors. Output elements may include a headset. Headsets may include, but are not limited to the form factor of earplugs, an over-the-ear headset, and/or an in-ear hearing aid. The processing element may be special purpose and/or be represented by software running on a mobile device. In some embodiments, processing may be performed externally to user devices. For example, processing may be performed by a cloud server in radio contact with another processing element carried by users. Input and output elements may share the same physical housing. Input and output elements may be connected to the processing element in a wired manner, in a wireless manner, including, but not limited to using Bluetooth Low Energy (BLE), and/or by the processing element being physically incorporated in the housing of the input/output element.

A number of embodiments of the invention may incorporate the functionality of identifying and emphasizing speech. Specifically, systems and methods in accordance with certain embodiments of the invention may involve identifying one or more selected human speakers, selectively enhancing their associated utterances, and suppressing the utterances of other speakers. This may be applied for the benefit of individuals with speech and/or hearing impediments.

In many embodiments, users can select whom their systems should auditorily focus on. For instance, systems may select one or more preferred speakers whose voices may be identified and enhanced, when present. Users may select a speaker they are listening to and indicate that this speaker should be recognized and enhanced in future situations. Making this indication may cause a profile of the speaker to be created and stored. As particular profiles are later matched, the speaker may still be selected by a system for their voice to be enhanced. Users may select to temporarily enhance the voice of any speaker within a particular range, even without a profile. For instance, a range may include, but is not limited to an area within five feet of a user device. Another range may be a triangular area in front of the user. Speakers can be matched based on analysis of their voice, the presence of a radio transmitter that conveys their identity to the recipient user, and/or a combination of such methods.

In a number of embodiments, users can select whom their systems should auditorily filter out. For instance, systems may select one or more sources of audio output, including, but not limited to a person speaking, to suppress. As is the case for voice enhancements, suppression may be temporary, long-term, based on identity and/or based on relative location. Identity may be associated with radio transmissions identifying the source of audio. Identity may be based on the detection of a speaker by analysis of the voice. Using such techniques, automated announcements on a subway train may, for instance, be suppressed by users who are familiar with the stops and where to get off.

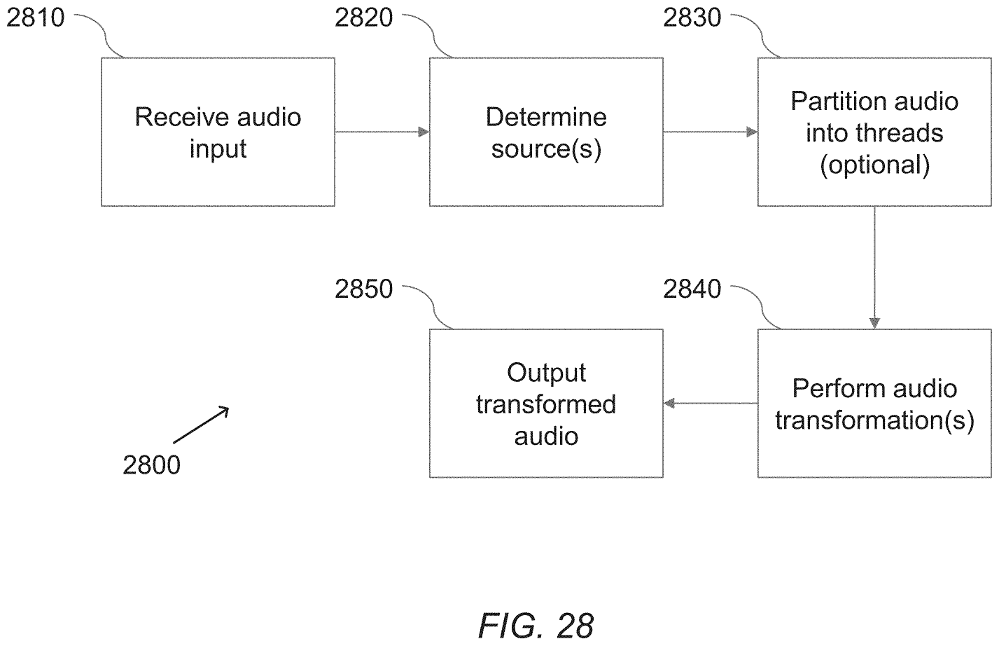

An example process in which audio input is manipulated, in accordance with several embodiments of the invention, is illustrated in FIG. 28. Process 2800 receives (2810) audio input from a particular source. An audio source may include, but is not limited to, a person speaking, a person singing, an alarm, and a song being played. Audio input may be received using a variety of devices, including but not limited to one or more microphones, a Bluetooth Low Energy radio connected to a mobile device that may be, but is not limited to a cell phone and/or a 5G radio connected to a cell phone tower. Process 2800 determines (2820) the one or more sources. An example of processes for determining one or more sources are discussed in greater detail below. In response to determining (2820) the one or more sources, process 2800 may partition (2830) the audio into two or more threads. A thread may represent, but is not limited to, one audio source, including, but not limited to one person speaking. Process 2800 performs (2840) one or more audio transformations. Example audio transformations may include, but are not limited to, the separation of the input audio into streams associated with threads; the suppression and/or enhancement of audio; the translation of voice data; the transcription of voice data; the creation of searchable logs, etc. An audio transformation example is depicted further below. Once the audio is transformed, process 2800, outputs (2850) the transformed data. The audio may be output in several ways, including but not limited to, using one or more speakers using a radio transmitter, etc. The transformed data may be sent to destinations including, but not limited to, a data file and/or a log.

In some embodiments, enhancement may be based on the detection of content of audio. For example, users fluent in English that do not speak German may wish, when visiting Germany, to have audio corresponding to spoken German suppressed and overlaid with real-time translations of the spoken German. In such instances, words that cannot be identified by systems, may be conveyed in their original form and/or with an audio indication of not being translated, depending on the user configuration. Users may configure windows of time for translations; for instance, a short window would cause a near-verbatim translation, word by word. By contrast, a longer window may, for example, have more time to reorder words as they are translated and/or identify idioms and correctly translate these. Like the examples described above, translations may be performed based on relative locations. Translations in accordance with several embodiments of the invention may be performed based on automated detections of languages, e.g., causing the locally spoken language to be translated to an identifiable language, but only when user information suggests the user does not know this language well. In such examples, users not speaking German and visiting Germany may elect not to have French translated to them, but instead suppressed, unless spoken by a person within 5 meters of the user, and/or by a person that can otherwise be identified as likely speaking to the user. This functionality may incorporate the detection of language, stored information about the user, and/or the detection of the speaker, along with translations that may be performed based on a configuration and/or which may depend on a window value of the configuration.

In certain embodiments, systems may be configured to enhance and/or suppress audio content that is not speech, and/or not solely speech. For instance, a runner may desire to remain aware of traffic noises even while listening to music. A system may adaptively filter the runner's current music to reduce frequency overlap with the current traffic noise. Alternatively or additionally, the system may amplify certain road sounds. System behavior may be switched on and/or enhanced during key moments. Situations where behavior might be switched may include, but are not limited to when the GPS indicates the runner is approaching an intersection while a camera integrated into the headset detects approaching cars. Changes can be triggered by sounds, the estimated location of origin of the sounds, and/or how the sound is changing.

In some embodiments, systems may use audio and/or non-audio signals to automatically switch configurations. After receiving certain signals, systems may initiate audio modifications and/or change their approach to audio modifications. For instance, if a motion sensor in the headset detects running movement, while music is being played, the “running mode” music enhancement may turn on. In another example, speech enhancement may be turned on as soon as the number of concurrent speakers in a space rises above some threshold.

In a number of embodiments, systems can augment users' audio worlds with new sounds. These sounds may include, but are not limited to alerts. For instance, an alert may sound when a computer vision model applied to camera data from the user's headset detects an oncoming car. These sounds may include speech descriptions of phenomena around the use. For instance, a description may include a reminder of the name of a person whose face has just been matched to a person in the face recognition registry but who has not been seen frequently. In such a case, the description may offer facts that have been saved. Another example may present a label of the species of bird currently singing, produced by a birdsong audio classifier. These sounds can include data sonifications rendered so that they are informative and/or pleasing to listen to. For instance, the local weather forecast for the next hour could be used as input into a generative algorithm for ambient background music. In such a case harmonic and rhythmic characteristics may hint at the likelihood of approaching inclement weather. Sounds may include, but are not limited to content pushed to users from third parties, for instance, GPS, motion sensors, and/or eye movement analysis. One of these content sources may detect users passing by a shop and pausing to look in the display window, providing notifications of a discount and/or they could be played a song chosen to align with the shop's branding.

Users may select to enhance and/or suppress audio based on the meaning of content. For example, system in accordance with various embodiments may suppress any announcement that does not relate to a specific flight (e.g. Flight 22 to Denver). This is an example of where the selection of what audio to modify sound may be based on a parsing of the content of the audio. Parsing audio content may involve the detection of keywords (e.g., “Flight 22” and/or “Denver”) and/or may be performed using artificial intelligence methods used to infer the meaning of the content.

Some content may be delivered in real-time, while some determinations and classifications may involve delays. The conveyance of the audio, when not suppressed, may be performed at a speed that is higher than that of the original, in order to catch up with the speaker. Such speed changes can be made to accommodate speed changes between languages.

Systems in accordance with certain embodiments of the invention may determine the locations of sources of audio using various techniques. These techniques may involve triangulation methods, and/or determining the input strength of the audio. For example, a headset may be equipped with two or more microphones receiving audio signals, and a connected processor can determine the location of a sound source by determining time differences between the two or more audio signals. Radio receivers can be used to determine the approximate distance to another radio. Distance may be approximated by varying the output signal strength and receiving responses to some messages but not all; and/or by determining the signal strength of received radio signal and assessing likely distance based on the common signal strengths for the associated type of device, as determined by headers and other information. In various embodiments, one or more cameras, heat sensors and/or motion sensors mounted on and/or in the headset may be used to determine the location of objects. These assessments may be combined for a more accurate assessment of the relative location of sound sources.

Systems may be used to process multiple threads of conversation at the same time. In doing so, one or more threads may be conveyed to users. Users can selectively modify the volume of the conveyed threads. The determination of what thread a given audio signal belongs to may be based on performing Fast Fourier Transforms (FFT) to determine likely frequency ranges for each sound source, and/or on performing context-based attributions of audio signals. For example, by determining in real-time a transcription of audio to text, a new audio input signal may be attributed to one or more speakers based on the already transcribed data and/or a maximum likelihood analysis of the new signal belonging to a given time series of audio associated with one particular speaker and/or other audio source. Such maximum likelihood analysis can determine, for example, what words may be formed by the addition of a sound element.

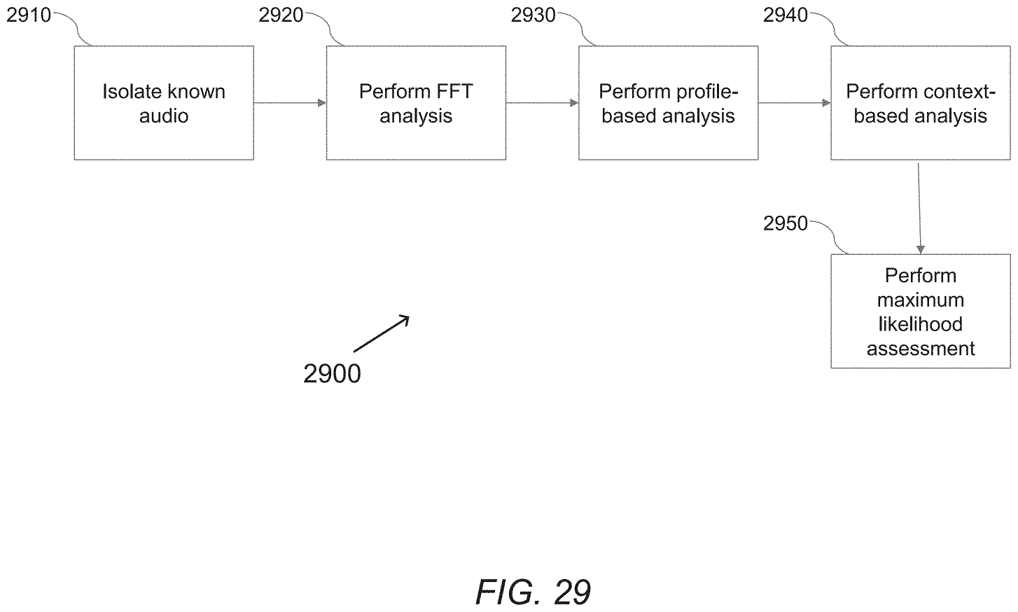

A process for the separation of an audio input into two or more threads, in accordance with various embodiments of the invention, is disclosed in FIG. 29. Each thread that audio inputs are separated into may be associated with a source of audio data. Process 2900 isolates (2910) known audio data, where applicable. Examples of known audio data may include, but are not limited to songs known by a system and/or concurrently broadcast audio data including, but not limited to the audio of a newscast. Audio may be filtered out of the audio input signal to remove it from the resulting signal, which can then be further processed. Process 2900 performs (2920) FFT analysis on the resulting signal. Process 2900 may alternatively perform an FFT (Fast Fourier Transform) analysis on the original input signal when no known audio is subtracted. The FFT analysis may be used to match portions of audio signals to known speakers. Known speakers may include, but are not limited to people for whom voice profiles have been created. As a result of the analysis, one or more tentative speakers may be identified using the match result and/or previous determinations. Process 2900 performs (2930) a profile-based analysis of the one or more identified profiles. The profile-based analysis may be used to attempt to determine, based on individual speech patterns, the identity of the speaker when one exists. Process 2900 performs (2940) a context-based analysis is performed. Context-based analysis may include, but is not limited to, analyses based on likely words contained in audio signals. Context-based analyses may be optionally based on data associated with profiles identifying typical word choices of various speakers for whom profiles have been created. The profile-based analyses may optionally take into consideration radio signals received by user devices. In the latter case, an analysis product may include signals from nearby speakers, and identifiers associated with the devices of such speakers. Such identifiers may be leveraged to revise determinations of the likely source of audio threads. Process 2900 performs (2950) a maximum likelihood analysis based on the received data and the analyses of the remainder of the process 2900. The output of the maximum likelihood analysis may be a generated assessment, the assessment including, but not limited to, threads, attributions of sources for the threads, and audio data and/or transcribed data associated with the threads.

Maximum likelihood analyses may determine whether formed words make sense in the context of previously determined words. This may be language-based determinations that can be performed subsequent to language-based speaker determinations. Determinations may be periodically re-evaluated to address combinations of languages. Language assessments can be performed, for example, when there is no likely candidate mapping from a sound sequence to a word in a currently selected language. Such assessments may be based on determining whether the yet-unmapped sequence has a mapping in another language than the currently selected language.

Another system application may be to resolve audio collisions. For instance, when at the airport two gates may be making announcements, overshadowing each other. Systems in accordance with various embodiments could block one audio source, record it, and replay the blocked source when quiet airtime is available. Similarly, the systems can be used to replay audio sequences that listeners may have missed due to not paying attention.

in a variety of embodiments, attribution of audio clips to likely speakers can be performed by generating speaker models for speakers that systems have previously interacted with. This may be specifically applied to speakers identified and bookmarked as high-priority speakers. Such models can be generated using machine learning (ML) techniques, and used to determine likely fits with candidate audio clips that have not yet been attributed to speakers. Models in accordance with many embodiments of the invention may correspond to information including, but not limited to descriptions of how individual speakers enunciate different words, their frequency ranges, and other identifying aspects of speech, including, but not limited to stutters, lisps, and accents causing some sounds to be pronounced in unusual ways, etc.

Multiple concurrent sound sources can be separated, individually transcribed, individually translated, individually saved, and optionally, combined in ways reflecting likely conversations. Each of these, including the speech of users wearing headsets, can be tagged with the identity of the speaker, when known. Identity can be determined by correlation with radio beacons that may identify public keys, users' name, etc.; and/or by mapping to audio-based profiles based on FFT analysis and speaker-unique models. Each such identity may be expressed as user-assigned labels, for example “John”, associated with entries in a contact list, and/or be given name broadcasts by radio. The association between phone numbers and speaker models can be performed when users engage with other speakers on phone call, where the speaker model can be mapped to the name and phone number of an entry in a contact list. When multiple speakers are associated with the same phone number, individual profiles may be generated for each such speaker.

Users may select singular threads to interact with a variety of modes. Systems in accordance with various embodiments, after obtaining particular threads, may listen to the audio. review transcripts, listen to (where the audio may be the original) enhanced versions, and/or listen to translated versions. Transcripts may be rendered on a mobile device including, but not limited to mobile phones. The selection of threads can be performed using voice commands and/or using a graphical user interface of an application on a phone, for example. When audio sources have been identified using one of the attribution methods, and/or a variant of one of the methods, audio clips may be modified to incorporate attribution information. An example may be to preface an audio clip with “John said.” Transcripts in accordance with some embodiments of the invention may include similar indications of user identity when known. When speaker identities are not known by systems, audio clips and/or transcripts may be associated with a record. For instance, an audio file may be labeled a username and/or nickname, etc. Users may modify already attributed clips and transcripts. This may be used to change misattributed statements by modifying the associated identity. Changes in association may be used to create new profiles of new speakers. Alternatively or additionally, changes may associate the audio of the user-identified speaker with the voice profile of that speaker. When certain clips and/or transcripts are saved, log files may be used to identify placements, change in attribution, and/or the sources of changes and placements.

Systems in accordance with a number of embodiments may share voice profiles of speakers with various users. For instance, voice profiles may be shared in a tokenized form. Such transfers may be used to acquire voice profiles for common public speakers in the form of tokens, enabling use in new systems. Transfers may have the effect of ensuring better accuracy of the translation, better accuracy of attribution into threads, and/or better accuracy of noise suppression based, e.g., on an automated mapping of audio to transcripts and the removal of background sounds that are not associated with the mappings. Systems may acquire voice profiles of “typical” speakers of different areas. An example may include, but is not limited to a speaker of English who was raised in Louisiana, and/or a speaker of German whose native tongue is French. The profiles can be expressed in the form of tokens, where the models included and/or referenced in the tokens may be used to enhance the processing of audio. Tokens may be associated with given accuracy rates, have assurances of precision corresponding to extensive testing, and/or be signed by organizations performing and/or auditing such testing. Tokens may be associated with digital rights management (DRM) statements assigning access rights to the rightful holders of such tokens. Such access rights may be verified by the process using the voice models.

EAR technologies can be used to enable processing on devices other than the mobile devices described above. For example, the aforementioned techniques and technologies can be used to perform similar services for traditional teleconference phone calls, to perform real-time transcription of conversations between TV anchors for purposes of generating subtitles, and to enhance voice-driven user interaction methods. An example of the latter may use the association of spoken commands to speakers. In such cases, access control verifications can be performed to determine, in real-time, whether the detected voice command can be issued and/or transferred. The association of speakers to commands may be used to perform automated command attribution and/or automatically create logs of commands. Logs of this type may have applications when making identifications in noisy multi-speaker environments. In some embodiments, Logs may be in the form of entries saved on a blockchain, with the entries including, but not limited to attribution information, audio data and/or transcribed commands.

Systems in accordance with several embodiments of the invention may be applied to searches on spoken data. For example, systems may engage in comparisons of one or more search terms with transcriptions of conversations and commands. This may be used, for example, to process large quantities of customer service conversations. In particular, multiple conversations with customers may be automatically partitioned into utterances by a customer and a customer service representative, where individual statements are attributed to the appropriate person. This can enable searches for terms indicative of problems, including, but not limited to a customer service representative making assertions that cannot be substantiated in order to increase the chances of a sale. Searches may involve, but are not limited to searching for associated keywords, searching for classes of words including, but not limited to superlatives, and/or searching for phrases described. Systems in accordance with many embodiments of the invention may use automated classifications of the speech patterns of highly effective speakers. This may be used to facilitate helpful feedback for purposes of training. Individual users can use search capabilities on their mobile systems. For instance, when Alice asks Bob for his phone number but later forgets it; Alice can then perform a search for words and terms associated with phone calls, including, but not limited to “call”, “number”, “reach you”, and obtain saved portions of the conversation where these occur. The outputs of searches may be in audio form and/or as transcripts. Systems may automatically label and/or record information. For example, a ten-digit number may be classified by the systems to be a phone number, while a nine-digit number may be labeled a potential social security number. Users can perform searches for labels, including, but not limited to “social security number.” Searches of this kind may cause systems to identify and report any utterance and its transcription that matches the pattern, e.g., nine consecutive digits. Additionally or alternatively, systems may include in the search results any sentence in which the term “social security” and/or the abbreviation “SSN” is used. Related terms and/or related phrases may be used, such as “last four” and “social.”

The practical generation of transcripts and the associated attribution of speakers may be used to create activity logs. Activity logs may be used to determine the time of occurrence of specific conversations. Uses for this function may include, but is not limited to establishing patent priority dates. Such logs can be automatically created by user modules, including, but not limited to a mobile device connected to a headset, and a laptop to which the headset is synchronized. Activity logs may be encrypted for purposes of privacy, and the resulting encrypted log entries time-stamped. When encrypted, activity logs may be time-stamped using blockchain technologies. Owners of logs may access log entries, decrypt encrypted log entries using a key known to the log owner, and perform searches on plaintext log entries, each one of which may be associated with at least one time-stamp. Activity logs may include multiple time-stamps, e.g., a first time-stamp provided by the transcription system and a second time-stamp provided by the inclusion of the associated record on a blockchain.

In many embodiments, systems may be used to identify known audio, referring to consistently conveyed audio. Known audio may include but is not limited to songs on the radio, recurring announcements, currently broadcast audio like the audio associated with a soccer game, etc. Known audio may be identified in multiple manners. For example, known audio may be based on detected audio matching FFT profiles associated with such known audio, where the FFT profiles can be stored on the mobile device, and/or where a cloud device can store the FFT profiles and match one or more of these to an FFT from the mobile device. The matching of the input audio to known audio can enable precise enhancement and/or suppression of the audio. In such cases, the known audio can be received (e.g., over a radio connection) and separately enhanced and/or suppressed. The determination of known audio can improve the classification of audio into separate threads. In such cases, one or more threads can be selectively enhanced, suppressed, translated, transcribed, and/or have other transformations performed on them. Other ways of identifying audio can be used, instead of or in addition to FFT-based methods. For example, audio like music can be detected using a series of tones, a characteristic beat, and more, regardless of whether the audio is audible to human ears.

Systems in accordance with many embodiments may receive audio source information from various devices. For instance, some audio source information may come for one or more microphones, a radio, a local storage, and/or from a connected device. Audio data received from differing sources need not be separated from each other. Audio data received from differing sources can be overlaid, presented at different volumes, presented with different priorities, etc. For example, audio data representing songs can have a lower priority than audio data from known speakers, where the presence of the latter may automatically lower the volume of the former, i.e., suppress the song audio data. Similarly, safety announcements and/or announcements related to a change of gates might have higher priority than audio data from a known speaker, whose volume may be reduced a bit and/or played only on one ear of the user.

The separation of audio data into separate threads can allow the processing of each thread of data independently of the other threads. Thread processing in accordance with various embodiments of the invention may include, but is not limited to suppression, enhancement, a time-shifting, replaying, translation and/or other transformation, transcription, recording into a searchable log, the attribution of speakers, the creation of searchable conversations, and more.

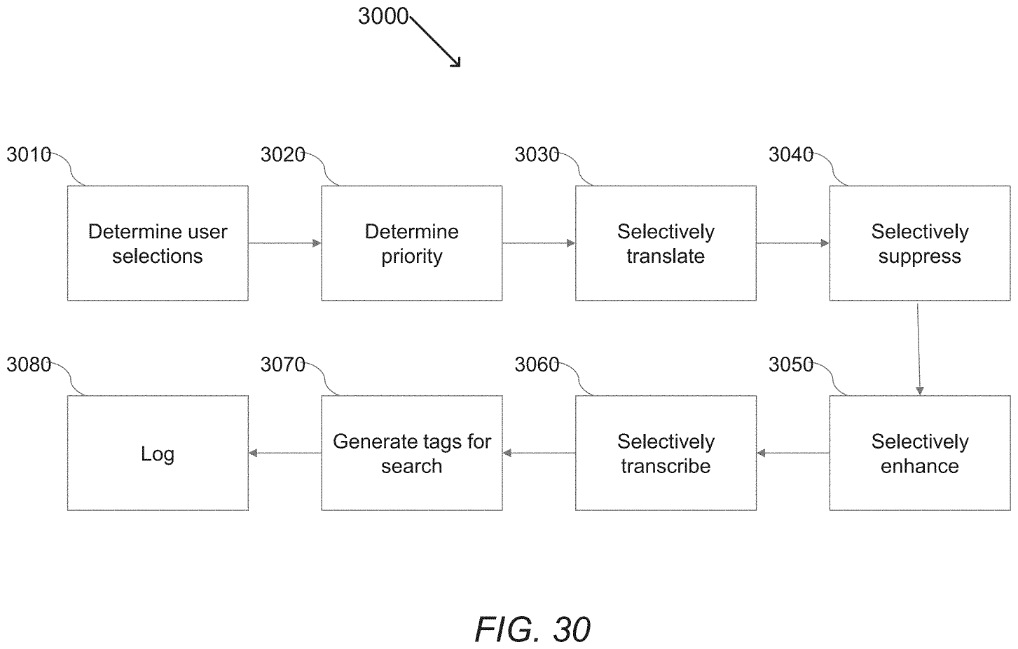

An example transformation process for obtained audio, in accordance with a number of embodiments of the invention, is disclosed in FIG. 30. Process 3000 determines (3010) user selections. User selections may identify, but are not limited to, what sources to suppress and/or enhance, what languages and associated sources to translate, how to determine priority, etc. Process 3000 determines (3020) priority for two or more threads. Process 3000 selectively (3030) translates the obtained audio. The audio resulting from the translation may be generated using a synthetic voice similar to that of the speaker, e.g., matching the approximate timbre of the speaker whose speech is being translated. Process 3000 selectively suppresses (3040) the resulting audio. Selective suppression in accordance with a variety of embodiments of the invention may be performed by, but is not limited to, not presenting signals of some threads and/or only presenting the audio at lower volumes. Process 3000 selectively (3050) enhances the resulting audio. In certain embodiments, selective enhancement may include, but is not limited to, selectively increasing the volume associated with some threads. Process 3000 selectively transcribes (3060) the obtained audio. Selective transcription in accordance with numerous embodiments of the invention may include, but is not limited to, only transcribing some threads and/or only transcribing audio for some selected speakers that may correspond to profiles stored by the user device. Process 3000 generates (3070) tags to facilitate searches for threads. An example tag may be “phone number”, which is a tag that can be added to a thread that contains a likely spoken phone number. Another example tag may be “insult” that can be added to a thread that contains a likely insult. Process 3000 creates (3080) one or more logs corresponding to the transformation. The one or more logs may be at least in part encrypted and/or may be time-stamped. Time-stamping may occur e.g., by submitting one or more logs and/or a function of the one or more logs to a blockchain.

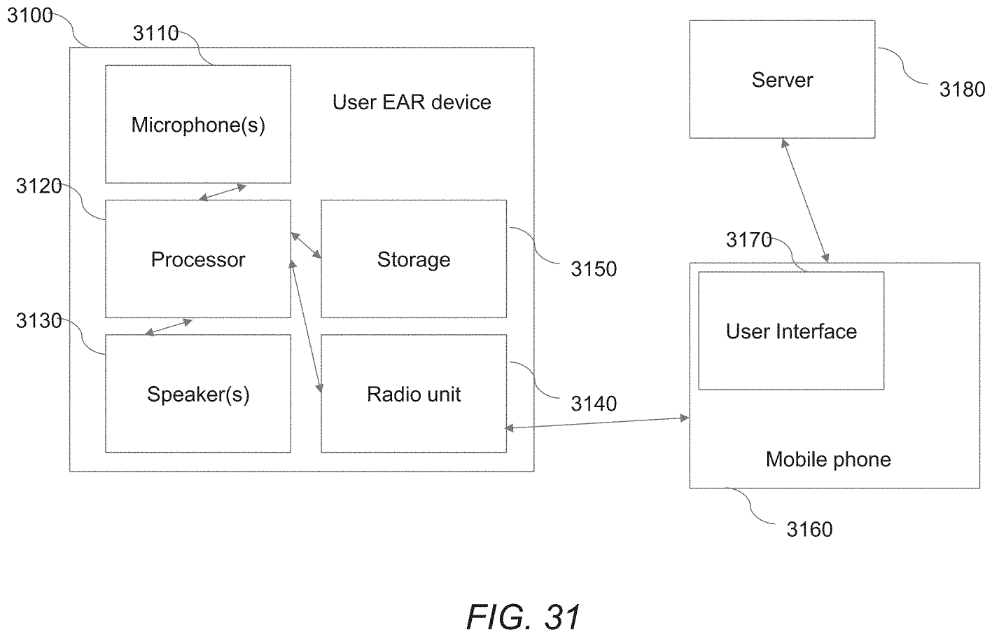

An example hardware configuration, in accordance with some embodiments of the invention, is disclosed in FIG. 31. The hardware configuration may include, but is not limited to, users EAR device 3100 connected to a mobile phone 3160 that in turn is connected to one or more servers 3180 providing services. The user EAR device 3100 may include at least one microphone 3110, at least one processor 3120, at least one speaker 3130, storage 3150 that may be secure storage, and/or at least one radio unit 3140. The speaker 3130 may refer to a standard speaker and/or another audio output entity. The radio unit 3140 may, for example, be a BLE radio unit. The radio unit 3140 may be communicatively coupled to a matching radio unit associated with the mobile phone 3160. The radio unit associated with the mobile phone 3160 may include a user interface 3170 that can be used to make configurations, select and/or modify the volume for different threads, cause a replay of audio information, perform a search, indicate the need for translation, etc. The server 3180 and/or the mobile phone 3160 may perform computing on behalf of the user EAR device 3100. The server 3180 may include records of known audio, and/or perform matches based on received FFT signals. The received FFT signals may be generated by the user EAR device 3100 and/or associated mobile phone 3160.

The associated techniques can be applied to video data, where one video stream is suppressed, enhanced, translated and/or otherwise modified, in manners analogous to the disclosure herein. Thus, it should be understood that the focus on audio data is not a limiting aspect of the disclosed technology. Additionally, the example transformations that can be performed on audio data, whether separated into threads and/or not, are illustrative but non-limiting examples, while many variants and related services can be built on the disclosed building blocks.

Systems and methods directed towards augmenting audio within immersive environments, in accordance with numerous embodiments of the invention, are not limited to use within NFT platforms. Accordingly, it should be appreciated that applications described herein can be implemented outside the context of an NFT platform network architecture and in contexts unrelated to the generation of non-fungible tokens and/or NFTs. Moreover, any of the computer systems described herein with reference to FIGS. 28-31 can be utilized within any of the NFT platforms and/or immersive environment configurations described above.

### D. Immersive Environment Access Right Management

Many embodiments of the invention can associate access rights with determinations of data overlays in relation to images and video. Access rights may be associated with, but are not limited to the ownership status of elements, attributed identity, status level, and/or recognition. Data overlays may refer to the digital data that overlays real-world environments in immersive environments such as AR. For example, users who own specified NFTs and associate their digital wallets with their home addresses may see an AR overlay of an image representing the content of the specified NFT when viewing their home using an AR-capable device associated with the respective wallets.

Participants may create series of related NFTs, each one of which enables their respective holders to generate AR overlays for selected locations. AR overlays may represent information about the participant and limit the access rights to parties outside the participant. A participant, Alice, may transfer one of these NFTs to her friend Bob and another NFT to her colleague Cindy. These NFTs may be configured in a way that they do not permit their owners to transfer the ownership rights to other parties. Alternatively or additionally, the NFTs may become inactive if owned by individuals with identities that do not match particular policy-specified identities. In the earlier example, due to what Alice may have specified by policy, Bob and/or Cindy may not be able to transfer their granted capabilities vis-a-vis Alice to another party, like Dave.

In certain embodiments, AR overlays granted by provided NFTs may grant the current holders, even when not the owners, to have specific capabilities. For instance, a holder may be able to determine where the owner/issuer is located by looking around using the AR-capable device. When looking in the direction Alice is located in, Bob and Cindy may see small icons and/or avatars representing Alice where Alice is determined to be located. The location of owners may be determined by, but are not limited to, depicting the direction of the owner's GPS coordinates that were determined most recently and/or by requesting information about the owner's location to the AR-enhanced device. For example, Bob, may be provided with guidance in his view, including, but not limited to an arrow, what direction to turn to face Alice, and his approximate distance to Alice.

Different NFTs issued by owners may have different and/or context-specific capabilities. For example, the localization capability may be granted to Bob but not to Cindy. Alternatively or additionally, Cindy may only have access rights to the location information of Alice's during office hours. Thus, policies can be associated with the NFT, specifying the access rights as a function of time, location, holder, and other factors. One example factor may be a mode that the owner of the NFTs may set on their device(s). For example, Alice may determine when she is detectable, allowing users granted the right to locate Alice to be able to visualize her location using their AR-enabled devices. Another capability may enable the owner's location to be identified within particular regions with particular resolutions, including, but not limited to within a city and/or state. A corresponding mode may require that the holder is within a certain distance from the owner to use it. Alice may create a policy such that Cindy can listen to a portion and/or all of Alice's music NFT library, by loaning an NFT, for example, when Cindy is within a specific distance of Alice.

In accordance with various embodiments of the invention, AR-renderable collectible artifacts may be implemented. We may refer to NFTs that include AR artifacts of the type disclosed herein as AR NFTs or AR tokens. In many embodiments, artifacts may have, but are not limited to a location, an associated visual and/or audio appearance, and associated access rights. The access rights may be expressed by tokens. One such token may be an NFT issued by a business owner. Artifacts may correspond to data that users with access rights can collect. One such artifact may be an in-game artifact to be used in a game. Another artifact may be an NFT. A third artifact may be a token that represents a discount given to the collector of the artifact. Artifacts may be limited, in which case they may only be collected by a pre-set number of different users with access rights. Examples may include, but are not limited to, the first person to collect the artefact having access, and the first 100 different users to collect it having access. Artifacts may be unlimited, meaning that anybody who collects the artifact receives the rights associated with the artifact. The act of collecting artifact may start with the access right of being able to render them. Access rights to render the artifact may be enabled specifically for certain parties. For instance, rendering may be limited to users within a preset distance of the location at which the business owner specified the artifact to reside, and only when there is a line of sight view of this location from the location of the viewing user.

The access rights associated with AR renderings of artifacts may come from situations and/or tokens unrelated to the issuers of the artifacts. For example, business owners may place and/or use a tool to distribute artifacts in various locations. The business owners may associate access rights for the rendering of the artifacts with possession of the artifacts and/or the ownership of tokens that are not related to the business owner. For example, a business called ACME Adventures may place two artifacts in a city and enable the rendering of these artifacts to any user who possesses a token that is indicative of belonging to a demographic group that is of interest to the business owner. For example, Alice may possess gaming NFTs, which causes her wallet to compute a token that enables Alice access to the AR artifacts. Bob may have an empty digital wallet that nevertheless determined his demographics from his browsing history, and generates a token that qualifies Bob to render the AR artifact on his devices. Cindy's digital wallet may not have qualifying contents and/or events that cause her wallet to generate an entity and/or signal (like a token), that would grant her access to the AR artifact; therefore, these artifacts may not be rendered on Cindy's device.

In various embodiments, the determinations of access rights for AR artifacts may be based on the evaluation of functions that take, as input, data related to digital wallets. For example, a function may be a wallet survey, as disclosed in U.S. Patent Application No. 63/256,597, “Token Surveys and Privacy Control Techniques,” filed Oct. 17, 2021, the disclosure of which is incorporated by reference herein in its entirety. Functions can be based on receipt of anonymized profiles, as disclosed in U.S. patent application Ser. No. 17/806,728, entitled “Systems and Methods for Encrypting and Controlling Access to Encrypted Data Based Upon Immutable Ledgers,” filed Jun. 13, 2022, the disclosure of which is incorporated by reference herein in its entirety. Functions can be based upon identities and/or pseudonyms, as disclosed in U.S. patent application Ser. No. 17/808,264, entitled “Systems and Methods for Token Creation and Management,” filed Jun. 22, 2022, the disclosure of which is incorporated by reference herein in its entirety.

Some artifacts may include conditionally renderable AR objects. In such cases, conditions may be based on access rights associated with, but not limited to ownership, actions, influencing factors and/or configurations associated with user devices. Access rights can be determined at least in part by digital wallets associated with the user devices. Access rights may be determined, at least in part, by service providers serving data related to the artifacts. Related data may include, but is not limited to the location of the artifacts and content associated with the artifacts. Content associated with artifacts may define, among other things, what is rendered by devices to which access rights have been granted.

Some artifacts may enable digital wallets to claim other tokens. For example, users may interact with user interfaces of digital wallets in which AR artifacts are caused to be rendered. In doing so, the users may perform actions that cause collection requests. Artifacts that enable collection may cause transfers of token information to the digital wallets of users requesting the collection. However, some artifacts may be associated with different access rights for rendering than for collection. In such cases, even though the token associated with the artifact has the property of being collectible, it may not be collectible by someone whose access rights may be sufficient for rendering but not collecting.

Other actions can be associated with AR artifacts, including, but not limited to the capability for artifacts to be modified by parties with sufficient access rights for modification. Thus, artifacts may be associated with a vector of access rights, where each element of the vector may specify the properties digital wallets must be associated with to be granted access of a given type.

Systems and methods in accordance with many embodiments of the invention may facilitate the rapid creation of AR-based games. The creation of such games may be carefully engineered to allow selective capabilities to users with pre-specified properties. Pre-specified properties may be expressed by memberships of the type that can be assigned using the distribution of NFTs. Pre-specified properties may depend on the general contents of the wallets associated with users, and the actions performed on these wallets and/or associated applications including, but not limited to browsers. Thus, users with particular browsing histories, demographic profiles, and/or a given NFT ownership profiles can be assigned capabilities in games designed by a game creator.

In accordance with a number of embodiments, capabilities may be assigned based on membership. One type of membership may be to be signed up for a game. Another type may be one granted by the possession of a particular in-game accomplishment, item, and/or skill. For example, capabilities may be conferred for in-game purchases to acquire a magic shield. Such purchases may be expressed as tokens, including, but not limited to NFTs. Capabilities may be assigned by creators based upon individuals' levels of recognition, as described in U.S. Patent Application No. 63/257,133, entitled “Characteristic Assignment to Identities with Tokens,” filed Oct. 19, 2021, the disclosure of which is incorporated by reference herein in its entirety. Games may be governed by one or more sets of policies and/or one or more sets of artifacts. Such policies and artifacts may be accessed by digital wallets from servers that provide real-time feedback. Real-time feedback may be used to, but are not limited to, unlock capabilities and tokens, convey promotional material including, but not limited to advertisements and coupons, and gift NFTs to users based on their in-game achievements. Games can be rapidly created based on various constructs and services, and may enable third party service providers (e.g., cafes) to advertise to game players by purchasing promotional content. Promotional content may include, but are not limited to NFTs and AR artifacts, which may be expressed as NFTs, and be advertised to players via the servers configured by the game creator. In such cases, third party service providers may act as advertisers as disclosed in U.S. patent application Ser. No. 17/808,264, entitled “Systems and Methods for Token Creation and Management,” filed Jun. 22, 2022, the disclosure of which is incorporated by reference herein in its entirety. Additionally, game creators may obtain a payment in response to conversions, where a conversion may correspond to the collection, by a game player, of an NFT that confers him a discount at the café. Alternatively or additionally, conversions in this context may be tied to using said coupon at the third-party service provider's establishment, and/or just to view the AR artifact sponsored by the third-party service provider. An example artifact sponsored by a third-party service provider may include, but is not limited to, a visual representation of the cafe and/or its logo. Using such AR advertisements, every village may include billboards being sponsored by local businesses on a user-by-user basis, as determined by matches between user profiles and templates specified by advertisers.

In various embodiments, tokens may be associated with geographical areas. For example a token, e.g., an NFT, may be associated with a portion of a sidewalk at the intersection between two roads. Content associated with the NFT may be viewed by users that possess the NFT and are in the associated area. The NFT may specify where the content is to be displayed. For example, the NFT may disclose the location of the associated area relative to markers and/or landmarks, including, but not limited to on the wall between two QR codes posted in two shop windows, and/or overlaid on a sign that specifies the direction to downtown. The specifications made by the NFT may include, but are not limited to data, an executable script, and one or more geolocations. For example, specifications may be determined by GPS data and refined by triangulation between beacons like WiFi hotspots, when present. The rendering of the content may depend on the direction of the viewing party. For example, rendering may be determined by a compass sensor associated with a headset and/or other mobile devices. Tokens associated with geographical areas may be located by anybody with access to the data of the NFT, which may be public. Such tokens may be referred to as publicly locatable tokens. The selection of what content to display (e.g., what publicly locatable tokens access), may be determined by user selection. For directions, content may be selected and configured based on the direction; one configuration may be the direction of an arrow, a time indicator, and/or a distance indicator.

In various embodiments, content data may be limited to users whose devices present geolocations corresponding to locations associated with NFTs. Such geolocation data may include, but is not limited to, the same type of information specifying how the content is to be displayed, including from what angles it can be viewed and what it looks like from such angles. However, geolocation data may not be accessible to parties reading the NFT data. Content data may be encrypted using keys that are only known to privileged users. Content data may be physically distinct from the NFT data. The associated geographical areas may be known and/or possible to determine by service providers. For example, service providers may have access to GPS coordinates and/or location data, including, but not limited to information locating the display locations relative to fixpoints. An example service provider may be a game server. Tokens of this type may be referred to as hidden-location tokens, since the locations can be hidden from the public.

Service providers may share information with user devices. Specifically, service providers may receive feeds of location information from user devices. For example, service providers may be sent location information when users activate an application including, but not limited to a game application, and/or when users activate and select to overlay AR applications. Service providers may provide information to user devices, including, but not limited to hints, directions, and/or instructions to modify the display of publicly locatable tokens. For example, publicly locatable tokens may be modified based on sponsorship information, user preferences, the time of the day, and/or special events, such as St. Patrick's Day. Service providers may select what publicly locatable tokens should be made visible to the user. For example, visibility may be based on user context and/or objectives. For example, a first user's objective may be to play game 1, whereas a second user's objective may be to find a public restroom that is clean. In interacting with the users, the service provider may have locations of all public restrooms in the area, and receive feeds of data, including data from AR headsets, indicating what bathrooms are clean.

In various embodiments, AR images may be displayed in 3D. In some examples, displays may be seen through using AR goggles with stereo vision. Independently of whether the viewing device enables stereo vision, AR overlays may be created with realistic shadows. In such cases, shadows may be based on, but are not limited to the lighting situation in the image into which they are rendered, and directional manners that cause different views of AR images from different angles, e.g., based on the compass and gravity sensors associated with the viewing device. Information about rendering may be included in scripts governing how the rendering can be performed. Scripts may govern rendering based on, but not limited to lighting, angle of viewing, speed of approach, etc. For example, warning signs may be rendered larger and in brighter colors if users travels at a high speed than if they travel at a low speed. Location and rendering perspectives may be based on anchor elements, including, but not limited to QR codes, street signs, relative to the position of windows, etc. Data affecting the rendering based on detected features may be included in a token, e.g., as part of the content. Thus, content can include information about what to render, such as a cartoon duck and a stop sign, as well as the geographic location, the rendering perspective data, and conditions including, but not limited to whether the data is rendered and/or not at a given speed.

In various embodiments, property owners may control the rendering of AR images. Example property owners may include, but are not limited to an owner of a storefront business and/or a residence. The rendering of the content may be controlled in a way that is directly associated with the property, including but not limited to at what times AR overlays are rendered, who can select AR overlays to be rendered on the property, what types of memberships users may need to be able to render overlays, and the types of overlays. Examples of types of overlays may include, but are not limited to overlays that are for purposes of providing directions; for purposes of providing endorsements or recommendations, e.g., related to the grocery store; for purposes of entertainment, e.g., gaming; for purposes of displaying artworks, etc. Such rules can be expressed in AR rendering rights tokens to control their rendering. AR rendering rights tokens may be provided separately to AR NFTs. They may be associated with AR NFTs. For example, AR NFTs may be referenced by AR rendering rights tokens, as a way to provide rights to render to select AR NFTs. Such identification may be based on public keys and/or other identifiers associated with the AR NFTs, of types of content as described above, etc. Rendering devices and/or associated computational entities may determine, based on one or more AR rendering rights tokens, whether AR NFTs may be rendered for a given user, e.g., as associated with this user's wallet and/or rendering device. Example associated computational entities may include, but are not limited to gateways and/or mobile phones.

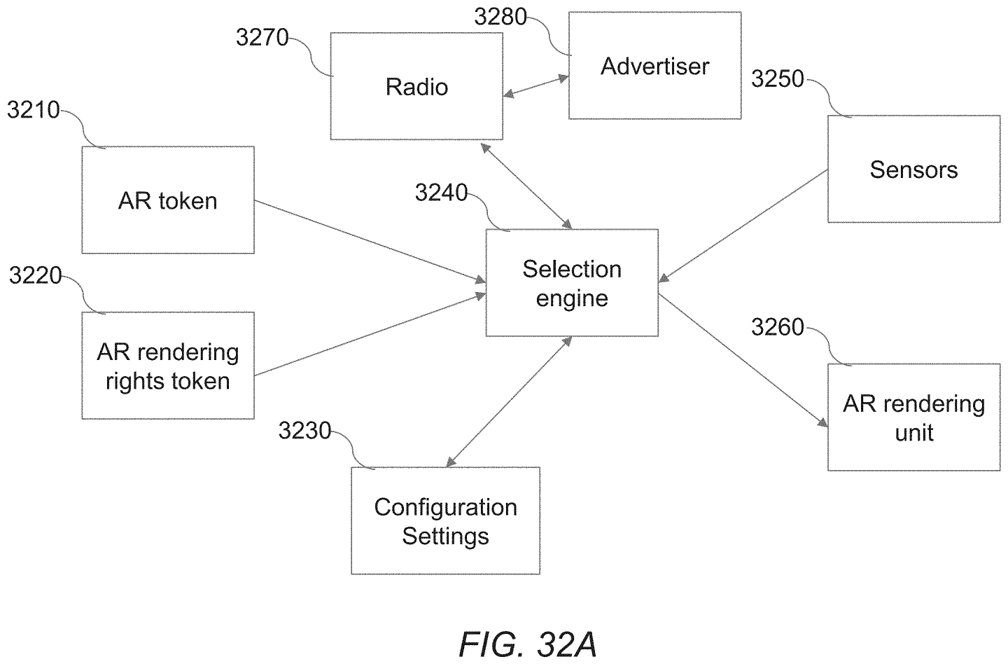

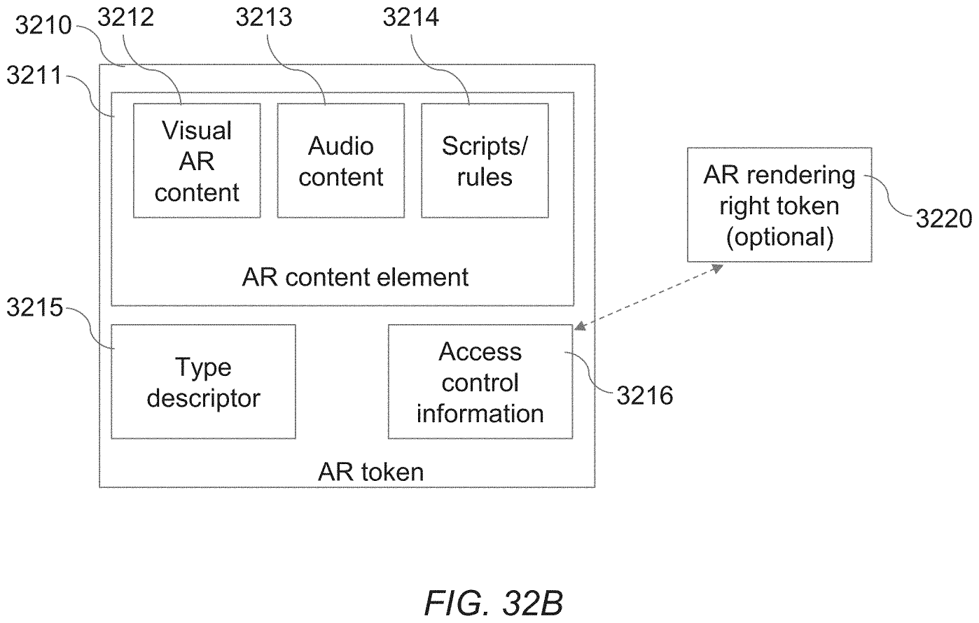

An example configuration of sample systems of AR content, in accordance with several embodiments of the invention, is illustrated in FIG. 32A. Systems may include an AR token 3210, an AR rendering rights token 3220, configuration and settings 3230, a selection engine 3240 connected to sensors 3250, an AR rendering unit 3260, and radio 3270. Radio 3270 may be connected to an Advertiser 3280. The AR token 3210 may be selected to be rendered on the AR rendering unit 3260 by selection engine 3240. The rendering of the AR token 3210 may be based on one or more of the AR rendering rights token 3220 and configuration and settings 3230. For example, the rendering may take place when the AR rendering rights token 3220 indicates that the owner allows rendering of the AR token 3210, and/or subject to the configurations and settings 3230 of the user device. The determination that the AR token 3210 can be rendered may depend on the mode of operation, the settings, and/or the current objectives of users. For example, an objective of users may be to reach a destination in time for a scheduled meeting. The Advertiser 3280 may be connected to the selection engine 3240 via radio 3270. Advertiser 3280 may provide indications of AR content to render, including but not limited to the AR token 3210. Rendering may be determined based on inputs from sensors 3250, including but not limited to location sensors, camera, compass, etc. Example location sensors may include, but are not limited to GPS sensors, motion sensors that can be used to augment GPS data, WiFi data, and Bluetooth data. Radios 3270 may function as location sensors when data may be indicative of a location. AR data may be rendered along with other visual data on AR rendering unit 3260. The AR rendering unit 3260 may include multiple entities, including but not limited to, a screen and a headset.

An AR token configuration, in accordance with a number of embodiments of the invention, is disclosed in FIG. 32B. An AR token 3210 may include, but is not limited to, an AR content element 3211, a type descriptor 3215, and access control information 3216. The AR content element 3211 may include a visual AR component 3212. The visual AR component 3212 may include, but is not limited to, images, visual models, video clips, vector graphics, etc. The AR content element 3211 may include audio content 3213. Audio content 3213 may include, but is not limited to sound effects and voice data associated with an avatar and/or other display element associated with the visual AR component 3212. The AR content element 3211 may include and scripts and rules 3214, which govern how to render the visual AR component 3212 and/or audio content 3213. The scripts and rules 3214 may include references to code libraries, API call information, and rules related to when and how content is rendered. One example rule may describe the orientation of an element relative to the background, based on an angle of viewing as determined by a compass sensor input. Another example rule may describe when an avatar can perform an action, based on information from sensors, including camera input, microphone input, and/or sensors used to determine the focus of the user associated with the AR display unit. The type descriptor 3215 may specify types of content, including, but not limited to “animated character”, “guidance”, “gaming”, “user warning”, etc. Access control information 3216 may include, but is not limited to, information identifying the membership necessary to enable rendering, what user settings are required, etc. Access control information 3216 may be governed by external rule sets, including, but not limited to those provided in the AR rendering right token 3220. AR rendering right tokens in accordance with certain embodiments of the invention may specify rights to render AR elements of different types, including, but not limited to AR elements identified by type descriptors. Rights may be dependent on the time of the day, such as events including, but not limited to a funeral procession, art festival, etc. AR rendering right tokens may be generated by a property owner of a mall, store, residence, and/or by a home owner association, local government, etc. In numerous embodiments, multiple AR rendering right tokens may be used to determine rights to render concurrently.

Access control related to AR tokens may be governed by AR rendering right tokens, as well as by service providers, including, but not limited to game service providers. The service providers may determine what users, on what devices, can render what AR content. Rendering rights in accordance with various embodiments of the invention may be based on context, including, but not limited to the user objectives. One objective may be to play a game, while another is to quickly find a cafe before the rain starts. This can affect what AR artifacts are rendered. Access control may depend on membership, ownership, and user settings.

In various embodiments, at least some AR data, including but not limited to AR rendering right tokens and AR tokens, can be streamed to users. For example, AR data may be streamed based on requests by the user, where the requests include geographic location information. In some embodiments, at least some AR data can be pre-loaded. In some embodiments, at least some downloaded AR data may be encrypted, with associated keys provided to users in real-time based on the triggering of events. Triggering events may include, but not limited to the arrival at a specified location, a particular time of the day, and/or a required user device state. Alternatively or additionally, access may be controlled by mobile devices with DRM capabilities, wherein such devices determine whether a given AR content element can be rendered at a given time by the one or more connected AR viewing devices, e.g., headsets or glasses. These determinations may be based on one or more rules.

In a number of embodiments, the rendering of AR elements may be based on contextual information associated with the scene in which it could be placed. For example, a given scene may include an intersection of two roads. An AR element corresponding to a cartoon duck may be rendered as crossing the street, but only when it is safe for the viewer to cross the street. An obstacle including, but not limited to a boom may be rendered in front of the viewer when it is not safe to cross. This may occur when the lights are red and/or a vehicle is approaching. In certain embodiments, the determination of what to render, and when, may be based on collaborative efforts. For example, rendering may be based on two or more players whose mobile devices exchange signals to convey state and location, thereby allowing a game to be played by these two or more players in which their presence and actions are used to select what AR elements to render, and how.

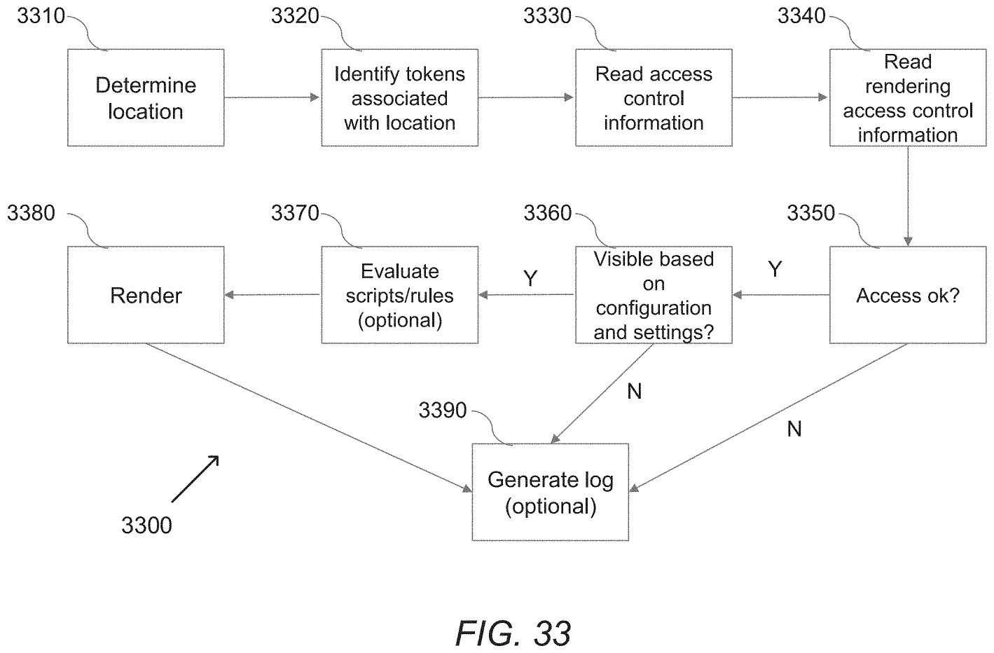

An example process, performed by a selection engine in accordance with a number of embodiments of the invention, to determine the content to be rendered is illustrated in FIG. 33. Process 3300 determines (3310) a location based on sensor inputs. Sensor inputs may include, but are not limited to GPS signals; detection of fixpoints such as known hotspots; detection of other mobile entities such as using Bluetooth detection; signals from accelerometers and compass, etc. Process 3300 identifies (3320), one or more tokens associated with the determined location. For example, identification may be based on being within a threshold distance specified by the token and/or being associated with a location that is likely viewable by the camera(s) associated with the rendering device. Process 3300 reads (3330) access control information from the identified tokens. Process 3300 reads (3340) rendering rights information from rendering rights tokens associated with the location, when applicable. Process 3300 determines (3350) whether access to the AR information and associated rendering should be granted. For example, access may be based on the access control information and the rendering rights token. When access is not permissible, the process 3300 may optionally log (3390) those actions. Logging may include, but is not limited to, making note of the actions taken. For example, an action may be the rendering of a given AR element, including, but not limited to a warning and/or a direction. When access is permissible, process 3300 determines (3360), whether there is an AR element to which access is allowed should be visible based on configurations/settings. When there is not an AR element for which access is determined to be visible, process 3300 may optionally log (3390) those actions. When there is an AR element for which access is determined to be visible, process 3300 evaluates (3370) scripts and rules. Scripts and rules may be used to determine how the AR element can be rendered, e.g., angle of rendering. Process 3300 renders (3380), the AR element defined by the visual AR content and/or the associated audio content. Rendering (3380) content may include, but is not limited to, plating it. In step (3390) process 3300 may optionally log (3390) those actions.

In various embodiments, AR content may be promotional content. For example, AR content may involve the recommendation of local businesses. AR content may be selected using techniques including, but not limited to those described in U.S. patent application Ser. No. 17/806,728, entitled “Systems and Methods for Encrypting and Controlling Access to Encrypted Data Based Upon Immutable Ledgers,” filed Jun. 13, 2022, the disclosure of which is incorporated by reference herein in its entirety. An example promotional AR element may be, but is not limited to, an avatar and/or live-looking person corresponding to a famous actor. Promotional AR elements may be used to endorse products that brands have paid to be rendered to selected users. These products, for example, may be displayed outside stores that sell the product, to users whose demographics, as determined by the digital wallet, match a template that is set by the advertiser. In such cases, AR elements may be in the form of famous actors, following users around in stores, and making recommendations corresponding to endorsements paid for by one or more brands. The AR experiences can include, but are not limited to visual aspects, sound aspects, and script aspects. AR experiences may therefore be in the form of integrating the experience with the context. For example, when the viewer of AR product placement is distracted by a person asking them a question, the AR experience may be temporarily stopped, with the avatar and/or actor ceasing to talk, taking a step away, and/or being rendered as standing behind the person asking the question.

In certain embodiments, personal concierges can be created to cause the rendering of personal assistants on AR-enabled rendering devices. Systems in accordance with such embodiments may provide audio associated with the personal assistant to users associated with the rendering device. Systems may receive user input, including, but not limited to voice commands provided using a microphone associated with the AR-enabled rendering device. Personal concierges may be associated with a specific property, including, but not limited to stores sponsoring the personal concierge service, malls, office parks, tour guide services, etc. Personal concierges can be associated with users. For example, a concierge may be a purchased service. Concierge services may be provided free of charge by companies wishing to provide recommendations to users, including promotional content that may be highlighted by the concierges. Users may request guidance from the concierges, who may then guide them through physical spaces. For example, a personal concierge may provide guidance in an area like a grocery store, and help users select products that match a need, e.g., groceries that correspond to a shopping list. When the users indicate that avocados should be ripe, the concierge may provide instructions of how to identify ripe avocados. In several embodiments, personal concierges may suggest alternatives. Concierge suggestions may be in response to specific determinations. For example, a side dish involving a promoted guacamole product may be suggested as an alternative to the avocados, should it be determined that the avocados were not ripe enough to be suitable. In some embodiments, AR rendering sets, having sensors including, but not limited to cameras and microphones, can automatically determine what products users interact with. For instance, personal concierges may take note of the items users place in a shopping cart, and determine the cost of these. Personal concierges can be used for an automated checkout feature in which a preferred payment form is automatically used to pay for the groceries as users leave the store.

Systems and techniques directed towards rendering augmented content, in accordance with numerous embodiments of the invention, are not limited to use within NFT platforms. Accordingly, it should be appreciated that applications described herein can be implemented outside the context of an NFT platform network architecture and in contexts unrelated to the generation of non-fungible tokens and/or NFTs. Moreover, any of the computer systems described herein with reference to FIGS. 32-33 can be utilized within any of the NFT platforms and/or immersive environment configurations described above.

### E. Immersive Environment Access Limitations

Several embodiments of the invention may be used to enable controlled uses of AR. Controls for such uses may be based on, but not limited to, the properties of, the functionality of, the perception of, and the origination of AR content, among other things. For example, AR content may be associated with one or more types. One such type may be for purposes of directional guidance, and used with AR rendering technology to provide step-by-step routing for drivers, bicyclists, pedestrians, commuters, delivery agents, etc. Another type may be to provide alerts and warnings. For example, warnings can be used to notify drivers of conditions including, but not limited to, that they are speeding, that there is an icy patch on the road coming up, that there is a portion of the road with missing guardrails, etc. A third type can relate to entertainment, e.g., to enable AR games.

AR technologies may be anchored in locations, reference objects, and/or experiences. AR technology anchored in specific locations may make AR objects appear in the specific locations. For example, a promotional anime character may beckon customers to enter a store associated with the anime character. In another example, a character may indicate a restaurant rating that is available, to users who selects to see it, on the facade of the restaurant. In a variety of embodiments, AR technology may be anchored on reference objects. Following the earlier example, AR objects may be overlaid on signs and menus. In some contexts, the location of the signs and/or menus may not be relevant, and the focus may be on what they say. For example, one type of AR tool may relate to translation services, e.g., enabling an American tourist in South Korea to read signs, menus, and product descriptions, by having them automatically translated from Korean to English. One way to process such information may use optical character recognition (OCR). Another way may use processes in which camera images are matched to a database of previously recorded camera images and/or characterizations of such. A characterization example may involve the detection of a collection of fixpoints that match the recorded collection of fixpoints of an image. When AR technology is anchored in experiences, it may relate to events, but not be specific to locations and/or reference objects. For example, AR technology may be anchored to an event like users speeding, thereby causing a warning to be rendered to the users. Similarly, a pedestrian about to step out in a road where oncoming traffic may be warned and informed where to find a crosswalk. In these examples, the AR experience can be tied to the activity and/or context of the users. AR events in accordance with some embodiments of the invention may be anchored to many anchors. Users may be warned of a situation (an experience-based anchor) and told where to find a solution (a location-based anchor). Anchoring may be performed by identifying the presence of one or more QR codes that signal orientation and content. Such identification may be performed by AV rendering devices and/or associated computational entities like mobile phones. Anchoring may be performed by determining the meaning of visual environments. For example, determinations can happen by identifying the face of a person and rendering cat ears on their face.

AR content in accordance with certain embodiments of the invention may be filtered based on provenance, allowing the origination of AR content to influence the use of it. For example, the origination of the AR content may be used for, but not limited to determining what users may be interested in the content; what users may find the content trustworthy; and whether content is associated with a known abusive source. One way to show the association between provenance and content may be to distribute and process AR content in the form of authenticated records showing their origin. The records may state the type of and the anchors of the content. One type of authentication method may be the use of a digital signature. The digital signature may be tied to an identity, of the content originator and/or of an authority that vouches for the identity of the originator.

Record that can be used to distribute and process AR content can be tokens. One such type of token may be NFTs. As such, the records containing AR content may be referred to AR NFTs. However, many of the disclosed techniques are not specific to NFTs, but apply equally to other types of tokens, and to digitally signed records, which can be stored and distributed without the use of blockchain technology.

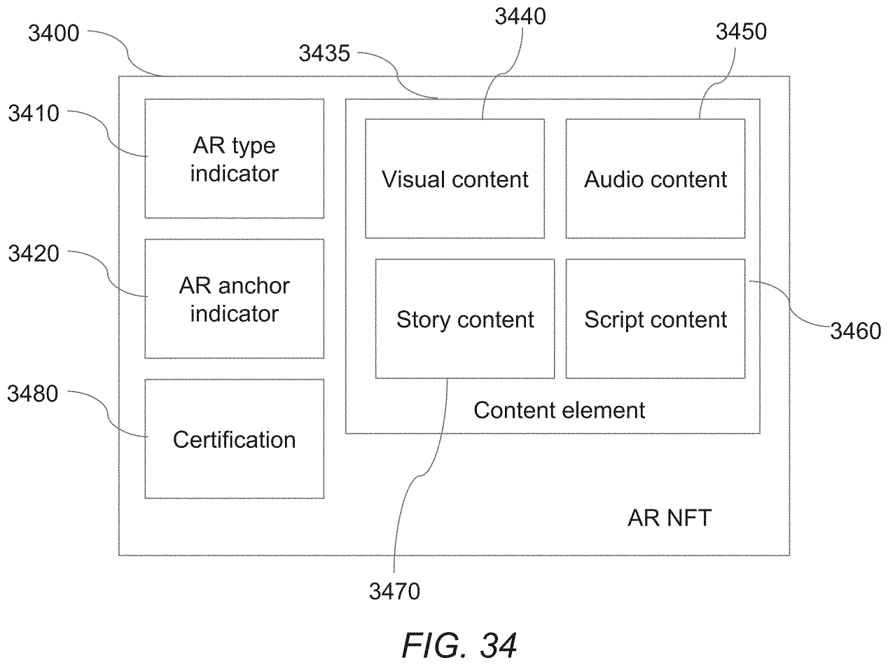

An implementation of an augmented reality (AR) non-fungible token (NFT), in accordance with some embodiments of the invention, is disclosed in FIG. 34. The AR NFT may include, but is not limited to an AR type indicator 3410, an AR anchor indicator 3420, a content element 3430, and a certification 3480. The AR type indicator 3410 may determine a classification of the content element 3430. For example, the AR type indicator 3410 may indicate that the content element 3430 corresponds to entertainment, to promotional content, to directions, to security warnings, etc. More than one type of classification may be possible. The AR anchor indicator 3420 can indicate one or more anchors on which rendering location and rendering perspective may be based, including, but not limited to physical location, a reference object, and the AR experience. The content element 3430 may include one or more of visual content 3440, audio content 3450, script content 3460, and story content 3470. Examples of visual content 3440 may be an image, a video, and graphic models used for rendering of objects with a 3D appearance. Examples of audio content 3450 may be voice data, sound effects, and music. Examples of script content 3460 may be executable content that determines how to combine visual content 3440, audio content 3450 and/or story content 3470. Script content 3460 may, for example, be based on sensor input data. An example of story content 3470 may be one or more texts that are used to create dialogue, e.g., for an avatar. The story content 3470 may refer to audio content 3450 associated with the AR NFT 3400. The story content 3470 may refer to voice profiles used for multiple AR NFT elements. The story content 3470 may be stored external to the AR NFT 3400, including but not limited to, on a separate blockchain entry. Certification 3480 for an AR NFT may certify that the content element 3430 corresponds to the type indicated by the AR type indicator 3410 and AR anchor indicator 3420. Certification 3480 may include a digital signature on the AR type indicator 3410, the AR anchor indicator 3420, and/or the content element 3430. Certification 3480 may indicate that the content element 3430 does not violate any policy referenced by the certification 3480.

The determination of whether AR content should be rendered, and how, may be determined by scripts associated with visual and/or audio content. The scripts may be part of the content and/or referenced by the content. Scripts may, for example, determine whether a visual element is a sign that should be translated, and/or whether user actions (including, but not limited to entering the roadway) is unsafe, and therefore should trigger AR-based warnings.

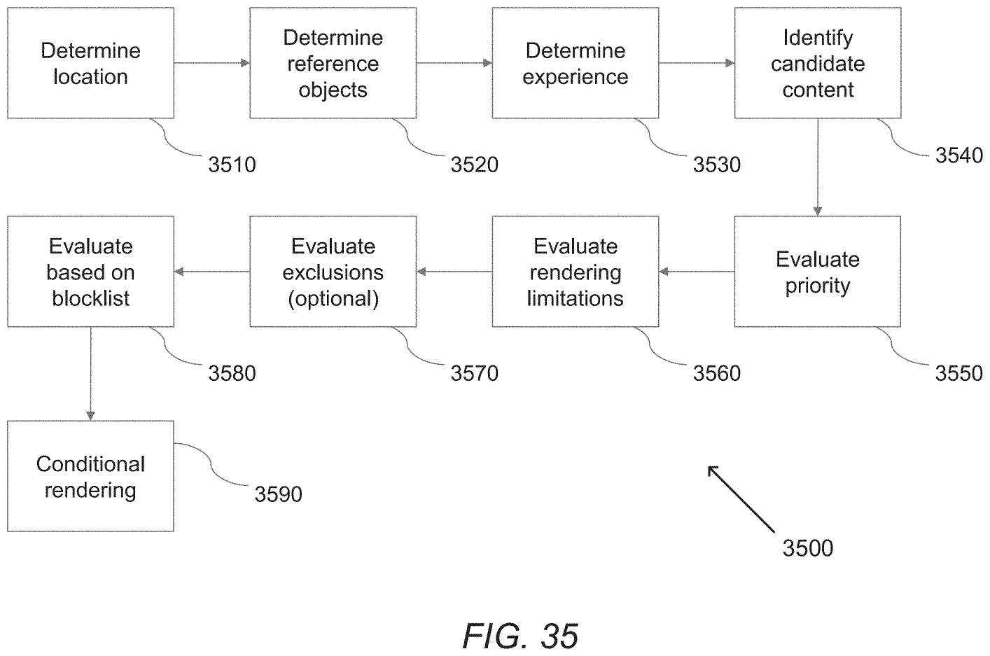

In accordance with some embodiments of the invention, a process for determining what AR content to render is illustrated in FIG. 35. Process 3500 determines (3510) a location based on location data. Location data may include, but is not limited to GPS location data, WiFi hotspot data, cell signal data, reported user data, and consistency verifications. Location data in accordance with various embodiments of the invention may be based on camera data, user action data, and historical location data. Process 3500 determines (3520) potential reference objects. Reference objects may include, but are not limited to, QR codes and/or pre-specified objects associated with the location determined in (3510). Process 3500 identifies (3530) user experience. In numerous embodiments, user experiences may include, but are not limited to, the active involvement in an activity, a tentative action like crossing a road, one or more applications that the user is receiving audio-visual data from, and recent user interactions with a user interface, e.g., voice commands received by a microphone. Process 3500 identifies (3540) candidate content based on at least one of the determined locations, determined reference objects, and a determined experience. Candidate content may correspond to one or more AR NFTs that are available to the user device. The user device may refer to a mobile device including, but not limited to a smartphone, a wearable computer, an AR rendering headset, and/or a combination of such devices and/or units. Process 3500 makes (3550) a priority assessment based on, but not limited to, user activity, the determined experience, and potential risks. Potential risks may be derived as assessed based on the determined location. The priority evaluation for a particular user may involve placing some content on a waitlist, to be considered later on. The placement may be based on the content not having a priority value that exceeds a threshold associated with the user, the user activity, and/or potential risks associated with the user. Process 3500 evaluates (3560) rendering limitations, the possible components of which are elaborated on below. Evaluating (3560) rendering limitations may cause some of the candidate content identified in (3540) to be no longer considered for rendering. The determination to no longer consider candidate content for rendering may be based on the limiting entity being an authority whose limitations are applied to the user device; the certificate being valid; the geographic descriptor matching the location determined in (3510); and/or the rendering limitation matching the candidate content, e.g., AR NFT. Process 3500 evaluates (3570) exclusion data. In evaluating (3570) exclusion data, process 3500 determines whether exclusion data matches the context of the user device. The context of user devices may be based on reference objects determined in (3520) that may suggest a particular user's location. For example, the determined reference objects may indicate that the particular user is indoors while rendering limitation only applies outdoors. Process 3500 evaluates (3580) blocklist data for AR content that has not been disabled and/or removed as a result of the evaluations of (3550), (3560), and (3570). The blocklist data may at least in part be downloaded on the user device and/or reside on a database, such as a blockchain. Process 3500 performs (3590) a conditional rendering. The conditional rendering may be configured based on evaluations performed in (3550), (3560), and (3570). The conditional rendering may be affected in ways including, but not limited to size and brightness of objects and the volume of audio. For example, a high-priority AR element may be rendered larger, brighter and with a higher volume, whereas a lower-priority AR element can be smaller, less bright, and with a lower volume. Some AR elements may not be rendered at all under a conditional rendering. In accordance with various embodiments of the invention, steps of process 3500 may follow an alternative ordering. For example, process 3500 may reduce the expected computational workload based on recent assessments of content, location, activities, etc.

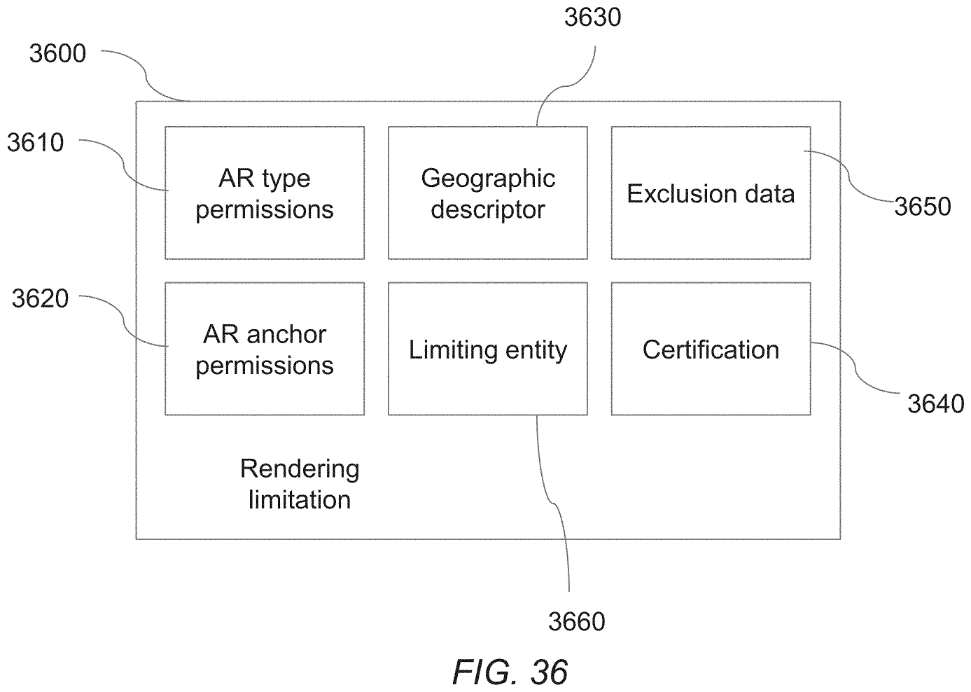

An example of a configuration of rendering limitations, in accordance with a number of embodiments of the invention, is illustrated in FIG. 36. Rendering limitations 3600 may include one or more AR type permissions 3610. AR type permissions 3610 may specify both allowed and disallowed types of content. AR type permissions 3610 may match the classifications of the AR type indicator. Rendering limitations 3600 may include one or more AR anchor permissions 3620, which may specify both allowed and disallowed anchors. The one or more AR anchor permissions 3620 may match the indications made by an AR anchor indicator. Rendering limitations 3600 may include a geographic descriptor 3630, which may specify a geographic area, region near a beacon, region near another NFT and/or specific users, and/or indications of whether the rendering limitation 3600 applies indoors, outdoors, in a first room, in a second room, etc. The geographic area may be defined by a lack of an object, NFT, user, etc. Rendering limitations 3600 may include exclusion data 3650, which may specify that the rendering limitation 3600 does not apply to users with a specified membership and/or token ownership. Exclusion data may indicate that the rendering limitation 3600 does not apply during certain parts of the day. Limiting entity 3660 can refer to, but is not limited to, the creator of the rendering limitation 3600. Creators may include, but are not limited to, property owners, homeowners' associations, and a local government. Certification 3640 can include a digital signature on AR type permissions 3610, AR anchor permissions 3620, geographic descriptor 3630, exclusion data 3650, and/or the limiting entity 3660. Certification 3640 may be generated by a certificate authority. Certification 3640 may be generated in response to verifying claims, receiving a staked amount to back the validity of the certified data, etc.

The possibility of AR abuses may encourage additional protective actions to rendering limitations. One form of abuse may be to cause a crowd of people to travel to a location associated with a victim. In such cases, an otherwise peaceful street can be suddenly inundated with thousands of people, and/or a neighborhood grocery store that is suddenly filled with hundreds of AR set wielding users with no interest in buying groceries. Another form of abuse may be to overlay a building, e.g., a restaurant and/or a residence, with AR graffiti. AR graffiti may include, but is not limited to, content insulting, slandering and/or otherwise harassing a victim associated with the building. Many forms of abuse can relate to a location of a victim, and therefore use location-based AR.

However, abuse may not be limited to location-based AR. For example, abusive forms of AR may induce changes including but not limited to, the incorrect translation of signs, the rendering of negative reviews on a menu of a competitor of the abuser, and/or the rendering of warts on the faces of everybody entering a store associated with a victim of the abuser. Such abuse may be based on anchoring, e.g., to store facades, menus and/or the face of a person.

Similarly, abuse can relate to experience anchors. Such abuse may encourage risky and/or rude behavior, for example. Specifically, incentives may otherwise cause AR viewers to perform actions that are undesirable in their surroundings. Several examples of abuse may reward particular negative actions and/or discourage positive actions.

In many embodiments, users may report AR content as being abusive, illegal, and/or otherwise undesirable. Content may be reported by using a user interface associated with the AR rendering device. Reports may be transmitted to an entity that generates signatures for the abusive content. Signatures may be made up of sequences of bits that are likely to be unique to the element from which they are generated from. After an analysis has been performed on a reported AR a signature may be used to identify content including, but not limited to, the AR NFT, content associated with the AR NFT, the originator of the AR NFT, etc. Such signatures can be distributed to entities including, but not limited to wallets, rendering devices, search engines, hosting services, etc. The signatures may therefore be used for purposes of suppressing the associated content. Example analytics may include, but are not limited to human review of reports, human-aided review of AR NFTs, and statistical analysis of the identity and reputation of the reporter. High reputations may be associated with reporters that report known risks as risks, and which appear to be aligned with other users with high reputations. Examples of how blocking may be performed are disclosed in U.S. Patent Application No. 63/283,330, entitled “Ownership-Based Limitations of Content Access,” filed Nov. 26, 2021, the disclosure of which is incorporated by reference herein in its entirety.

In various embodiments, service providers may analyze AR NFTs in the context of emulators (also referred to here as emulation environments). Emulators may be used to simulate features of environments, including but not limited to, location, actions, view, etc. in order to determine whether the simulation triggers an undesirable AR rendering. The stimuli for the emulator may be received, for example, from real devices that live-stream at least some of sensor data to a simulator. The emulators may assess the risk of the sensor data. Once undesirable renderings have been confirmed, the emulators may be used to generate defensive actions, including, but not limited to blocking and generating signatures, as described above. These actions may be performed in response to reports of abuse.

Signatures used to indicate undesirable content can be initiated in various ways. Systems and methods in accordance with some embodiments of the invention may use signatures in a comparative manner to anti-virus. Systems in accordance with a number of embodiments of the invention may have signatures encoded in probabilistic storage structures, including, but not limited to Bloom filters, a form of hash filter with probabilistic storage assurance. Probabilistic structures may enable the efficient distribution of larger blocklists in forms that have a low probability of false positives but no risk for false negatives. To determine whether apparent positives are true positives, filters can perform online lookups before determining whether associated AR content is permissible.

In many embodiments, mobile devices capable of rendering AR content can include emulation environments. The emulation environments may be used to real data received from the sensors associated with the AR rendering device and selectively modify the sensor data. The emulation environments may thereby determine whether given AR NFTs pose potential risks. For example, an emulator may simulate the rapid approach of a large truck to determine whether an AR NFT content responds in a way that protects the user. When the AR NFT is confirmed to not protect the user and/or responds in a way that increases the threat in the simulated environment, the AR NFT may be automatically reported by the emulator. Alternatively or additionally, the rendering of the associated content may be locally blocked and/or disrupted.

In some embodiments, one or more prioritizations may be performed when one or more AR content elements are determined to be permissible to render. Prioritizations may be used to determine which AR content elements have higher priority. This may correspond, for example, to safety-related AR content rendering that indicates that it is not safe to cross the street being compared to a happy woodpecker anime character that advertises a nearby café. In another example, a driving direction may indicate that users should change lanes while a historical marker indicates that a driver is approaching a famous battlefield. In these examples, the lower-priority AR element, i.e., the happy woodpecker and the historical marker, may be suppressed to make sure that the higher-priority AR content is given all user attention. Similarly, in the seconds leading up to situations where there are high-priority AR elements have a high probability of being needed to render, any lower-priority AR element may be suppressed. For instance, this may happen when users stand close to intersections and the sensors spot approaching vehicles, but have not yet determined speed and/or direction of the vehicles. Accordingly, AR content may be associated with priority values that may, for example, be stored in the record associated with the AR content, and/or be determined by evaluating scripts associated with the content.

Prioritization may be performed based on context and on user attention. For example, in instances where users are reading book and/or watching movies, systems in accordance with a number of embodiments may determine that it is unlikely that the users may welcome an advertisement. In contrast, if users are walking around in an unknown neighborhood, they may welcome suggestions of good places to take a break. Thus, the context of user activities may be relevant for determinations of priority. Alerts from personal concierges that it is time to leave for the airport may have sufficient priority to be rendered, as may warnings of environmental hazards, like a potential fire in the neighboring building determined from sensory information like smoke detectors, and/or reports of fires. Similarly, users paying attention to particular tasks, e.g., parking their car, may not want distractions, even when related to advertised specials at the cafe they are headed to. Attention can be determined based on user focus. Focus may, for instance, be measured by eye trackers, and based on detected events associated with users, including, but not limited to a driver slowing their car down and an accelerometer indicating a likely parking event taking place.

Just like systems may encode blocklists, systems may maintain and distribute whitelists, corresponding to AR NFTs that are known to be well-functioning. The distribution of whitelists can be and/or performed in batch mode. Alternatively or additionally, AR NFTs may be associated with certificates issued by trusted authorities, where different types of content may be certified by different authorities. Moreover different geographic areas, e.g., corresponding to different jurisdictions, may correspond to different certification authorities, and associated Certificate Revocation Lists (CRLs). Certificate authorities may issue certificates after performing verifications of content, including script elements, to determine that the content is legitimate, allowed in a particular area, permissible to be rendered on a given type of device, has a correct priority value, etc. Certificate authorities may hold an amount of funds as stake and include assertions of this escrowing in the certificate. When AR content is found to be in violation of rules, have serious bugs, and/or otherwise causes problems, the corresponding stake may be automatically slashed. Staking and slashing can be used for content-creator initiated assertion of content type, content priority, etc. When content creators misrepresent information, the staked funds can be slashed, and potential bounty hunters having reported on the misrepresentation may be provided awards. Bounty hunting was first introduced in U.S. Pat. No. 11,017,036, titled “Publicly Verifiable Proofs of Space”, granted May 25, 2021, and described in U.S. patent application Ser. No. 17/808,264, entitled “Systems and Methods for Token Creation and Management,” filed Jun. 22, 2022, the disclosure of which is incorporated by reference herein in its entirety.

Information about what types of AR content may be displayed may be conveyed from property authorities and/or certificate authorities. The information may refer to given geographical areas, certain times of the day, etc. Information about access rights may be sent to end-user devices with AR capabilities and used to determine what AR content may be rendered. For example, owner and/or renters of a residential property may limit the rendering of some types of AR content on and/or nearby their property. Additionally, homeowners associations may limit the rendering of AR content within some areas, except by users authorized by the associated properties, e.g., allowing guests of a homeowner to render any AR content inside the homeowner's property. Similarly, communities, cities, states and/or countries, which we collectively refer to as jurisdictions, may impose limitations on the rendering of AR content. Some limitations may be absolute, e.g., only safety AR content and directional content may be displayed in a given city park. Others may be associated with quantities that are allowed, e.g., only 100 users may at any five-minute period of time be allowed to render gaming AR content on Main street between the Hudson Street intersection and the Garden Street intersection. Some limitations may be governed by scripts. Certain limitations may be encoded as data with executable elements to determine policy compliance, rule applicability, etc. AR content limiters may be encoded as records, e.g., NFTs. The content limiters may include data and references to data associated with geographical areas, optional quantifications, types, and potential exclusions. An example exclusion may be that when an emergency vehicle approaches a user, all NFT rendering that is not safety-related is paused and an AR warning is rendered. Some communities may, when legal, limit the number of people who can be served direction data taking them through the community at a given time. Limiting service can be used to curb the excessive use by navigation applications through residential neighborhoods not suited for large amounts of traffic, for the purpose of shortening the distance traveled.

Systems and techniques directed towards establishing limitations on rendering augmented content, in accordance with numerous embodiments of the invention, are not limited to use within NFT platforms. Accordingly, it should be appreciated that applications described herein can be implemented outside the context of an NFT platform network architecture and in contexts unrelated to the generation of non-fungible tokens and/or NFTs. Moreover, any of the computer systems described herein with reference to FIGS. 34-36 can be utilized within any of the NFT platforms and/or immersive environment configurations described above.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A method for rendering content comprising:
receiving, from one or more sensory instruments, sensory input;
processing the sensory input into a background source;
receiving a non-fungible token (NFT), wherein the NFT comprises one or more character modeling elements;
processing the one or more character modeling elements from the NFT into a character source; and
producing an immersive environment comprising features from the background source and features from the character source.

2. The method of claim 1, further comprising:
receiving a connective visual source comprising one or more connective visual elements; and
enhancing details of the immersive environment using the connective visual source.

3. The method of claim 1, further comprising rendering the immersive environment.

4. The method of claim 1, further comprising generating a log entry, wherein the log entry comprises information relating to the rendering of the immersive environment.

5. The method of claim 4, further comprising:
processing the log entry; and
initiating a transfer of funds based on content from the log entry.

6. The method of claim 1, wherein the sensory input is obtained from a physical location.

7. The method of claim 1, wherein the character source, when rendered, corresponds to facial elements.

8. The method of claim 6, wherein the physical location is selected from the group consisting of an office, a recreational location, a residence of a participant in the immersive environment, and a custom-made environment.

9. The method of claim 7, wherein the facial elements are derived from a character, and wherein the character is selected from the group consisting of a fictional character, a celebrity, a participant in the immersive environment, and a custom-made character.

10. The method of claim 1, wherein a right to use the character source is obtained by purchasing and/or licensing the NFT.

11. The method of claim 1, wherein the features are selected from the group consisting of perspective, angle, lighting, color, and physical attributes.

12. The method of claim 1, further comprising incorporating audible elements into the immersive environment, wherein audible elements are selected from the group consisting of vocal music, speech, audible advertisements, and background music.

13. The method of claim 1, wherein the sensory instruments are selected from the group consisting of cameras, microphones, and pressure-sensitive sensors.

14. The method of claim 9, wherein the custom-made character is a character-trained model.

15. The method of claim 8, wherein:
the immersive environment is used for instructional purposes;
the physical location is a classroom; and
the character is a computer-generated instructor.

16. The method of claim 15, wherein the computer-generated instructor uses a computer-generated script, comprising:
dialogue to be spoken by the instructor; and
suggested reactions to questions from participants to the immersive environment.

17. The method of claim 16, further comprising:
reviewing the suggested reactions when a participant in the immersive environment asks a question;
when a reaction of the suggested reactions is appropriate to the question configuring the instructor to respond using the reaction; and
when no reaction of the suggested reactions is appropriate to the question, configuring the instructor to respond using an input reaction.

18. The method of claim 1, wherein elements that are processed into sources correspond to NFTs.

19. The method of claim 18, wherein each NFT corresponding to an element is associated with one or more policies.

20. The method of claim 19, wherein at least one policy of the one or more policies governs royalty payments for use of an associated element.
